(19) United States
(12) Patent Application Publication
(10) Pub. No.: US 2024/0162413 A1
(43) Pub. Date: May 16, 2024

(54) DEVICES COMPRISING CARBON-BASED MATERIAL AND FABRICATION THEREOF

(71) Applicant: The Regents of the University of California, Oakland, CA (US)

(72) Inventors: Maher F. El-Kady, Los Angeles, CA (US); Richard B. Kaner, Pacific Palisades, CA (US); Matthew Kowal, Los Angeles, CA (US)

(21) Appl. No.: 18/455,693

(22) Filed: Aug. 25, 2023

Related U.S. Application Data
(63) Continuation of application No. 17/112,384, filed on Dec. 4, 2020, now Pat. No. 11,791,453.
Application No. 17/112,384 is a division of application No. 15/688,342, filed on Aug. 28, 2017, now Pat. No. 10,938,021.
(60) Provisional application No. 62/381,859, filed on Aug. 31, 2016.

(51) Int. Cl. H01M 4/133; H01G 11/36; H01G 11/38; H01G 11/86; H01M 4/04; H01M 4/1391; H01M 4/1393; H01M 4/36; H01M 4/583; H01M 4/587; H01M 4/62; H01M 10/052; H01M 10/0525

(52) U.S. Cl. CPC H01M 4/133; H01G 11/36; H01G 11/38; H01G 11/86; H01M 4/0409; H01M 4/0435; H01M 4/1391; H01M 4/1393; H01M 4/364; H01M 4/583; H01M 4/587; H01M 4/623; H01M 4/625; H01M 10/052; H01M 10/0525; H01G 11/06; H01M 2220/20; H01M 2220/30

(57) ABSTRACT

Energy storage devices are disclosed. In some embodiments, the energy storage devices comprise a positive electrode comprising a carbon-based material comprising porous carbon sheet(s). Fabrication processes for manufacturing the energy storage devices are disclosed.

### CROSS-REFERENCE

This application is continuation of U.S. patent application Ser. No. 17/112,384, filed Dec. 4, 2020, which is a divisional of U.S. patent application Ser. No. 15/688,342, filed Aug. 28, 2017, now U.S. Pat. No. 10,938,021, which claims the benefit of U.S. Provisional Application No. 62/381,859, filed Aug. 31, 2016, which applications are incorporated herein by reference in their entireties.

### BACKGROUND

As a result of the rapidly growing energy needs of modern life, the development of high-performance energy storage devices has gained significant attention.

Lithium-ion batteries (LIBs) are very popular in portable electronics because of their high energy density and small memory effect. They play an important role in the progress of electric vehicles, power tools, and military and aerospace applications. LIBs in some cases dominate the market for energy storage. However, like any other any storage system, LIBs still suffer from many shortcomings. While normal electronic devices have seen very rapid progress following Moore's law, batteries have advanced only slightly, mainly because of the lack of new materials with high charge storage capacity.

### SUMMARY

Recognized herein is the need for higher performance energy storage devices (also “devices” herein). Provided herein are carbon-based materials, fabrication processes, and devices with improved performance.

In some embodiments, the present disclosure provides batteries (e.g., rechargeable batteries) that may avoid shortcomings of current battery technology. Provided herein are materials and fabrication processes of such batteries. In some embodiments, carbon-based lithium-ion batteries (LIBs) that may avoid shortcomings of current LIB technology are disclosed. Prototype carbon-based batteries disclosed herein may provide improved performance compared with commercial LIBs. In certain embodiments, the batteries described herein may hold twice as much charge compared with commercial LIBs. The batteries described herein may have double the capacity of commercial cells, provide twice the power of commercial cells, have a cycle life and be used for twice as long, or any combination thereof. In certain embodiments, the batteries described herein not only may have double the capacity of commercial cells but also may provide twice the power and be used for twice as long.

The batteries described herein may play an important role in one or more applications or areas, for example, portable electronics (e.g., cellphones, computers, and cameras), medical devices (e.g., life-sustaining and life-enhancing medical devices, including pacemakers, defibrillators, hearing aids, pain management devices, and drug pumps), electric vehicles (e.g., batteries with long lifetime are needed to improve the electric vehicles industry), space (e.g., the batteries may be used in space to power space systems including rovers, landers, spacesuits, and electronic equipment), military batteries (e.g., the military uses special batteries for powering a large number of electronics and equipment; the reduced mass and volume of the batteries described herein are highly preferred), electric aircraft (e.g., an aircraft that runs on electric motors rather than internal combustion engines, with electricity coming from solar cells or batteries), grid scale energy storage (e.g., batteries may be used to store electrical energy during times when production, from power plants, exceeds consumption and the stored energy may be used at times when consumption exceeds production), renewable energy (e.g., since the sun does not shine at night and the wind does not blow at all times, batteries in off-the-grid power systems may store excess electricity from renewable energy sources for use during hours after sunset and when the wind is not blowing; high power batteries may harvest energy from solar cells with higher efficiency than current state-of-the-art batteries), power tools (e.g., the batteries described herein may enable fast-charging cordless power tools such as drills, screwdrivers, saws, wrenches, and grinders; current batteries have a long recharging time), or any combination thereof.

Other goals and advantages of the device of the present disclosure will be further appreciated and understood when considered in conjunction with the following description and accompanying drawings. While the following description may contain specific details describing particular embodiments of the device of the present disclosure, this should not be construed as limitations to the scope of the device of the present disclosure but rather as an exemplification of preferable embodiments. For each aspect of the device of the present disclosure, many variations are possible as suggested herein that are known to those of ordinary skill in the art. A variety of changes and modifications may be made within the scope of the present disclosure without departing from the spirit thereof.

### BRIEF DESCRIPTION OF DRAWINGS

The features of the device of the present disclosure are set forth with particularity in the appended claims. A better understanding of the features and advantages of the device of the present disclosure will be obtained by reference to the following detailed description that sets forth illustrative embodiments, in which the principles of the device of the present disclosure are utilized, and the accompanying drawings or figures (also “FIG.” and “FIGs.” herein), of which:

FIG. 1 schematically illustrates an example of making porous carbon sheets.

FIG. 2 schematically illustrates an example of a fabrication process for manufacturing a battery comprising a carbon-based material in accordance with the present disclosure.

FIG. 3 shows an example of coating of a slurry using large scale roll-to-roll processing.

FIG. 4 shows an example of a process in which an aluminum foil is used as a substrate and the process starts with unwinding the aluminum foil for coating a slurry.

FIG. 5 shows an example of a close-up view of a slurry as it is being coated onto an aluminum foil/current collector (slurry is black).

FIG. 6 shows an example of an electrode/coated film after drying at 120° C. using an in-line heating oven.

FIG. 7 shows an example of rewinding an aluminum foil after it has been coated.

FIG. 8 schematically illustrates examples of various carbon forms.

FIG. 9 is a schematic illustration of an example of a structure of a battery.

FIG. 10 shows an example of a fabrication process of a cell.

FIG. 11 shows examples of finished cells.

FIG. 12 shows an example of performance of an lithium iron phosphate (LFP)-based cell.

FIG. 13 is a schematic illustration of an example of a structure of a battery.

FIG. 14 shows an example of a fabrication process of a cell.

FIG. 15 shows examples of finished cells.

FIG. 16 shows an example of performance of a lithium nickel cobalt aluminum oxide (NCA)-based cell.

FIG. 17 is a schematic illustration of an example of a structure of a battery.

FIG. 18 is a bird's eye view of an example of an assembly process of a cell.

FIG. 19 is a cross-sectional view of an example of an assembly process of a cell.

FIG. 20 shows an example of an assembly process of a cell.

FIG. 21 shows an example of a finished cell.

FIG. 22 shows an example of performance of a lithium nickel manganese cobalt oxide (NMC)-based cell.

FIG. 23 is a diagram showing an example of a Hummers'-based method (e.g., modified Hummers' method) of producing graphite oxide.

FIG. 24 is a diagram showing an example of a method for producing graphite oxide.

FIG. 25 shows an exemplary method for coating a film with slurry.

FIG. 26 shows capacity measurements of exemplary energy storage devices.

FIG. 27 shows equivalent series resistance (ESR) measurements of exemplary energy storage devices.

FIG. 28 shows exemplary dynamic ESR measurements of an exemplary energy storage device.

### DETAILED DESCRIPTION

Provided herein are carbon-based materials, fabrication processes, and devices with improved performance. In some embodiments, the present disclosure provides batteries (e.g., lithium-ion batteries (LIBs)) comprising carbon-based material and their fabrication processes. Such batteries may avoid the shortcomings of current battery (e.g., LIB) technology. A battery of the present disclosure may comprise one or more battery cells. A battery cell may comprise a positive electrode and a negative electrode separated by a separator comprising an electrolyte. The positive electrode may be a cathode during discharge. The negative electrode may be an anode during discharge.

In some embodiments, a plurality of battery cells may be arranged (e.g., interconnected) in a battery pack. A large battery pack (e.g., lithium-ion battery pack) may store the charge from rooftop solar panels to provide power for home appliances. The large battery pack may help stabilize the power grid. The large battery pack may lead to stand-alone power systems that may work completely off the grid.

### Carbon-Based Material

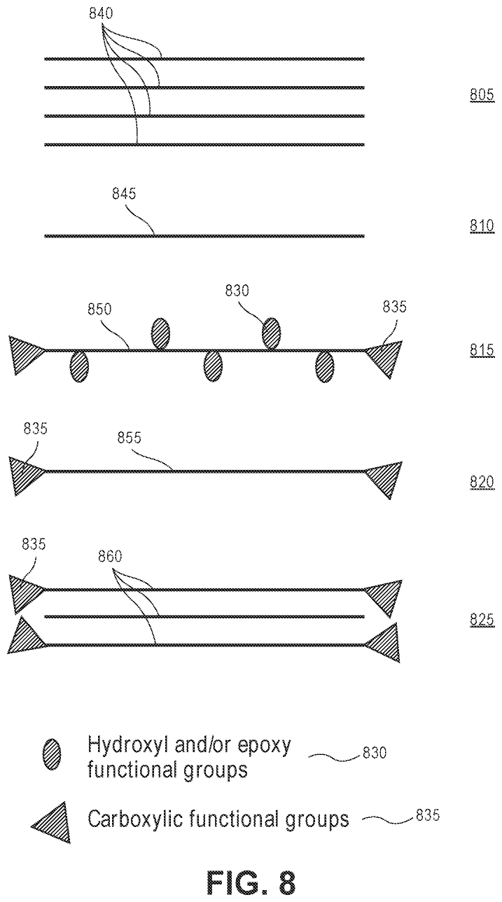

FIG. 8 schematically illustrates examples of various carbon forms 805, 810, 815, 820, and 825. Such carbon forms may form various carbon-based materials. The carbon forms may comprise functional groups. A given carbon form may comprise, for example, one or more hydroxyl and/or epoxy functional groups 830, one or more carboxylic functional groups 835, one or more other functional groups (e.g., carbonyl functional groups), or any combination thereof. The carbon form 805 may be, for example, graphite. The graphite may comprise a plurality of carbon sheets 840 (e.g., greater than or equal to about 100, 1,000, 10,000, 100,000, 1 million, 10 million, 100 million or more) that are each one atom thick. The plurality of carbon sheets 840 may be stacked on top of each other (e.g., as a result of strong van der Waals forces). The carbon sheets 840 may stick together such that the interior of the stack may not be accessible (e.g., only top and bottom sheets may be accessible, while the interior sheets stick together due to van der Waals interactions such that no pores are present). The carbon form 805 may include substantially no functional groups. The carbon form 810 may be, for example, graphene. The graphene may comprise a carbon sheet 845 that is one atom thick. The carbon form 810 may include substantially no functional groups. The carbon form 815 may be, for example, graphene oxide (e.g., singular graphite oxide in solution). The graphene oxide may comprise a carbon sheet 850 that is one atom thick. In some embodiments, one or more carbon forms 815 may agglomerate. In such instances, individual carbon sheets 815 may be separated. The carbon sheets may not agglomerate due to van der Waals interactions. The carbon form 815 may include one or more hydroxyl and/or epoxy functional groups 830, and one or more carboxylic functional groups 835. The hydroxyl and/or epoxy functional groups 830 may be attached or otherwise associated with/bonded to the surfaces of the carbon sheet 850. The carboxylic functional groups 835 may be attached or otherwise associated with/bonded to edges of the carbon sheet 850. The carbon form 825 may be, for example, few layer graphene oxide (e.g., bilayer or trilayer graphite oxide in solution). The few layer graphene oxide may comprise two or more carbon sheets or layers 860 that are each one atom thick. The two or more carbon sheets or layers 860 may be held together by van der Waals interactions. In some embodiments, the few layer graphene oxide may comprise greater than or equal to 2, 3, 4, 5, 6, 7, 8, 9 or 10 carbon sheets or layers 860. In an embodiment, the few layer graphene oxide may comprise less than or equal to 10 carbon sheets or layers 860 (e.g., up to 10 carbon sheets or layers). In some embodiments, the few layer graphene oxide may comprise between 2 and 3, 2 and 4, 2 and 5, 2 and 6, 2 and 7, 2 and 8, 2 and 9, 2 and 10, 3 and 4, 3 and 5, 3 and 6, 3 and 7, 3 and 8, 3 and 9, 3 and 10, 4 and 5, 4 and 6, 4 and 7, 4 and 8, 4 and 9, 4 and 10, 5 and 6, 5 and 7, 5 and 8, 5 and 9, 5 and 10, 6 and 7, 6 and 8, 6 and 9, 6 and 10, 7 and 8, 7 and 9, 7 and 10, 8 and 9, 8 and 10, or 9 and 10 carbon sheets or layers 860. In some embodiments, the few layer graphene oxide may comprise between 2 and 4, or 2 and 3 carbon sheets or layers 860. In an embodiment, the few layer graphene oxide comprises up to 4 carbon sheets or layers 860. In another embodiment, the few layer graphene oxide comprises up to 4 carbon sheets or layers 860. The carbon form 825 may include one or more carboxylic functional groups 835. The carboxylic functional groups 835 may be attached or otherwise associated with/bonded to edges of one or more of the carbon sheets 860. In some embodiments, the carboxylic functional groups 835 may be primarily or solely attached or otherwise associated with/bonded to edges of the top and bottom carbon sheets 860 in a stack of the carbon sheets or layers 860. In some embodiments, the carboxylic functional groups 835 may be attached or otherwise associated with/bonded to edges of any (e.g., each, or at least 2, 3, 4 or more) of the carbon sheets 860. The carbon form 820 may be, for example, reduced graphene oxide (e.g., porous carbon sheets(s) (PCS) formed in solution). The reduced graphene oxide may comprise a carbon sheet 855 that is one atom thick. The carbon form 820 may include one or more carboxylic functional groups 835. The carboxylic functional groups 835 may be attached or otherwise associated with/bonded to edges of the carbon sheet 855.

The presence and quantity of functional groups may affect the overall carbon-to-oxygen (C:O) atomic ratio of the carbon forms in FIG. 8. For example, the carbon forms 825 and 815 may differ in the amount and/or type of oxygen functionality. Such differences may affect their respective C:O atomic ratios. In another example, the carbon form 825 may be produced upon oxidation of the carbon form 805, and the carbon form 825 may in turn be further oxidized to the carbon form 815. It will be appreciated that each of the carbon forms in FIG. 8 may be produced via one or more pathways, and/or at least some of the carbon forms in FIG. 8 may be transformed from one to another at least in some implementations. For example, the carbon form 815 may be formed via an alternative pathway.

In some embodiments, a single-layer graphite oxide and graphene oxide (GO) may comprise between about 93% and 96% (e.g., by weight) of singular graphene oxide (e.g., carbon form 815 in FIG. 8). In some embodiments, a multi-layer GO may comprise a given distribution (e.g., by weight) of a number of layers (e.g., a distribution of carbon forms 825 with different numbers of layers). For example, a multi-layer GO may comprise greater than or equal to about 5%, 10%, 15%, 25%, 50%, 75%, 85%, 90%, or 95% (e.g., by weight) of a carbon form 825 with a given number of layers (e.g., 3 or 4). The multi-layer GO may comprise such percentages of a carbon form 825 together with less than or equal to about 95%, 90%, 75%, 50%, 25%, 15%, 10%, or 5% (e.g., by weight) of another carbon form 825 with a different number of layers. A multi-layer GO may comprise less than about 95%, 90%, 85%, 75%, 50%, 25%, 15%, 10%, or 5% (e.g., by weight) of a carbon form 825 with a given number of layers.

In some instances, only edges of the graphite may be oxidized while the material maintains a large portion of the conductive properties of graphene (e.g., see carbon form 825 in FIG. 8). The GO from the first reaction may have one or more properties (e.g., conductivity) that are, up to a given reaction time of the GO, substantially the same or similar to those of reduced GO. For example, the GO and reduced GO may be substantially the same or similar in terms of one or more properties below a given degree of oxidation of the GO. In an example, when oxidized (e.g., from the carbon form 805) to the carbon form 825, the GO may have one or more properties that are substantially the same as or similar to reduced GO produced from one or more of the oxidized carbon forms in FIG. 8 (e.g., substantially the same as or similar to reduced GO produced from the carbon form 825). The GO may or may not maintain one or more of such properties upon further oxidation. For example, if the carbon form 825 is further oxidized to the carbon form 815, one or more of such properties may differ (e.g., may begin to differ) from the reduced GO.

In some embodiments, the carbon-based material of the present disclosure comprises one or more PCS. The carbon-based material may be dispersed in solution. For example, PCS may be formed through chemical reduction in solution (e.g., as described in greater detail elsewhere herein). A PCS may have an oxygen content of less than or equal to about 10%, 9%, 8%, 7%, 6%, 5%, 4.5%, 4%, 3.5%, 3%, 2.5%, 2%, 1.5%, 1%, or 0.5%. A PCS may have a pore size of less than or equal to about 10 nanometers (nm), 9 nm, 8 nm, 7 nm, 6 nm, 5 nm, 4 nm, 3 nm, 2 nm, or 1 nm. A PCS may have a pore size of greater than or equal to about 1 nm. A PCS may have a pore size of between about 1 nm and 2 nm, 1 nm and 3 nm, 1 nm and 4 nm, 1 nm and 5 nm, 1 nm and 6 nm, 1 nm and 7 nm, 1 nm and 8 nm, 1 nm and 9 nm, 1 nm and 10 nm, 2 nm and 3 nm, 2 nm and 4 nm, 2 nm and 5 nm, 2 nm and 6 nm, 2 nm and 7 nm, 2 nm and 8 nm, 2 nm and 9 nm, 2 nm and 10 nm, 3 nm and 4 nm, 3 nm and 5 nm, 3 nm and 6 nm, 3 nm and 7 nm, 3 nm and 8 nm, 3 nm and 9 nm, 3 nm and 10 nm, 4 nm and 5 nm, 4 nm and 6 nm, 4 nm and 7 nm, 4 nm and 8 nm, 4 nm and 9 nm, 4 nm and 10 nm, 5 nm and 6 nm, 5 nm and 7 nm, 5 nm and 8 nm, 5 nm and 9 nm, 5 nm and 10 nm, 6 nm and 7 nm, 6 nm and 8 nm, 6 nm and 9 nm, 6 nm and 10 nm, 7 nm and 8 nm, 7 nm and 9 nm, 7 nm and 10 nm, 8 nm and 9 nm, 8 nm and 10 nm, or 9 nm and 10 nm. For example, the PCS may have a pore size between about 1 nm and 4 nm, or 1 nm and 10 nm. The PCS may have one or more pore sizes (e.g., the PCS may have a distribution of such pore sizes).

### Methods of Forming a Carbon-Based Material

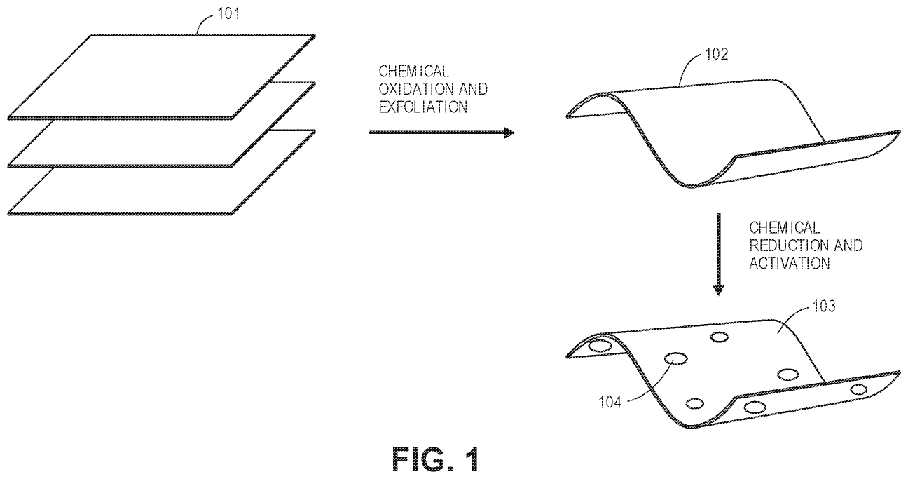

FIG. 1 schematically illustrates an example of making PCS. Graphite 101 may be chemically oxidized and exfoliated to graphite oxide or graphene oxide 102. For the purpose of this disclosure, the terms graphite oxide and graphene oxide are used interchangeably. In some instances, graphite oxide and graphene oxide are collectively referred to herein as “GO.”

The graphite 101 may be chemically oxidized and exfoliated to the GO using Hummers' method and modified Hummers' method (and various modifications thereof, for example, various methods derived from the modified Hummers' method, including renamed methods derived from the modified Hummers' method), collectively referred to herein as Hummers'-based methods.

In certain embodiments, a Hummers'-based method (e.g., a modified Hummers' method) may require several weeks of purification, expensive hydrochloric acid (HCl) washes, proper technique that is left to the judgment of the individual scientist, and/or a resulting product that sometimes gives acceptable results and sometimes does not give acceptable results.

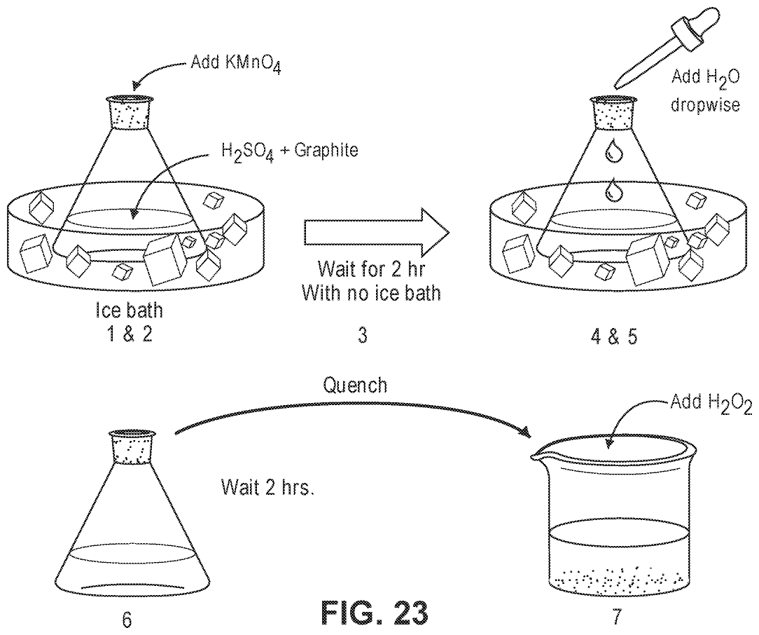

FIG. 23 shows an example of a Hummers'-based method (e.g., a modified Hummers' method) of producing graphite oxide. The method includes, in a first step, adding 15 grams (g) graphite to 750 milliliters (mL) concentrated sulfuric acid (H₂SO₄) at 0° C. using an ice bath. The method further includes, in a second step, adding 90 g potassium permanganate (KMnO₄) (exothermic). A third step includes removing the reaction flask from the ice bath and waiting 2 hours. A fourth step includes placing the reaction flask back into the ice bath. In a fifth step, 1.5 liters (L) water (H₂O) is added drop-wise over the course of about 1-1.5 hours while maintaining the temperature at 45° C. (controlling the temperature by the rate of addition of water and by adding ice to a melting ice bath). In certain embodiments, the ice bath from the first and/or second steps may be maintained and/or refilled for use in the fourth and/or fifth steps. A sixth step includes removing the reaction flask from the ice bath and waiting 2 hours. A seventh step includes quenching the reaction with 4.2 L H₂O and then 75 mL 30% hydrogen peroxide (H₂O₂). An eighth step includes purification. The purification involves five HCl washes, followed by nine H₂O washes, followed by allowing the solution to air dry for about 2 weeks and then rehydrating the dried graphite oxide with a known amount of water and putting it into dialysis for about 2 weeks. In an example, the total processing time is about 2 months, and the total cost is $93/kg.

Alternatively, the graphite 101 may be chemically oxidized and exfoliated to the GO using a non-Hummers'-based method (e.g., first reaction described in greater detail elsewhere herein). The GO may be of different forms (e.g., single-layer GO or multi-layer GO). The GO 102 may be chemically reduced and activated to produce PCS 103. The PCS 103 may comprise pores 104. The PCS may be a two-dimensional material.

In the non-Hummers'-based method, the graphite 101 may be chemically oxidized and exfoliated to the GO 102 in a first reaction. The first reaction may be followed by a first purification. The GO 102 may be chemically reduced to the PCS 103 in a second reaction. The second reaction may be followed by a second purification. In some embodiments, the first reaction and/or second reaction may allow GO and PCS, respectively, to be produced on a large scale (e.g., by the ton). In some embodiments, the second reaction may be performed separately from the first reaction. For example, the second reaction, in some cases followed by the second filtration, may be performed using any graphite oxide feedstock with suitable specifications.

The first reaction may include a low-temperature process for the production of GO with production of at least about 1 pound per day, including the time for purification. GO synthesis via the first reaction may be tunable in terms of control of oxidation characteristics and amount of exfoliation, safer than other methods because of procedural and engineered temperature controls, efficient in its minimal use of reagents, configured to be fully scalable, or any combination thereof. In certain embodiments of the non-Hummers'-based method described herein, the first reaction may produce a more controlled form of GO than Hummers'-based methods, as described in greater detail elsewhere herein. In some embodiments, this low-temperature process reduces the amount of chemicals used and thus promises lower cost. In addition, the lower reaction temperature of the method may reduce the risk of explosion.

The GO produced by the first reaction may be suitably exfoliated (e.g., sufficiently exfoliated but not so much as to absorb a too large amount of water). The GO may have an amount and/or type of oxygen functionality that allows less than a given amount of water to be absorbed. The amount and type of oxygen functionality may change with degree of oxidation. As described elsewhere herein, GO produced using the first reaction described herein may comprise a repeatable (e.g., consistent) amount and/or type of oxygen functionality. At least a portion of the oxygen functionality may allow water to be absorbed. The GO may be substantially (e.g., fully) exfoliated but not over-oxidized. The GO may be oxidized to a degree less than that which allows water to be absorbed in a suitably low amount (e.g., an over-oxidized graphite oxide may comprise an excessive amount and/or unsuitable type(s) of oxygen functionality that allow an excessive amount of water to be absorbed).

In addition, the degree of oxidation of graphite oxide in the first reaction may be adjusted to enable good control over the electrical conductivity and the number of layers of graphene oxide sheets in the final product. For example, reaction conditions may be adjusted to form single-layer graphite oxide or multi-layer graphite oxide. The two types of graphite oxide may have different properties. The properties may include, for example, given physicochemical properties and/or performance characteristics (e.g., conductivity or purity). For example, single-layer graphite oxide or multi-layer graphite oxide may have different conductive properties. In some embodiments, the resulting graphite oxide synthesis product may be affected by reaction conditions and/or by type or quality of the graphite feedstock.

A graphite feedstock may include various grades or purities, for example, carbon content measured as, for example, weight-% graphitic carbon (C g), types (e.g., amorphous graphite, for example, 60%-85% carbon), flake graphite (e.g., greater than 85% carbon) or vein graphite (e.g., greater than 90% carbon), sizes (e.g., mesh size), shapes (e.g., large flake, medium flake, powder, or spherical graphite), and origin (e.g., synthetic or natural, for example, natural flake graphite). Such characteristics (e.g., physical and chemical properties) may affect the type or quality of the graphite oxide. For example, the mesh size of the graphite may affect the resulting graphite oxide. The graphite may have a grade or carbon content of at greater than or equal to about 1%, 2%, 5%, 10%, 15%, 20%, 30%, 40%, 50%, 60%, 70%, 80%, 90%, 91%, 92%, 93%, 94%, 95%, 96%, 97%, 98%, or 99% (e.g., by weight). The graphite may have a grade or carbon content of less than about 100%, 99%, 98%, 97%, 96%, 95%, 94%, 93%, 92%, 91%, 90%, 85%, 80%, 70%, 60%, 50%, 40%, 30%, 20%, 15%, 10%, 5%, 2%, or 1% (e.g., by weight). The graphite may have such grades or carbon contents at a mesh size of greater than or equal to about −200, −150, −100, −80, −50, −48, +48, +80, +100, +150, or +200 mesh size. Mesh sizes may be converted to size in other dimensions (e.g., microns). Other examples of graphite feedstocks are provided elsewhere herein.

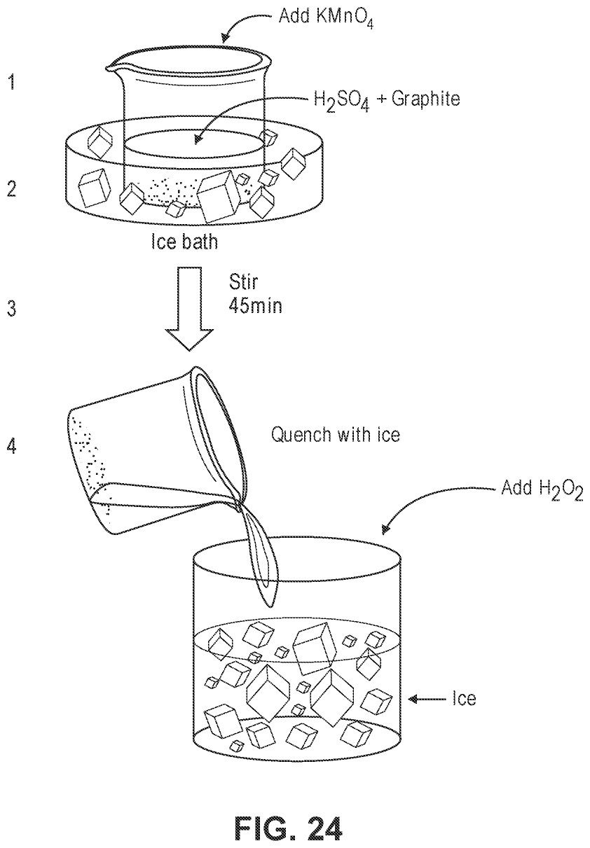

The non-Hummers'-based GO synthesis method of the present disclosure may be used to form GO with a given purity or grade (e.g., a minimum purity or grade). In some embodiments, purity or grade of the GO may be provided in terms of an ionic conductivity measured at the end of purification. The ionic conductivity may provide a metric for how much impurity the graphite oxide contains. In some embodiments, the ionic conductivity (e.g., for the method in FIG. 24) may be between about 10 microsiemens per centimeter (0/cm) and 20 μS/cm, 10 μS/cm and 30 μS/cm, 10 μS/cm and 40 μS/cm, 10 μS/cm and 50 μS/cm, 20 μS/cm and 30 μS/cm, 20 μS/cm and 40 μS/cm, 20 μS/cm and 50 μS/cm, 30 μS/cm and 40 μS/cm, 30 μS/cm and 50 μS/cm, or 40 μS/cm and 50 μS/cm. In some embodiments, the ionic conductivity (e.g., for the method in FIG. 24) may be less than and equal to about 50 μS/cm, 40 μS/cm, 30 μS/cm, 20 μS/cm or 10 μS/cm. In certain embodiments of the non-Hummers'-based method described herein, the given purity or grade may be achieved at least about 2, 3, 4, 5, 6, 7, 8, 9, or 10 times faster than a Hummers'-based method. In certain embodiments of the non-Hummers'-based method described herein, the given purity or grade may be achieved between about 2 and 5, 2 and 8, or 5 and 8 times faster than a Hummers'-based method. In certain embodiments of the non-Hummers'-based method described herein, the purity or grade may be reached at the aforementioned faster rates because a Hummers'-based method requires hydrochloric acid to be washed out and is therefore slower to reach the given purity or grade. The second reaction may be used to form (e.g., from GO produced via the first reaction) PCS with a given purity or grade (e.g., a minimum purity or grade). In some embodiments, a purity or grade of the PCS may be at least about 90%, 95%, 96%, 97%, 98%, 99%, 99.5%, or 99.9% carbon (e.g., by weight).

In certain embodiments of the non-Hummers'-based method described herein, the non-Hummers'-based method (e.g., see FIG. 24) may be faster, safer, and cheaper and may produce more repeatable results than Hummers'-based methods. In some embodiments, the improved repeatability may be at least in part due to a lower reaction temperature than a Hummers'-based method. In some embodiments, the non-Hummers'-based method described herein produces GO with a composition (e.g., C:O atomic ratio and quantity of oxygen functionality) and/or morphology repeatable to within about 1%, 2%, 3%, 4%, 5%, 6%, 7%, 8%, 9%, or 10%. For example, the method may produce GO with a C:O atomic ratio repeatable to within about 1%, 2%, 3%, 4%, 5%, 6%, 7%, 8%, 9%, or 10%. In certain embodiments of the non-Hummers'-based method described herein, the non-Hummers'-based method may include, for example, expedited purification without the use of costly HCl and a lower reaction temperature that reduces the risk of explosion.

In certain embodiments of the non-Hummers'-based method described herein, the non-Hummers'-based method may provide several advantages or benefits over a Hummers'-based method. For example, in certain embodiments, the non-Hummers'-based method described herein may be cheaper (e.g., at a cost per mass of graphite oxide of at least about 4 times less than a Hummers'-based method; less waste per mass graphite oxide produced than a Hummers'-based method), faster (e.g., removed HCl washes and/or faster purification; at least about 2, 5, or 8 times faster than (i) a Hummers'-based method or (ii) with HCl and/or without air drying; in less than or equal to about 1 week), more reliable (e.g., removal of human error/judgment), safer (e.g., reaction runs at lower temperatures, for example, at a maximum temperature of (i) less than about 45° C. or (ii) at least about 30° C. less than a maximum temperature used in a Hummers'-based method), or any combination thereof.

FIG. 24 is a diagram showing an example of a method for producing graphite oxide. The method in FIG. 24 provides examples of the first reaction and the first purification. The method includes, in a first step, adding about 15 g graphite to about 750 mL concentrated H₂SO₄ at about 0° C. using ice bath or recirculating chiller. In a second step, the method includes adding about 90 g KMnO₄ (exothermic) while keeping the temperature below about 15° C. using an ice bath or recirculating chiller. A third step (also “step 3” herein) includes stirring the reaction for about 45 minutes. A fourth step (also “step 4” herein) includes quenching the reaction by adding the reaction mixture to about 2.6 kg ice and then adding about 75 mL 30% H₂O₂. The method may further include a fifth step comprising purification. In this example, purification involves five H₂O washes, followed by less than or equal to about 1 week in a continuous-flow dialysis setup. In an example, the total processing time is about 1 week, and the total cost is $21/kg.

The reaction conditions (time/duration and temperature) in step 3 may vary. In this example, the reaction in step 3 is cooled by ice bath, and a time of about 45 minutes is selected. In other examples, the duration may be as described in greater detail elsewhere herein, and the reaction temperature may vary with time (duration) according to specific cooling conditions (e.g., presence or absence of cooling by ice bath).

The purification in step 5 may include at least 1, 2, 3, 4, or 5 or more H₂O washes. The purification in step 5 may include 5 or fewer H₂O washes. The purification may further include other water purification steps, for example, dialysis. For example, dialysis may include placing the material in a porous tube and removing (e.g., leaching out) ions from the material through the walls of the tube into a water bath that is refreshed continuously or batch-wise. The method may include using one or more filtration methods other than dialysis (e.g., after the H₂O washes, another filtration method may be applied in lieu of dialysis). The filtration may take less than 1 week. The duration of the filtration may depend on batch size. For example, for the 15 g graphite batch above, filtration may take less than or equal to about 1 or 2 days. Total filtration (e.g., dialysis) time may be less than or equal to about 7 days, 6 days, 5 days, 4 days, 3 days, 2 days, 1 day, or ½ day. A shorter filtration time may reduce the total processing time to less than or equal to about 7 days, 6 days, 5 days, 4 days, 3 days, 2 days, 1 day, or ½ day.

In step 4, the reaction mixture may be added to greater than or equal to about 2.6 kg ice. In some instances, the amount of ice described herein may be a minimum amount. Step 4 may include adding greater than or equal to about 75 mL 30% H₂O₂. In some instances, the amount of H₂O₂ described herein may be a minimum amount.

Given the scalability of the methods described herein (e.g., the method in FIG. 24), the amount of oxidizing agent (also “oxidizer” herein) may be provided in terms of a ratio of oxidizing agent (KMnO₄) to graphite (also “Ox:Gr” herein). For example, about 90 g KMnO₄ may be used per 15 g graphite, corresponding to about 6× mass ratio Ox:Gr. In another example, about 75 mL 30% H₂O₂ (e.g., about 30% by weight in aqueous solution, corresponding to about 0.66 moles H₂O₂) may be used (i) per 90 g KMnO₄, corresponding to about 0.25 units of H₂O₂ per unit of KMnO₄ on a weight basis or about 1.16 units of H₂O₂ per unit of KMnO₄ on a molar basis, or (ii) per 750 mL concentrated H₂SO₄ with a concentration of between about 96% H₂SO₄ and 98% H₂SO₄ (e.g., by weight in aqueous solution), corresponding to a volume ratio of 30% H₂O₂ to concentrated sulfuric acid of about 10:1 (e.g., about 1 L of aqueous solution having about 30% H₂O₂ for every 10 L of concentrated H₂SO₄). In yet another example, about 50 L of concentrated H₂SO₄ may be consumed for every 1 kg of graphite. Further examples of amounts and ratios are provided elsewhere herein, for example, in relation to methods for producing single-layer GO and multi-layer GO (e.g., on a per kilogram graphite oxide basis).

In some embodiments, H₂SO₄ (e.g., with a concentration of between about 96% H₂SO₄ and 98% H₂SO₄) may be provided in an amount between about 1 g graphite:10 mL H₂SO₄ and about 1 g graphite:50 mL H₂SO₄. The method may include providing between about 10 mL H₂SO₄ and 20 mL H₂SO₄, 10 mL H₂SO₄ and 30 mL H₂SO₄, 10 mL H₂SO₄ and 40 mL H₂SO₄, 10 mL H₂SO₄ and 50 mL H₂SO₄, 20 mL H₂SO₄ and 30 mL H₂SO₄, 20 mL H₂SO₄ and 40 mL H₂SO₄, 20 mL H₂SO₄ and 50 mL H₂SO₄, 30 mL H₂SO₄ and 40 mL H₂SO₄, 30 mL H₂SO₄ and 50 mL H₂SO₄, or 40 mL H₂SO₄ and 50 mL H₂SO₄ per 1 g graphite. The method may include providing greater than or equal to about 10 mL H₂SO₄, 20 mL H₂SO₄, 30 mL H₂SO₄, 40 mL H₂SO₄, or 50 mL H₂SO₄ per 1 g graphite. The method may include providing less than about 75 mL H₂SO₄, 70 mL H₂SO₄, 60 mL H₂SO₄, 50 mL H₂SO₄, 40 mL H₂SO₄, 30 mL H₂SO₄, 20 mL H₂SO₄, or 15 mL H₂SO₄ per 1 g graphite.

In some embodiments, H₂SO₄ (e.g., with a concentration of between about 96% H₂SO₄ and 98% H₂SO₄) may be provided in an amount between about 1 g graphite:18.4 g H₂SO₄ and about 1 g graphite:92.0 g H₂SO₄. The method may include providing between about 18.4 g H₂SO₄ and 30 g H₂SO₄, 18.4 g H₂SO₄ and 40 g H₂SO₄, 18.4 g H₂SO₄ and 50 g H₂SO₄, 18.4 g H₂SO₄ and 60 g H₂SO₄, 18.4 g H₂SO₄ and 70 g H₂SO₄, 18.4 g H₂SO₄ and 80 g H₂SO₄, 18.4 g H₂SO₄ and 92.0 g H₂SO₄, 30 g H₂SO₄ and 40 g H₂SO₄, 30 g H₂SO₄ and 50 g H₂SO₄, 30 g H₂SO₄ and 60 g H₂SO₄, 30 g H₂SO₄ and 70 g H₂SO₄, 30 g H₂SO₄ and 80 g H₂SO₄, 30 g H₂SO₄ and 92.0 g H₂SO₄, 40 g H₂SO₄ and 50 g H₂SO₄, 30 g H₂SO₄ and 60 g H₂SO₄, 30 g H₂SO₄ and 70 g H₂SO₄, 30 g H₂SO₄ and 80 g H₂SO₄, 30 g H₂SO₄ and 92.0 g H₂SO₄, 40 g H₂SO₄ and 50 g H₂SO₄, 40 g H₂SO₄ and 60 g H₂SO₄, 40 g H₂SO₄ and 70 g H₂SO₄, 40 g H₂SO₄ and 80 g H₂SO₄, 40 g H₂SO₄ and 92.0 g H₂SO₄, 50 g H₂SO₄ and 60 g H₂SO₄, 50 g H₂SO₄ and 70 g H₂SO₄, 50 g H₂SO₄ and 80 g H₂SO₄, 50 g H₂SO₄ and 92.0 g H₂SO₄, 60 g H₂SO₄ and 70 g H₂SO₄, 60 g H₂SO₄ and 80 g H₂SO₄, 60 g H₂SO₄ and 92.0 g H₂SO₄, 70 g H₂SO₄ and 80 g H₂SO₄, 70 g H₂SO₄ and 92.0 g H₂SO₄, 80 g H₂SO₄ and 92.0 g H₂SO₄ per 1 g graphite. The method may include providing greater than or equal to about 18.4 g H₂SO₄, 20 g H₂SO₄, 25 g H₂SO₄, 30 g H₂SO₄, 35 g H₂SO₄, 40 g H₂SO₄, 45 g H₂SO₄, 50 g H₂SO₄, 55 g H₂SO₄, 60 g H₂SO₄, 65 g H₂SO₄, 70 g H₂SO₄, 75 g H₂SO₄, 80 g H₂SO₄, 85 g H₂SO₄, 90 g H₂SO₄, or 92.0 g H₂SO₄ per 1 g graphite. The method may include providing less than about 140 g H₂SO₄, 130 g H₂SO₄, 120 g H₂SO₄, 110 g H₂SO₄, 100 g H₂SO₄, 95 g H₂SO₄, 90 g H₂SO₄, 80 g H₂SO₄, 70 g H₂SO₄, 60 g H₂SO₄, 50 g H₂SO₄, 40 g H₂SO₄, 30 g H₂SO₄, or 20 g H₂SO₄ per g graphite.

In some embodiments, KMnO₄ may be provided in an amount between about 1 g graphite:2 g KMnO₄ and about 1 g graphite:6 g KMnO₄. The method may include providing between about 1 g KMnO₄ and 2 g KMnO₄, 1 g KMnO₄ and 3 g KMnO₄, 1 g KMnO₄ and 4 g KMnO₄, 1 g KMnO₄ and 5 g KMnO₄, 1 g KMnO₄ and 6 g KMnO₄, 2 g KMnO₄ and 3 g KMnO₄, 2 g KMnO₄ and 4 g KMnO₄, 2 g KMnO₄ and 5 g KMnO₄, 2 g KMnO₄ and 6 g KMnO₄, 3 g KMnO₄ and 4 g KMnO₄, 3 g KMnO₄ and 5 g KMnO₄, 3 g KMnO₄ and 6 g KMnO₄, 4 g KMnO₄ and 5 g KMnO₄, 4 g KMnO₄ and 6 g KMnO₄, or 5 g KMnO₄ and 6 g KMnO₄ per 1 g graphite. The method may include providing greater than or equal to about 1 g KMnO₄, 2 g KMnO₄, 3 g KMnO₄, 4 g KMnO₄, 5 g KMnO₄, or 6 g KMnO₄ per 1 g graphite. The method may include providing less than about 9 g KMnO₄, 8 g KMnO₄, 7 g KMnO₄, 6 g KMnO₄, 5 g KMnO₄, 4 g KMnO₄, 3 g KMnO₄, or 2 g KMnO₄ per 1 g graphite.

In some embodiments, H₂O₂ may be provided in an amount of at least about 1 mol H₂O₂ per 1 mol KMnO₄. The method may include providing between about 1 mol H₂O₂ and 1.1 mol H₂O₂, 1 mol H₂O₂ and 1.2 mol H₂O₂, 1 mol H₂O₂ and 1.3 mol H₂O₂, 1 mol H₂O₂ and 1.4 mol H₂O₂, or 1 mol H₂O₂ and 1.5 mol H₂O₂ per 1 mol KMnO₄. The method may include providing greater than or equal to about 1 mol H₂O₂, 1.1 mol H₂O₂, 1.2 mol H₂O₂, 1.3 mol H₂O₂, 1.4 mol H₂O₂, or 1.5 mol H₂O₂ per 1 mol KMnO₄. The method may include providing less than about 1.5 mol H₂O₂, 1.4 mol H₂O₂, 1.3 mol H₂O₂, 1.2 mol H₂O₂, or 1.1 mol H₂O₂ per 1 mol KMnO₄.

In some embodiments, ice may be provided in an amount between about 1 g H₂SO₄:0 g ice and about 1 g H₂SO₄:1.09 g ice, between about 1 g H₂SO₄:1.09 g ice and about 1 g H₂SO₄:1.63 g ice, or between about 1 g H₂SO₄:0 g ice and about 1 g H₂SO₄:1.63 g ice. The method may include providing between about 0 g ice and 0.4 g ice, 0 g ice and 0.8 g ice, 0 g ice and 1.2 g ice, 0 g ice and 1.63 g ice, 0.4 g ice and 0.8 g ice, 0.4 g ice and 1.2 g ice, 0.4 g ice and 1.63 g ice, 0.8 g ice and 1.2 g ice, 0.8 g ice and 1.63 g ice, or 1.2 g ice and 1.63 g ice per 1 g H₂SO₄. The method may include providing greater than or equal to about 0 g ice, 0.2 g ice, 0.4 g ice, 0.6 g ice, 0.8 g ice, 1.09 g ice, 1.2 g ice, 1.4 g ice, or 1.63 g ice per 1 g H₂SO₄. The method may include providing less than about 2.4 g ice, 2.2 g ice, 2.0 g ice, 1.8 g ice, 1.63 g ice, 1.4 g ice, 1.2 g ice, 1.09 g ice, 0.8 g ice, 0.6 g ice, 0.4 g ice, 0.2 g ice, or 0.1 g ice per 1 g H₂SO₄.

In some embodiments, ice may be provided in an amount between about 1 mL H₂SO₄:0 g ice and about 1 mL H₂SO₄:2 g ice, between about 1 mL H₂SO₄:2 g ice and about 1 mL H₂SO₄:3 g ice, or between about 1 mL H₂SO₄:0 g ice and about 1 mL H₂SO₄:3 g ice. The method may include providing between about 0 g ice and 1 g ice, 0 g ice and 2 g ice, 0 g ice and 3 g ice, 1 g ice and 2 g ice, 1 g ice and 3 g ice, or 2 g ice and 3 g ice per 1 mL H₂SO₄. The method may include providing greater than or equal to about 0 g ice, 0.2 g ice, 0.4 g ice, 0.6 g ice, 0.8 g ice, 1 g ice, 1.2 g ice, 1.4 g ice, 1.6 g ice, 1.8 g ice, 2 g ice, 2.2 g ice, 2.4 g ice, 2.6 g ice, 2.8 g ice or 3 g ice per 1 mL H₂SO₄. The method may include providing less than about 4.5 g ice, 4 g ice, 3.5 g ice, 3 g ice, 2.5 g ice, 2 g ice, 1.5 g ice, 1 g ice, 0.5 g ice, 0.25 g ice, or 0.1 g ice per 1 mL H₂SO₄.

In certain embodiments, the graphite may be provided in powder form. It will be appreciated that the reactant amounts may be suitably scaled for production on a large scale. Substantially all of the graphite may be converted. The amount of GO produced per unit of graphite may depend on the oxygen content of the GO. In some embodiments, the C:O atomic ratio of the GO may be, for example, between about 4:1 and 5:1, and the amount of GO produced may be between about 1.27 and 1.33 units of GO per unit of graphite on a weight basis (e.g., between about 19 g and 20 g GO per 15 g graphite). The C:O atomic ratio of the GO may differ for single-layer and multi-layer GO (e.g., as described in relation to FIG. 8). Thus, the amount of GO produced per unit of graphite may differ for single-layer GO and multi-layer GOs. It will also be appreciated that the concentration of one or more of the reactants may in some cases vary. In an example, sulfuric acid may be provided at a concentration of between about 96% H₂SO₄ and 98% H₂SO₄ (e.g., by weight in aqueous solution). In another example, in some instances an absolute concentration of H₂O₂ may not substantially affect reaction conditions; instead, reaction conditions may depend on a ratio of H₂O₂ to KMnO₄ (e.g., affecting lesser manganese species). In such instances, volume and/or mass of the reactant mixture may be suitably adjusted such that a given (e.g., predetermined) total mass or molar amount of the reactant is provided. It will further be appreciated that in some instances a minimum or maximum concentration may be required to ensure suitable reaction conditions. For example, a substantially lower sulfuric acid concentration than about 96%-98% (e.g., by weight in aqueous solution) may lead to a different morphology of the GO (e.g., the lower concentration may affect oxygen-containing groups).

The present non-Hummers'-based method for producing graphite oxide may comprise steps of: providing a graphite powder and H₂SO₄ mixture while cooling the graphite powder and H₂SO₄ mixture to a first predetermined temperature; adding a predetermined amount of KMnO₄ to the graphite powder and H₂SO₄ mixture to make a graphite oxidizing mixture; agitating (e.g., after the addition of the predetermined amount of KMnO₄ has been completed) the graphite oxidizing mixture for a predetermined amount of time; cooling the graphite oxidizing mixture to a second predetermined temperature; and adding a predetermined amount of H₂O₂ to the graphite oxidizing mixture to yield graphite oxide. In some implementations, the graphite powder and H₂SO₄ mixture may be provided, and then cooled to the first predetermined temperature.

The non-Hummers'-based method described herein may further include purifying the graphite oxide by rinsing the graphite oxide with water (e.g., deionized water), purifying the graphite oxide by chemistry dialysis, or a combination thereof (e.g., rinsing followed by dialysis).

The first predetermined temperature resulting from cooling the graphite powder and H₂SO₄ mixture may be about 0° C. The first predetermined temperature resulting from cooling the graphite powder and H₂SO₄ mixture may range from about −10° C. to about 15° C. The first predetermined temperature may be greater than or equal to about −10° C., −9° C., −8° C., −7° C., −6° C., −5° C., −4° C., −3° C., −2° C., −1° C., or 0° C. but less than or equal to about 1° C., 2° C., 3° C., 4° C., 5° C., 6° C., 7° C., 8° C., 9° C., 10° C., 11° C., 12° C., 13° C., 14° C., or 15° C.

A reaction temperature of the graphite oxidizing mixture may be prevented from rising above about 15° C. while adding the predetermined amount of KMnO₄ to the graphite powder and H₂SO₄ mixture. The addition of the KMnO₄ to the graphite powder and H₂SO₄ mixture may initiate an exothermic (e.g., self-heated) reaction. The reaction temperature of the graphite oxidizing mixture may be less than or equal to about 15° C., 14° C., 13° C., 12° C., 11° C., 10° C., 9° C., 8° C., 7° C., 6° C., 5° C., 4° C., 3° C., 2° C., or 1° C. while adding the predetermined amount of KMnO₄ to the graphite powder and H₂SO₄ mixture. In certain embodiments, the reaction temperature of the graphite oxidizing mixture may be less than about 15° C. while adding the predetermined amount of KMnO₄ to the graphite powder and H₂SO₄ mixture.

The agitating may include stirring at a rate that ranges from about 50 revolutions per minute (rpm) to about 150 rpm. In some embodiments, the agitating may include stirring at a rate of at least about 50 rpm, 60 rpm, 70 rpm, 80 rpm, 90 rpm, 100 rpm, 110 rpm, 120 rpm, 130 rpm, 140 rpm, or 150 rpm. In some embodiments, the agitating may include stirring at such rates (also “stirring rates” herein) while maintaining a stirring rate of less than or equal to about 150 rpm. The predetermined time for agitating the graphite oxidizing mixture may range from about 45 minutes to about 300 minutes. The predetermined time for agitating the graphite oxidizing mixture may be at least about 45 minutes, 50 minutes, 60 minutes, 70 minutes, 80 minutes, 90 minutes, 100 minutes, 120 minutes, 140 minutes, 160 minutes, 180 minutes, 200 minutes, 220 minutes, 240 minutes, 260 minutes, 280 minutes, or 300 minutes. The predetermined time may or may not depend upon the stirring rate. In some examples, the predetermined time may be independent of the stirring rate beyond a given threshold (e.g., a minimum stirring rate) and/or within a given range of stirring rates. In some embodiments, a reaction temperature of the graphite oxidizing mixture during the agitating may be maintained below about 45° C. In some embodiments, a reaction temperature of the graphite oxidizing mixture during the agitating may be maintained at less than or equal to about 15° C.

The cooling of the graphite oxidizing mixture to the second predetermined temperature may be achieved by quenching the graphite oxidizing mixture with water and/or ice. The second predetermined temperature may be about 0° C. The second predetermined temperature may range from about 0° C. to about 10° C. The second predetermined temperature may be greater than or equal to about 0° C. but less than or equal to about 1° C., 2° C., 3° C., 4° C., 5° C., 6° C., 7° C., 8° C., 9° C., or 10° C.

In some embodiments, single-layer GO is produced. The first reaction may include using about 32 L 98% H₂SO₄ per kilogram graphite. About 4.8 kg KMnO₄ powder per kilogram graphite may be used. The method may or may not include cooking time. The method may include given temperatures and processes. The method may include, from the beginning of the reaction, about 1.5 hour of addition of KMnO₄ (reaction temperature less than about 15° C.), about 2 hours of reaction time (reaction temperature range of about 20-30° C.), about 1 hour of addition of about 32 kg ice (reaction temperature of about 50° C.) and about 1 hour reaction time (reaction temperature of about 50° C.). About 72 kg ice per kilogram graphite may be used to quench the reaction and/or for ice for reaction cooling. About 2 L 30% H₂O₂ per kilogram of graphite may be used to quench the reaction and/or for neutralizing. The graphite may be of a given type. The graphite may be 325sh natural flake graphite. Mixing speed (e.g., during one or more reaction processes) may be about 100 rpm. The method may include given timing of mixing ingredients. Sulfuric acid and graphite may be premixed to minimize graphite dust and added to the reactor rapidly. Potassium permanganate addition may be exothermic. The KMnO₄ may be added at a rate slow enough to keep the reaction temperature below about 15° C. (e.g., the KMnO₄ may be added over approximately 1.5 hours).

During oxidation to single-layer GO, graphite (about 1 kg) may be mixed with 98% H₂SO₄ (about 32 L) and chilled to about −10° C. GO reactor cooling coils may be chilled to −2° C. Graphite/H₂SO₄ mixture may then be poured carefully into the reactor. Potassium permanganate (about 4.8 kg) powder may be added to the reactor slowly over the course of about 1.5 hours, carefully keeping the reaction temperature below about 15° C. After addition of KMnO₄ is complete, the reactor cooling coil temperature may be raised to about 12° C. and the reaction may heat up to about 30° C. over about 1.5 hours. Then, the reactor cooling coils may be cooled to about −2° C. and the reaction temperature may stay at about 30° C. for approximately an additional 30 minutes. Crushed ice (about 32 kg) may be added over the course of about 1 hour. The reaction temperature may climb to about 50° C. over this time. After ice addition, the reaction may be allowed to stir for about 1 hour. The reaction may then be quenched with crushed ice (about 72 kg). The ice may melt during this quench, and then 30% hydrogen peroxide (about 2 L) may be added to stop the reaction.

In some embodiments, multi-layer GO is produced. The first reaction may include using about 25 L 98% H₂SO₄ per kilogram graphite. About 2 kg KMnO₄ per kilogram graphite oxide may be used. The method may or may not include cooking time. The method may include given temperatures and process(es). The method may include a 45-minute addition of KMnO₄ (reaction temperature less than about 15° C.) and 30-minute reaction time (reaction temperature of about 15° C.). About 125 kg ice per kilogram graphite may be used to quench the reaction and/or for ice for reaction cooling. About 1 L 30% hydrogen peroxide per kilogram of graphite may be used to quench the reaction and/or for neutralizing. The graphite may be of a given type. The graphite may be highly exfoliated and milled, small flake, large surface area graphite, 9 micron flakes, or any combination thereof. Mixing speed (e.g., during one or more reaction processes) may be about 100 rpm. The method may include a given timing of mixing ingredients. Sulfuric acid and graphite may be premixed to minimize graphite dust and added to the reactor rapidly. Potassium permanganate addition may be exothermic. The KMnO₄ may be added at a rate slow enough to keep the reaction temperature below about 15° C. (e.g., the KMnO₄ may be added over approximately 1.5 hours).

During oxidation to multi-layer GO, graphite (about 1 kg) may be mixed with 98% H₂SO₄ (about 32 L) and chilled to about −10° C. Graphite oxide/graphene oxide reactor cooling coils may be chilled to about −2° C. Graphite/H₂SO₄ mixture may then be poured carefully into the reactor. Potassium permanganate (about 2 kg) powder may be added to the reactor slowly over the course of about 45 minutes, carefully keeping the reaction temperature below about 15° C. The reaction may then be allowed to stir for about 30 minutes at a reaction temperature of about 15° C. The reaction may then be quenched with crushed ice (about 125 kg). The ice may melt during this quench, and then 30% H₂O₂ (about 1 L) may be added to stop the reaction.

A first purification may include filtration (also “first filtration” herein). The first filtration may be performed after the first reaction. The first filtration may include post-oxidation purification. The first filtration may remove impurities from the crude product and bring the pH up to at least about 5. After oxidation, the crude product may contain GO as well as one or more (e.g., several) impurities, for example, H₂SO₄, manganese oxides, and manganese sulfate. After purification is complete, the GO may then be concentrated to, for example, a solution of about 1% by weight. Water and/or acid from first reaction may be removed during filtration. After the first reaction, the acid concentration may be about 30% (single-layer) or about 16% (multi-layer) H₂SO₄, corresponding to a pH of approximately 0. Filtration may be complete when the pH reaches about 5, correspond to an acid concentration of about 0.00005%. A given amount or degree of concentration may be needed (e.g., if used as feedstock for a second reaction). In some embodiments, the GO may be in dry powder form and/or an aqueous solution of about 2% (by weight).

Purification may be performed using a tangential flow filtration process. The filter type may be a modified polyether sulfone hollow filter membrane with about 0.02 micron pore size. Purification may be complete when the pH of the product reaches about 5. The purified GO may then be concentrated to a solution of about 1% by weight. After the first purification, the H₂SO₄ concentration of the product may be about 0.00005% with a pH of about 5.

The second reaction may include reduction of GO (in solution) to form reduced GO (e.g., PCS). In some embodiments, GO from the first reaction may be used as input to the second reaction. For example, single-layer GO from the first reaction may be used as input to the second reaction. In some embodiments, GO produced by a Hummers'-based method may be used as input to the second reaction. For example, single-layer GO from a Hummers'-based method may be used as input to the second reaction. In some embodiments, single-layer GO may be used instead of multi-layer GO as input to the second reaction to produce PCS. Use of single-layer may in some instances reduce waste material relative to multi-layer GO when PCS is produced in the second reaction (e.g., to produce sheets). For example, a higher amount of multi-layer GO may be needed to produce PCS than when single-layer GO is used.

The second reaction may include heating the reaction to about 90° C. and adding H₂O₂ over the course of about an hour. The reaction may continue to heat at about 90° C. for about 3 more hours. Sodium ascorbate (e.g., C₆H₇NaO₆) may be added over the course of about 30 minutes. The reaction may continue to heat at about 90° C. for approximately an additional 1.5 hours. The total time at about 90° C. may be about 6 hours. The mixing speed (also “stirring rate” herein) may be as described elsewhere herein (e.g., in relation to synthesis of GO). In some embodiments, the mixing speed (e.g., during one or more reaction processes) may be at least about 100 rpm, 110 rpm, 120 rpm, 130 rpm, 140 rpm, 150 rpm, 160 rpm, 170 rpm, 180 rpm, 190 rpm, or 200 rpm.

As previously described, the reaction temperature may be about 90° C. Alternatively, one or more of the aforementioned steps may be performed at a temperature of between about 60° C. and 180° C. The steps may be performed at the same temperature or temperature range, or at one or more different temperatures or temperature ranges (e.g., at one or more different temperatures between about 60° C. and 180° C.). For example, all steps may be performed at the same temperature (or temperature range), each step may be performed at a different temperature (or temperature range), or subset(s) of steps may be performed at the same temperature (or temperature range). In some embodiments, the temperature may be between about 60° C. and 80° C., 60° C. and 90° C., 60° C. and 100° C., 60° C. and 120° C., 60° C. and 140° C., 60° C. and 160° C., 60° C. and 180° C., 80° C. and 90° C., 80° C. and 100° C., 80° C. and 120° C., 80° C. and 140° C., 80° C. and 160° C., 80° C. and 180° C., 90° C. and 100° C., 90° C. and 120° C., 90° C. and 140° C., 90° C. and 160° C., 90° C. and 180° C., 100° C. and 120° C., 100° C. and 140° C., 100° C. and 160° C., 100° C. and 180° C., 120° C. and 140° C., 120° C. and 160° C., 120° C. and 180° C., 140° C. and 160° C., 140° C. and 180° C., or 160° C. and 180° C. The temperature may or may not be allowed to change or fluctuate within a given range (e.g., the temperature for a given step may be kept constant at a given temperature within a given range, or may be allowed to fluctuate within the given range). In some instances (e.g., at temperatures above about 100° C.), the reaction chamber may need to be sealed.

The concentration of the GO in the solution prior to the second reaction may range, for example, between about 0% and 2% by mass (e.g., 0-2 kg/100 L of aqueous solution). For example, the concentration of GO by mass may be between about 0% and 0.5%, 0% and 1%, 0% and 1.5%, 0% and 2%, 0.5% and 1%, 0.5% and 1.5%, 0.5% and 2%, 1% and 1.5%, 1% and 2%, or 1.5% and 2%. The concentration of GO may be less than or equal to about 2%, 1.5%, 1%, 0.5%, 0.25%, 0.1% (or less) by mass. For example, the concentration of GO in the solution (e.g., from the first reaction) may be about 1% by mass (1 kg GO in 100 L of aqueous solution). In some embodiments, the concentration may be limited by how much GO may be dissolved in water while maintaining its fluidity. In some embodiments, the solution may become viscous (e.g., at a concentration of 2% or more, i.e., 2 kg or more of GO in 100 L of water). In some embodiments, the solution viscosity may be less than a viscosity at which reaction cooking may become difficult. A higher concentration (e.g., 1% by mass) may allow the amount of water used in the reaction to be decreased (e.g., as high concentration as possible may minimize the amount of water used in the reaction). The water may be filtered at the end of the second reaction. A decrease in the amount of water used in the second reaction may decrease filtration time (e.g., the larger the volume of the solution, the longer it may take in filtration).

In some embodiments, H₂O₂ (e.g., with a concentration of about 30% by weight) may be provided in an amount between about 10 L and 100 L per 1 kg GO. For example, between about 10 L and 20 L, 10 L and 30 L, 10 L and 40 L, 10 L and 50 L, 10 L and 60 L, 10 L and 70 L, 10 L and 80 L, 10 L and 90 L, 10 L and 100 L, 20 L and 30 L, 20 L and 40 L, 20 L and 50 L, 20 L and 60 L, 20 L and 70 L, 20 L and 80 L, 20 L and 90 L, 20 L and 100 L, 30 L and 40 L, 30 L and 50 L, 30 L and 60 L, 30 L and 70 L, 30 L and 80 L, 30 L and 90 L, 30 L and 100 L, 40 L and 50 L, 40 L and 60 L, 40 L and 70 L, 40 L and 80 L, 40 L and 90 L, 40 L and 100 L, 50 L and 60 L, 50 L and 70 L, 50 L and 80 L, 50 L and 90 L, 50 L and 100 L, 60 L and 70 L, 60 L and 80 L, 60 L and 90 L, 60 L and 100 L, 70 L and 80 L, 70 L and 90 L, 70 L and 100 L, 80 L and 90 L, 80 L and 100 L, or 90 L and 100 L of H₂O₂ (e.g., with a concentration of about 30% by weight) may be provided per 1 kg of GO. In some embodiments, greater than or equal to about 10 L, 20 L, 30 L, 40 L, 50 L, 60 L, 70 L, 80 L, 90 L, or 100 L of H₂O₂ (e.g., with a concentration of about 30% by weight) per 1 kg GO may be provided. In some embodiments, less than about 100 L, 90 L, 80 L, 70 L, 60 L, 50 L, 40 L, 30 L, 20 L, or 15 L of H₂O₂ (e.g., with a concentration of about 30% by weight) per 1 kg GO may be provided. An amount of H₂O₂ equivalent to any of the aforementioned amounts of the 30% solution may be added as a solution with a different concentration or in concentrated or pure form (e.g., 90%-100% by weight). The amount of H₂O₂ equivalent to any of the aforementioned amounts of the 30% solution may be expressed in terms of volume based on a 100% (or pure) solution. The amount of H₂O₂ equivalent to any of the aforementioned amounts of the 30% solution may be expressed in terms of moles or in terms of weight of H₂O₂. For example, between about 3 kg (or 88 moles) and 30 kg (or 882 moles) of (pure) H₂O₂ may be provided per 1 kg GO. Expressed on a weight basis, between about 3 kg and 6 kg, 3 kg and 9 kg, 3 kg and 12 kg, 3 kg and 15 kg, 3 kg and 18 kg, 3 kg and 21 kg, 3 kg and 24 kg, 3 kg and 27 kg, 3 kg and 30 kg, 6 kg and 9 kg, 6 kg and 12 kg, 6 kg and 15 kg, 6 kg and 18 kg, 6 kg and 21 kg, 6 kg and 24 kg, 6 kg and 27 kg, 6 kg and 30 kg, 9 kg and 12 kg, 9 kg and 15 kg, 9 kg and 18 kg, 9 kg and 21 kg, 9 kg and 24 kg, 9 kg and 30 kg, 12 kg and 15 kg, 12 kg and 18 kg, 12 kg and 21 kg, 12 kg and 24 kg, 12 kg and 27 kg, 12 kg and 30 kg, 15 kg and 18 kg, 15 kg and 21 kg, 15 kg and 24 kg, 15 kg and 30 kg, 18 kg and 21 kg, 18 kg and 24 kg, 18 kg and 27 kg, 18 kg and 30 kg, 21 kg and 24 kg, 21 kg and 27 kg, 21 kg and 30 kg, 24 kg and 27 kg, 24 kg and 30 kg, or 27 kg and 30 kg of pure H₂O₂ may be added per 1 kg GO. Expressed on a weight basis, greater than or equal to about 3 kg, 6 kg, 9 kg, 12 kg, 15 kg, 18 kg, 21 kg, 24 kg, or 30 kg of pure H₂O₂ per 1 kg GO may be provided. Expressed on a weight basis, less than about 30 kg, 24 kg, 21 kg, 18 kg, 15 kg, 12 kg, 9 kg, 6 kg, or 4.5 kg of pure H₂O₂ per 1 kg GO may be provided.

In some embodiments, sodium ascorbate may be provided in an amount between about 1 kg and 10 kg per 1 kg GO. For example, between about 1 kg and 2 kg, 1 kg and 3 kg, 1 kg and 4 kg, 1 kg and 5 kg, 1 kg and 6 kg, 1 kg and 7 kg, 1 kg and 8 kg, 1 kg and 9 kg, 1 kg and 10 kg, 2 kg and 3 kg, 2 kg and 4 kg, 2 kg and 5 kg, 2 kg and 6 kg, 2 kg and 7 kg, 2 kg and 8 kg, 2 kg and 9 kg, 2 kg and 10 kg, 3 kg and 4 kg, 3 kg and 5 kg, 3 kg and 6 kg, 3 kg and 7 kg, 3 kg and 8 kg, 3 kg and 9 kg, 3 kg and 10 kg, 4 kg and 5 kg, 4 kg and 6 kg, 4 kg and 7 kg, 4 kg and 8 kg, 4 kg and 9 kg, 4 kg and 10 kg, 5 kg and 6 kg, 5 kg and 7 kg, 5 kg and 8 kg, 5 kg and 9 kg, 5 kg and 10 kg, 6 kg and 7 kg, 6 kg and 8 kg, 6 kg and 9 kg, 6 kg and 10 kg, 7 kg and 8 kg, 7 kg and 9 kg, 7 kg and 10 kg, 8 kg and 9 kg, 8 kg and 10 kg, or 9 kg and 10 kg of sodium ascorbate may be provided per 1 kg of GO. In some embodiments, greater than or equal to about 1 kg, 2 kg, 3 kg, 4 kg, 5 kg, 6 kg, 7 kg, 8 kg, 9 kg or 10 kg of sodium ascorbate per 1 kg GO may be provided. In some embodiments, less than about 15 kg, 14 kg, 13 kg, 12 kg, 11 kg, 10 kg, 9 kg, 8 kg, 7 kg, 6 kg, 5 kg, 4 kg, 3 kg, 2 kg or 1.5 kg of sodium ascorbate per 1 kg GO may be provided.

In some embodiments, for 1 kg of GO, between about 10 L and 100 L of 30% H₂O₂ and between about 1 kg and 10 kg of sodium ascorbate may be used.

In some embodiments, at least about y=90%, 95%, 98%, 99%, or 99.5%, or substantially all of the GO may be converted. The amount of PCS produced per unit of GO may depend on the oxygen content of the GO and on the oxygen content of the PCS. In some embodiments, the C:O atomic ratio of the GO may be, for example, between about 4:1 and 5:1, and the oxygen content of the PCS may be, for example, less than or equal to about 5 atomic percent. In such cases, the amount of PCS produced may be between about 0.75y and 0.84 units of PCS per unit of GO on a weight basis. In some embodiments, the C:O atomic ratio of the GO may be, for example, between about 7:3 and 5:1, and the oxygen content of the PCS may be, for example, less than or equal to about 5 atomic percent. In such cases, the amount of PCS produced may be between about 0.64y and 0.84 units of PCS per unit of GO on a weight basis. In some embodiments, the C:0 atomic ratio of the GO may be, for example, at least about 7:3, and the oxygen content of the PCS may be, for example, less than or equal to about 5 atomic percent. In such cases, the amount of PCS produced may be at least about 0.64y units of PCS per unit of GO on a weight basis. In some embodiments, the amount of PCS produced may be at least about 0.5, 0.55, 0.6, 0.65, 0.7, 0.75, or 0.8 units of PCS per unit of GO on a weight basis. In some embodiments, the amount of PCS produced may be between about 0.5 and 0.85, 0.6 and 0.8, or 0.7 and 0.8 units of PCS per unit of GO on a weight basis.

A second purification may include purifying PCS via vacuum filtration through, for example, a 2 micron 316 stainless steel mesh filter. The filtration (also “second filtration” herein) may be performed after the second reaction. After the second reaction, there may be several impurities such as, for example, sodium ascorbate, plus small amounts of H₂SO₄, manganese oxides, and manganese salts. The filtration may remove at least a portion of the impurities from the solution. Water, acid, and/or salts may be left over from second reaction. For example, there may be about 4.95 kg of sodium ascorbate per kilogram of GO left over in solution from the second reaction. There may also be impurities from the GO. For example, there may remain small amounts of H₂SO₄, manganese oxides, and manganese salts from the initial oxidation (e.g., first reaction).

Water may be flushed through the PCS to remove salts. The conductivity of the solution after reduction may be greater than about 200 millisiemens per centimeter (mS/cm). The PCS solution may be washed with deionized water (e.g., with copious amounts of deionized water) until the conductivity of the PCS solution reaches about 50 microsiemens per centimeter (μS/cm) or less. Purification may be complete when the PCS solution has a conductivity of about 50 μS/cm or less. A given amount or degree of concentration may be needed for straight PCS use. For example, a concentration of about 2% by weight or greater may be needed.

### Energy Storage Devices

Energy storage devices of the present disclosure may comprise at least one electrode (e.g., a positive electrode and a negative electrode). The carbon-based material of the present disclosure may be provided in the positive electrode (cathode during discharge), the negative electrode (anode during discharge), or both. In certain embodiments, the energy storage device may be a lithium-ion battery. In certain embodiments, the energy storage device may be a lithium metal battery. In certain embodiments, the energy storage device may be a supercapacitor.

A battery may comprise at least one cell comprising a negative electrode (anode during discharge) comprising graphite, and a positive electrode (cathode during discharge) comprising PCS/lithium iron phosphate (LFP). A configuration/form factor of the battery may be as described elsewhere herein (e.g., cylindrical, pouch, prismatic, or button cells of various sizes). In certain embodiments, the battery may have a cylindrical configuration/form factor (e.g., 18650 packaging). It will be appreciated that while the positive electrode and battery in this example is primarily described as comprising PCS, such positive electrodes and batteries may comprise any carbon-based material in accordance with the present disclosure.

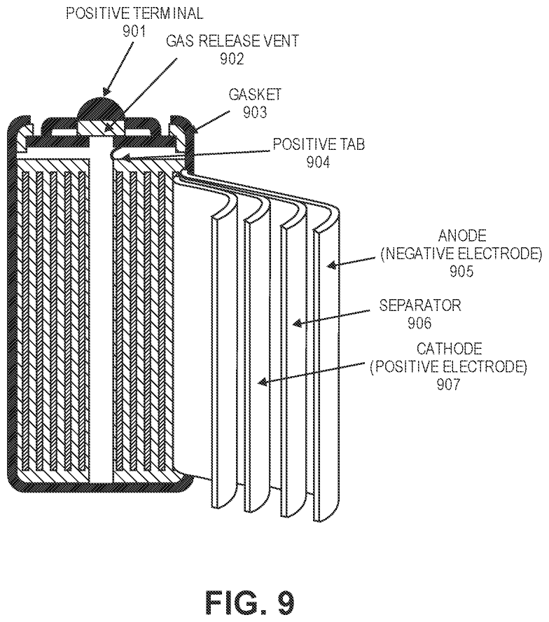

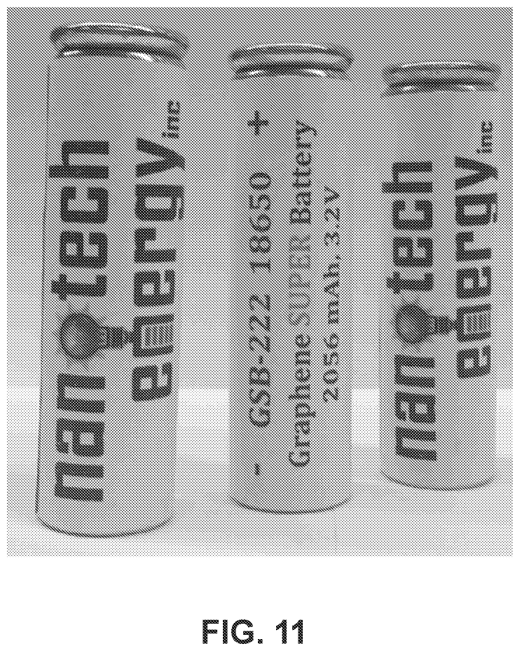

FIG. 9 is a schematic illustration of an example of a structure of a (battery) cell (e.g., an LFP-based cell). The battery comprises a positive terminal 901, a gas release vent 902 adjacent to the positive terminal 901, and a gasket 903 that seals the interior of the battery. A positive tab 904 connects the positive terminal 901 to a positive electrode 907. A separator 906 separates the positive electrode from a negative electrode 905. In some embodiments, the battery comprises layered sheets of, in sequence, the separator 906, the positive electrode 907, the separator 906, and the negative electrode 905 rolled into a cylinder with a circular cross-section. In this configuration, at least a portion of the outer surface of the cell (e.g., bottom surface of cell can) may serve as a negative terminal. FIG. 11 shows examples of finished LFP-based batteries. In this instance, the batteries are configured with a cylindrical configuration/form factor.

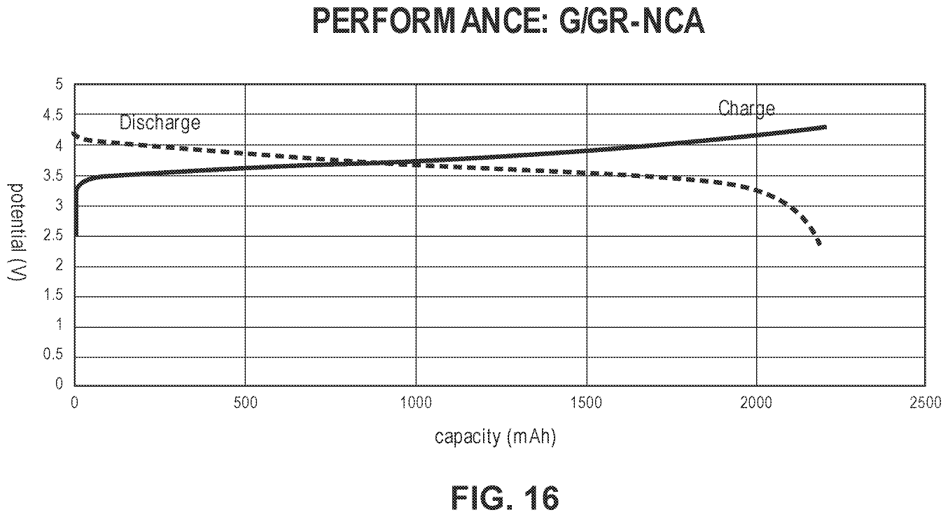

A battery may comprise at least one cell comprising a negative electrode (anode during discharge) comprising graphite, and a positive electrode (cathode during discharge) comprising PCS/lithium nickel cobalt aluminum oxide (NCA). A configuration/form factor of the battery may be as described elsewhere herein (e.g., cylindrical, pouch, prismatic, or button cells of various sizes). In certain embodiments, the battery may have a cylindrical configuration/form factor (e.g., 18650 packaging). FIG. 16 shows example performance of an NCA-based battery. It will be appreciated that while the positive electrode and battery in this example is primarily described as comprising PCS, such positive electrodes and batteries may comprise any carbon-based material in accordance with the present disclosure.

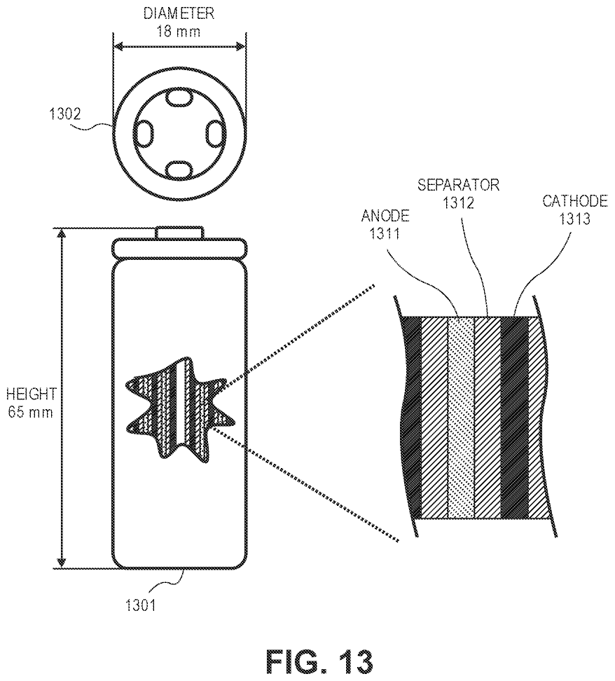

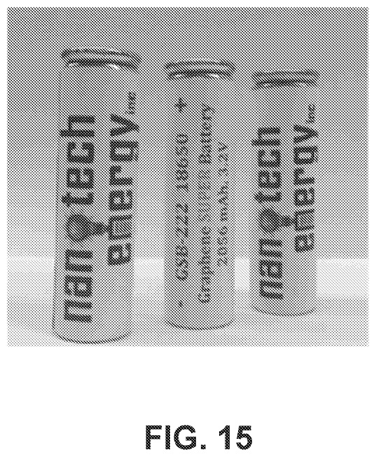

FIG. 13 is a schematic illustration of an example of a structure of a (battery) cell (e.g., an NCA-based cell). A side view 1301 and a top view 1302 of the battery are shown. In some embodiments, the battery has a height of about 65 mm, and a diameter of about 18 mm. A separator 1312 separates a cathode (positive electrode) 1313 from an anode (negative electrode) 1311. In some embodiments, the battery comprises layered sheets of the anode 1311, the separator 1312, and the cathode 1313 rolled into a cylinder with a circular cross-section. FIG. 15 shows examples of finished NCA-based batteries. In this instance, the batteries are configured with a cylindrical configuration/form factor.

A battery may comprise at least one cell comprising a negative electrode (anode during discharge) comprising graphite and a positive electrode (cathode during discharge) comprising PCS/lithium nickel manganese cobalt oxide (NMC). A configuration/form factor of the battery may be as described elsewhere herein (e.g., cylindrical, pouch, prismatic, or button cells of various sizes). In certain embodiments, the battery may have a pouch configuration/form factor (e.g., LiPoly packaging). It will be appreciated that while the positive electrode and battery in this example are primarily described as comprising PCS, such positive electrodes and batteries may comprise any carbon-based material in accordance with the present disclosure.

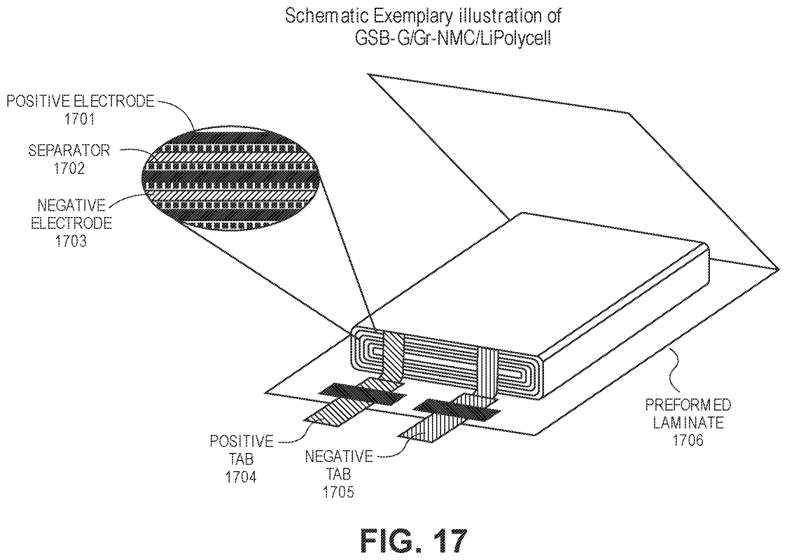

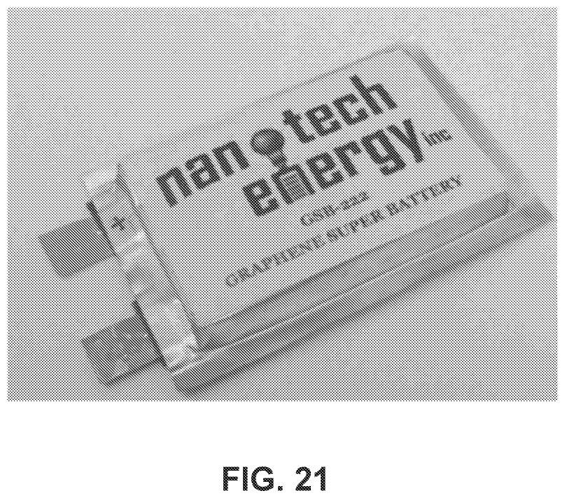

FIG. 17 is a schematic illustration of an example of a structure of a (battery) cell (e.g., an NMC-based cell). A separator 1702 separates a positive electrode 1701 from a negative electrode 1703. In some embodiments, the battery comprises layered sheets of the negative electrode 1703, the separator 1702, and the positive electrode 1701 rolled into a cylinder with a rectangular cross-section. The positive and negative electrodes are connected with a positive tab 1704 and a negative tab 1705, respectively. The battery may be encapsulated in a preformed aluminum laminate 1706. FIG. 21 shows an example of a finished NMC-based battery. In this instance, the battery is configured with a pouch configuration/form factor.

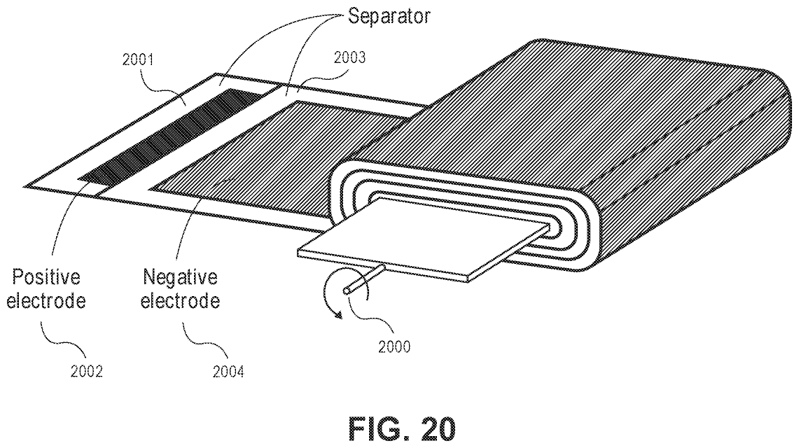

Energy storage devices of the present disclosure may have different configurations and/or form factors (e.g., see FIG. 9, FIG. 11, FIG. 13, FIG. 15, FIG. 17, and FIGS. 20-21). Any aspects of the present disclosure described in relation to a given configuration and/or form factor described in relation to an energy storage device comprising a given material or set of materials may equally apply to an energy storage device comprising a different material or set of materials described herein at least in some configurations. The energy storage devices of the present disclosure may be packaged in any form. The packaging may be driven by final application.

A given configuration and/or form factor may include a given packaging. The configuration and/or form factor may be selected based on application (e.g., a pouch cell may be selected for application in a cell phone, whereas cylindrical cells may be selected for certain other consumer devices). For example, a cell of an energy storage device described herein may be configured as a cylindrical cell, a pouch cell, a rectangular cell, a prismatic cell, a button cell, or another configuration. Each such configuration may have a given size and final form factor. The form factor may correspond to a given packaging. The packaging may be rigid or non-rigid. The packaging may or may not hermetically seal the cell.

Cylindrical, prismatic, and button cells may use metallic enclosures. A cylindrical cell may have an exterior stainless steel can as its package. In some embodiments, a cell may comprise 18 mm by 65 mm cylindrical cell packaging (also “18650 packaging” herein), 26 mm by 65 mm cylindrical cell packaging (also “26650 packaging” herein), or 32 mm by 65 mm cylindrical cell packaging (also “32650 packaging” herein). Such packaging may include, for example, one or more of outer metallic packaging and a negative terminal (e.g., a cell can), gasket(s), insulator(s), separator(s) (e.g., anode separator(s)), a metal mesh, and/or other components (e.g., see FIG. 9 and FIG. 13). The sealed can exterior may withstand high internal pressures. In some embodiments, the cylindrical cell package may include a pressure relief mechanism, for example, a membrane seal that ruptures upon excess internal pressure, and/or a re-sealable vent to release internal pressure.

A button cell may not have a safety vent. The button cell may comprise a cell can (e.g., in electrical communication with a positive electrode) sealed to a cap (e.g., in electrical communication with a negative electrode) with a gasket.

Prismatic cells may be contained in a rectangular can. A prismatic cell may be packaged, for example, in welded aluminum housings. Heavier gauge metal may be used for a prismatic cell container (e.g., a slightly thicker wall size may be used for the prismatic cell to compensate for decreased mechanical stability from a cylindrical configuration). In some embodiments, electrodes of a prismatic cell may be stacked. In some embodiments, electrodes of a prismatic cell may be in the form of a flattened spiral. Prismatic cells may be configured in various formats and/or sizes. Such formats and/or sizes may be configured, for example, based on charge storage capacity (e.g., 800 milliamp hours (mAh) to 4,000 mAh format for mobile phones, tablets, low-profile laptops, and other portable consumer electronics, or 20-50 Ah for electric powertrains in hybrid and electric vehicles).

Soft case/pack or pouch cells may comprise a laminated architecture in a bag of thin aluminized plastic, glued with different types of polymers for tightness. A pouch cell may comprise heat-sealable multi-layer foil packaging (e.g., see FIG. 17). Such packaging may serve as a soft pack. The electrical contacts in the pouch cell may comprise conductive foil tabs welded to the electrodes and sealed to the pouch material (e.g., brought to the outside in a fully sealed way). The pouch cell may be packaged using, for example, lithium polymer battery packaging (e.g., packaging used for lithium polymer cells with solid electrolytes, also “LiPoly packaging” herein). Such packaging may include, for example, a foil pouch with an outer plastic laminate. A pouch cell may have different sizes. In some embodiments, a pouch cell may be configured or sized for a specific application (e.g., pouch cells may be placed into small areas between custom electronics packages). In some embodiments, a size of a pouch cell may correspond to given charge storage capacity (e.g., a charge storage capacity in the 40 Ah range for use in energy storage systems or a charge storage capacity suitable for cell phone and portable consumer electronics applications such as drones and hobby gadgets).

### Composition of Energy Storage Devices

A lithium-ion battery (LIB) may comprise a negative electrode. In some embodiments, the LIB may comprise a carbon-based negative electrode (e.g., comprising graphite or carbon nanotubes). In some embodiments, the LIB may comprise a silicon (Si) negative electrode. In some embodiments, the LIB may comprise an alloy-based negative electrode (e.g., comprising tin alloys). In some embodiments, the LIB may comprise an oxide or sulfide-based negative electrode (e.g., comprising manganese(II) oxide (MnO) or magnesium sulfide (MgS)). The LIB may comprise a positive electrode comprising an oxide, for example, layered oxide (e.g., LiCoO₂), spinel (e.g., LiMn₂O₄), or olivine (e.g., LiFePO₄). The LIB may comprise conductive additive(s). The conductive additive(s) may be provided in the positive electrode, the negative electrode, or both. The conductive additive(s) may include, for example, carbon black or carbon nanotubes. The LIB may comprise a binder, wherein the binder comprises at least one of a first binder and a second binder. In some embodiments, the first binder is the same as the second binder. In some embodiments, the first binder is not the same as the second binder. The LIB may comprise an electrolyte. The electrolyte may include, for example, a lithium salt (e.g., lithium hexafluorophosphate (LiPF₆), lithium tetrafluoroborate (LiBF₄), or lithium perchlorate (LiClO₄)) in an organic solution (e.g., ethylene carbonate, dimethyl carbonate, or diethyl carbonate).

In some embodiments, the carbon-based material of the present disclosure may be provided in the positive electrode of a lithium-ion battery. The carbon-based material may be used as a conductive additive (e.g., to replace carbon black). The carbon-based material may be used as an active material in the positive electrode.

In some embodiments, the carbon-based material of the present disclosure may be provided in the negative electrode of a lithium-ion battery. The carbon-based material may be used as an active material in the negative electrode. The carbon-based material may be used as coating on other active materials (e.g., Si) and/or may form composites with other active materials (e.g., Si) for the negative electrode.

In some embodiments, the carbon-based material of the present disclosure may be provided in the negative electrode of a lithium metal battery. The carbon-based material may be used as coating on the lithium negative electrode (e.g., to inhibit dendrite growth).

In some embodiments, the carbon-based material of the present disclosure may be provided in the positive electrode and in the negative electrode of a lithium-ion battery. The carbon-based material may be used as a conductive additive in the positive electrode and at the same time as active material in the negative electrode. The carbon-based material may be used as active material in the positive electrode (e.g., when GO is used in the negative electrode).

In some embodiments, the carbon-based material of the present disclosure may be provided as active material in symmetric supercapacitors. The carbon-based material may be used in both electrodes (e.g., as carbon-based aerogel).

In some embodiments, the carbon-based material of the present disclosure may be provided as active material in asymmetric supercapacitors. The carbon-based material may be used as one electrode and coupled with another electrode made of other materials (e.g., MnO₂). The carbon-based material may also be used in both electrodes when it forms composites with different materials in the two electrodes.

The energy storage devices described herein may comprise an electrolyte. Electrolytes described herein may include, for example, aqueous, organic, and/or ionic liquid-based electrolytes. The electrolyte may be liquid, solid, or a gel. An ionic liquid may be hybridized with another solid component, for example, polymer or silica (e.g., fumed silica), to form a gel-like electrolyte (also “ionogel” herein). An aqueous electrolyte may be hybridized with, for example, a polymer, to form a gel-like electrolyte (also “hydrogel” and “hydrogel-polymer” herein). An organic electrolyte may be hybridized with, for example, a polymer, to form a gel-like electrolyte. In some embodiments, the electrolyte may also include a lithium salt (e.g., LiPF₆, LiBF₄, or LiClO₄). For example, the electrolyte may include a lithium salt (e.g., LiPF₆, LiBF₄, or LiClO₄) in an organic solution (e.g., ethylene carbonate (EC), dimethyl carbonate (DMC), or diethyl carbonate (DEC)). The electrolyte may comprise one or more additional components (e.g., one or more additives). In some embodiments, an electrolyte composition (e.g., a soft pack polymer LIB electrolyte) may include one or more of EC, ethyl methyl carbonate (EMC), DEC, LiPF₆, and an additive. In some embodiments, an electrolyte composition (e.g., a high capacity LIB electrolyte) may include one or more of EC, DEC, propylene carbonate (PC), LiPF₆, and an additive.

The energy storage device may comprise a polymer. In some embodiments, the energy storage device may comprise a separator. For example, the energy storage device may comprise a polyethylene separator (e.g., an ultra-high molecular weight polyethylene separator). The separator may have a thickness of less than or equal to about 16 μm, 15 μm, 14 μm, 13 μm, 12 μm, 11 μm, 10 μm, 9 μm, or 8 μm (e.g., about 12±2.0 μm). The separator may have a given permeability. The separator may have a permeability (e.g., Gurley type) of greater than or equal to about 150 sec/100 mL, 160 sec/100 mL, 170 sec/100 mL, 180 sec/100 mL, 190 sec/100 mL, 200 sec/100 mL, 210 sec/100 mL, 220 sec/100 mL, 230 sec/100 mL, 240 sec/100 mL, 250 sec/100 mL, 260 sec/100 mL, 270 sec/100 mL, 280 sec/100 mL, 290 sec/100 mL, or 300 sec/100 mL (e.g., 180±50 sec/100 mL). Alternatively, the separator may have a permeability (e.g., Gurley type) of less than about 150 sec/100 mL, 160 sec/100 mL, 170 sec/100 mL, 180 sec/100 mL, 190 sec/100 mL, 200 sec/100 mL, 210 sec/100 mL, 220 sec/100 mL, 230 sec/100 mL, 240 sec/100 mL, 250 sec/100 mL, 260 sec/100 mL, 270 sec/100 mL, 280 sec/100 mL, 290 sec/100 mL, or 300 sec/100 mL. The separator may have a given porosity. The separator may have a porosity of greater than or equal to about 35%, 40%, 45%, or 50% (e.g., 40%±5%). Alternatively, the separator may have a porosity of less than about 35%, 40%, 45%, or 50%. The separator may have a given shut-down temperature (e.g., above the shut-down temperature, the separator may not function normally). In some embodiments, the separator may have a shut-down temperature (actual) of less than or equal to about 150° C., 140° C., 130° C., 120° C., 110° C., or 100° C. In some embodiments, the separator may have a shut-down temperature (DSC) between about 130° C. and 150° C., 130° C. and 140° C., or 136° C. and 140° C.

An active material of an electrode (e.g., a positive electrode of a LIB) may include, for example, graphene, lithium iron phosphate (LFP; LiFePO₄), lithium nickel cobalt aluminum oxide (NCA; LiNiCoAlO₂), lithium nickel manganese cobalt oxide (NMC; LiNiMnCoO₂), lithium cobalt oxide (LCO; LiCoO₂), lithium manganese oxide (LMO; LiMn₂O₄), lithium titanate (LTO; Li₄Ti₅O₁₂), lithium sulfur, or any combination thereof. One or more of such active materials may be present in the electrode at an individual or combined concentration (e.g., by weight on a dry basis, without solvent) between about 0.25% and 0.5%, 0.25% and 0.75%, 0.25% and 1%, 0.25% and 2%, 0.25% and 5%, 0.25% and 10%, 0.25% and 20%, 0.25% and 30%, 0.25% and 40%, 0.25% and 50%, 0.5% and 0.75%, 0.5% and 1%, 0.5% and 2%, 0.5% and 5%, 0.5% and 10%, 0.5% and 20%, 0.5% and 30%, 0.5% and 40%, 0.5% and 50%, 0.75% and 1%, 0.75% and 2%, 0.75% and 5%, 0.75% and 10%, 0.75% and 20%, 0.75% and 30%, 0.75% and 40%, 0.75% and 50%, 1% and 2%, 1% and 5%, 1% and 10%, 1% and 20%, 1% and 30%, 1% and 40%, 1% and 50%, 2% and 5%, 2% and 10%, 2% and 20%, 2% and 30%, 2% and 40%, 2% and 50%, 5% and 10%, 5% and 20%, 5% and 30%, 5% and 40%, 5% and 50%, 10% and 20%, 10% and 30%, 10% and 40%, 10% and 50%, 20% and 30%, 20% and 40%, 20% and 50%, 30% and 40%, 30% and 50%, 40% and 50%, 50% and 55%, 50% and 60%, 50% and 65%, 50% and 67%, 50% and 69%, 50% and 71%, 50% and 73%, 50% and 75%, 50% and 77%, 50% and 79%, 50% and 81%, 50% and 83%, 50% and 85%, 50% and 87%, 50% and 89%, 50% and 91%, 50% and 93%, 50% and 95%, 50% and 97%, 50% and 99%, 55% and 60%, 55% and 65%, 55% and 67%, 55% and 69%, 55% and 71%, 55% and 73%, 55% and 75%, 55% and 77%, 55% and 79%, 55% and 81%, 55% and 83%, 55% and 85%, 55% and 87%, 55% and 89%, 55% and 91%, 55% and 93%, 55% and 95%, 55% and 97%, 55% and 99%, 60% and 65%, 60% and 67%, 60% and 69%, 60% and 71%, 60% and 73%, 60% and 75%, 60% and 77%, 60% and 79%, 60% and 81%, 60% and 83%, 60% and 85%, 60% and 87%, 60% and 89%, 60% and 91%, 60% and 93%, 60% and 95%, 60% and 97%, 60% and 99%, 65% and 67%, 65% and 69%, 65% and 71%, 65% and 73%, 65% and 75%, 65% and 77%, 65% and 79%, 65% and 81%, 65% and 83%, 65% and 85%, 65% and 87%, 65% and 89%, 65% and 91%, 65% and 93%, 65% and 95%, 65% and 97%, 65% and 99%, 67% and 69%, 67% and 71%, 67% and 73%, 67% and 75%, 67% and 77%, 67% and 79%, 67% and 81%, 67% and 83%, 67% and 85%, 67% and 87%, 67% and 89%, 67% and 91%, 67% and 93%, 67% and 95%, 67% and 97%, 67% and 99%, 69% and 71%, 69% and 73%, 69% and 75%, 69% and 77%, 69% and 79%, 69% and 81%, 69% and 83%, 69% and 85%, 69% and 87%, 69% and 89%, 69% and 91%, 69% and 93%, 69% and 95%, 69% and 97%, 69% and 99%, 71% and 73%, 71% and 75%, 71% and 77%, 71% and 79%, 71% and 81%, 71% and 83%, 71% and 85%, 71% and 87%, 71% and 89%, 71% and 91%, 71% and 93%, 71% and 95%, 71% and 97%, 71% and 99%, 73% and 75%, 73% and 77%, 73% and 79%, 73% and 81%, 73% and 83%, 73% and 85%, 73% and 87%, 73% and 89%, 73% and 91%, 73% and 93%, 73% and 95%, 73% and 97%, 73% and 99%, 75% and 77%, 75% and 79%, 75% and 81%, 75% and 83%, 75% and 85%, 75% and 87%, 75% and 89%, 75% and 91%, 75% and 93%, 75% and 95%, 75% and 97%, 75% and 99%, 77% and 79%, 77% and 81%, 77% and 83%, 77% and 85%, 77% and 87%, 77% and 89%, 77% and 91%, 77% and 93%, 77% and 95%, 77% and 97%, 77% and 99%, 79% and 81%, 79% and 83%, 79% and 85%, 79% and 87%, 79% and 89%, 79% and 91%, 79% and 93%, 79% and 95%, 79% and 97%, 79% and 99%, 81% and 83%, 81% and 85%, 81% and 87%, 81% and 89%, 81% and 91%, 81% and 93%, 81% and 95%, 81% and 97%, 81% and 99%, 83% and 85%, 83% and 87%, 83% and 89%, 83% and 91%, 83% and 93%, 83% and 95%, 83% and 97%, 83% and 99%, 85% and 87%, 85% and 89%, 85% and 91%, 85% and 93%, 85% and 95%, 85% and 97%, 85% and 99%, 87% and 89%, 87% and 91%, 87% and 93%, 87% and 95%, 87% and 97%, 87% and 99%, 89% and 91%, 89% and 93%, 89% and 95%, 89% and 97%, 89% and 99%, 90% and 90.5%, 90% and 91%, 90% and 91.5%, 90% and 92%, 90% and 92.5%, 90% and 93%, 90% and 93.5%, 90% and 94%, 90% and 94.5%, 90% and 95%, 90% and 95.5%, 90% and 96%, 90% and 96.5%, 90% and 97%, 90% and 97.5%, 90% and 98%, 90% and 98.5%, 90% and 99%, 90% and 99.5%, 90.5% and 91%, 90.5% and 91.5%, 90.5% and 92%, 90.5% and 92.5%, 90.5% and 93%, 90.5% and 93.5%, 90.5% and 94%, 90.5% and 94.5%, 90.5% and 95%, 90.5% and 95.5%, 90.5% and 96%, 90.5% and 96.5%, 90.5% and 97%, 90.5% and 97.5%, 90.5% and 98%, 90.5% and 98.5%, 90.5% and 99%, 90.5% and 99.5%, 91% and 91.5%, 91% and 92%, 91% and 92.5%, 91% and 93%, 91% and 93.5%, 91% and 94%, 91% and 94.5%, 91% and 95%, 91% and 95.5%, 91% and 96%, 91% and 96.5%, 91% and 97%, 91% and 97.5%, 91% and 98%, 91% and 98.5%, 91% and 99%, 91% and 99.5%, 91.5% and 92%, 91.5% and 92.5%, 91.5% and 93%, 91.5% and 93.5%, 91.5% and 94%, 91.5% and 94.5%, 91.5% and 95%, 91.5% and 95.5%, 91.5% and 96%, 91.5% and 96.5%, 91.5% and 97%, 91.5% and 97.5%, 91.5% and 98%, 91.5% and 98.5%, 91.5% and 99%, 91.5% and 99.5%, 92% and 92.5%, 92% and 93%, 92% and 93.5%, 92% and 94%, 92% and 94.5%, 92% and 95%, 92% and 95.5%, 92% and 96%, 92% and 96.5%, 92% and 97%, 92% and 97.5%, 92% and 98%, 92% and 98.5%, 92% and 99%, 92% and 99.5%, 92.5% and 93%, 92.5% and 93.5%, 92.5% and 94%, 92.5% and 94.5%, 92.5% and 95%, 92.5% and 95.5%, 92.5% and 96%, 92.5% and 96.5%, 92.5% and 97%, 92.5% and 97.5%, 92.5% and 98%, 92.5% and 98.5%, 92.5% and 99%, 92.5% and 99.5%, 93% and 93.5%, 93% and 94%, 93% and 94.5%, 93% and 95%, 93% and 95.5%, 93% and 96%, 93% and 96.5%, 93% and 97%, 93% and 97.5%, 93% and 98%, 93% and 98.5%, 93% and 99%, 93% and 99.5%, 93.5% and 94%, 93.5% and 94.5%, 93.5% and 95%, 93.5% and 95.5%, 93.5% and 96%, 93.5% and 96.5%, 93.5% and 97%, 93.5% and 97.5%, 93.5% and 98%, 93.5% and 98.5%, 93.5% and 99%, 93.5% and 99.5%, 94% and 94.5%, 94% and 95%, 94% and 95.5%, 94% and 96%, 94% and 96.5%, 94% and 97%, 94% and 97.5%, 94% and 98%, 94% and 98.5%, 94% and 99%, 94% and 99.5%, 94.5% and 95%, 94.5% and 95.5%, 94.5% and 96%, 94.5% and 96.5%, 94.5% and 97%, 94.5% and 97.5%, 94.5% and 98%, 94.5% and 98.5%, 94.5% and 99%, 94.5% and 99.5%, 95% and 95.5%, 95% and 96%, 95% and 96.5%, 95% and 97%, 95% and 97.5%, 95% and 98%, 95% and 98.5%, 95% and 99%, 95% and 99.5%, 95.5% and 96%, 95.5% and 96.5%, 95.5% and 97%, 95.5% and 97.5%, 95.5% and 98%, 95.5% and 98.5%, 95.5% and 99%, 95.5% and 99.5%, 96% and 96.5%, 96% and 97%, 96% and 97.5%, 96% and 98%, 96% and 98.5%, 96% and 99%, 96% and 99.5%, 96.5% and 97%, 96.5% and 97.5%, 96.5% and 98%, 96.5% and 98.5%, 96.5% and 99%, 96.5% and 99.5%, 97% and 97.5%, 97% and 98%, 97% and 98.5%, 97% and 99%, 97% and 99.5%, 97.5% and 98%, 97.5% and 98.5%, 97.5% and 99%, 97.5% and 99.5%, 98% and 98.5%, 98% and 99%, 98% and 99.5%, 98.5% and 99%, 98.5% and 99.5%, or 99% and 99.5%. One or more of such active materials may be present in the electrode at an individual or combined concentration (e.g., by weight on a dry basis, without solvent) of greater than or equal to about 50%, 51%, 52%, 53%, 54%, 55%, 56%, 57%, 58%, 59%, 60%, 61%, 62%, 63%, 64%, 65%, 65.5%, 66%, 66.5%, 67%, 67.5%, 68%, 68.5%, 69%, 69.5%, 70%, 70.5%, 71%, 71.5%, 72%, 72.5%, 73%, 73.5%, 74%, 74.5%, 75%, 75.5%, 76%, 76.5%, 77%, 77.5%, 78%, 78.5%, 79%, 79.5%, 80%, 80.5%, 81%, 81.5%, 82%, 82.5%, 83%, 83.5%, 84%, 84.5%, 85%, 85.5%, 86%, 86.5%, 87%, 87.5%, 88%, 88.5%, 89%, 89.5%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, 99.5%, or 99.9%. In addition, or as an alternative, one or more of such active materials may be present in the electrode at an individual or combined concentration of less than or equal to about 99.9%, 99.5%, 99%, 98.5%, 98%, 97.5%, 97%, 96.5%, 96%, 95.5%, 95%, 94.5%, 94%, 93.5%, 93%, 92.5%, 92%, 91.5%, 91%, 90.5%, 90%, 89.5%, 89%, 88.5%, 88%, 87.5%, 87%, 86.5%, 86%, 85.5%, 85%, 84.5%, 84%, 83.5%, 83%, 82.5%, 82%, 81.5%, 81%, 80.5%, 80%, 79.5%, 79%, 78.5%, 78%, 77.5%, 77%, 76.5%, 76%, 75.5%, 75%, 74.5%, 74%, 73.5%, 73%, 72.5%, 72%, 71.5%, 71%, 70.5%, 70%, 69.5%, 69%, 68.5%, 68%, 67.5%, 67%, 66.5%, 66%, 65.5%, 65%, 64%, 63%, 62%, 61%, 60%, 59%, 58%, 57%, 56%, 55%, 54%, 53%, 52%, 51%, or 50%. One or more of such active materials may be present in the electrode at such concentrations in combination with one or more other materials (e.g., one or more other electrode materials and concentrations thereof described herein).

The aforementioned active material may comprise non-lithium metals at a given ratio. For example, the active material may comprise nickel, cobalt, and aluminum at a given ratio (e.g., about 0.815:0.15:0.035 for NCA), or nickel, cobalt, and manganese at a given ratio (e.g., about 6:2:2 for NMC). The active material may comprise at least 1, 2, 3, 4, 5, or more non-lithium metals. The non-lithium metals may be selected among, for example, nickel, cobalt, aluminum, manganese, iron, and titanium. In some embodiments, the active material may comprise a first non-lithium metal at a ratio (e.g., by weight or by mol) of at least about 1, 2, 3, 4, 5, 6, 7, 8, 9, 10, or 15 with respect to a second non-lithium metal. In some embodiments, the active material may comprise the first non-lithium metal at a ratio (e.g., by weight or by mol) of at least about 1, 2, 3, 4, 5, 6, 8, 10, 12, 14, 16, 18, 20, 22, 24, 26, 28, 30, or 35 with respect a third non-lithium metal. In some embodiments, the active material may comprise the second non-lithium metal at a ratio (e.g., by weight or by mol) of at least about 1, 2, 3, 4, 5, 6, 7, 8, 9, 10, or 15 with respect to the third non-lithium metal. The active material may comprise the non-lithium metal(s) and/or one or more non-metals at an individual or combined concentration (e.g., by weight) of greater than or equal to about 1%, 2%, 4%, 6%, 8%, 10%, 15%, 20%, 25%, 30%, 35%, 40%, 45%, 50%, 55%, 60%, 65%, 70%, 75%, 80%, 85%, 90%, 95%, or 99%. In addition, or as an alternative, the active material may comprise the non-lithium metal(s) and/or the one or more non-metals at an individual or combined concentration (e.g., by weight) of less than or equal to about 99.5%, 99%, 95%, 90%, 85%, 80%, 75%, 70%, 65%, 60%, 55%, 50%, 45%, 40%, 35%, 30%, 25%, 20%, 15%, 10%, 5%, or 2%. In certain embodiments, the active material may comprise nickel, cobalt, and aluminum at a concentration (e.g., by weight total) of at least about 50%, 51%, 52%, 53%, 54%, 55%, 56%, 57%, 58%, 59%, or 60% (e.g., about 59±1.0% for NCA). In certain embodiments, the active material may comprise iron at a concentration (e.g., by weight) between about 33% and 36%, and phosphorus at a concentration (e.g., by weight) between about 19% and 21% (e.g., greater than or equal to about 58.5% for NMC). In certain embodiments, the active material may comprise nickel, cobalt, and aluminum at a concentration (e.g., by weight total) of at least about 50%, 51%, 52%, 53%, 54%, 55%, 56%, 57%, 58%, 59%, or 60% (e.g., about 59±1.0% for NCA). The active material may comprise lithium at a concentration (e.g., by weight) of at greater than or equal to about 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10%. In addition, or as an alternative, the active material may comprise lithium at a concentration (e.g., by weight) of less than or equal to about 15%, 10%, 8%, 6%, 5%, 4%, 3%, 2%, or 1.5%. For example, the active material may comprise lithium at a concentration (e.g., by weight) of about 7.2±0.4% for NCA, 7.1% for NMC, or between about 3.9% and 4.9% for LFP. The active material may comprise such lithium concentrations in addition to the aforementioned concentrations of non-lithium metals (e.g., of nickel, cobalt, and aluminum, or of nickel, cobalt, and manganese). The active material may have a given specific surface area. The active material may have a specific surface area greater than or equal to about 0.1 square meter per gram (m²/g), 0.2 m²/g, 0.3 m²/g, 0.4 m²/g, 0.5 m²/g, 0.6 m²/g, 0.7 m²/g, 0.8 m²/g, 0.9 m²/g, 1 m²/g, 2 m²/g, 3 m²/g, 4 m²/g, 5 m²/g, 6 m²/g, 7 m²/g, 8 m²/g, 9 m²/g, 10 m²/g, 11 m²/g, 12 m²/g, 13 m²/g, 14 m²/g, 15 m²/g, 16 m²/g, 17 m²/g, 18 m²/g, 19 m²/g, 20 m²/g or 25 m²/g. In addition, or as an alternative, the active material may have a specific surface area of less than or equal to about 30 m²/g, 25 m²/g, 20 m²/g, 19 m²/g, 18 m²/g, 17 m²/g, 16 m²/g, 15 m²/g, 14 m²/g, 13 m²/g, 12 m²/g, 11 m²/g, 10 m²/g, 9 m²/g, 8 m²/g, 7 m²/g, 6 m²/g, 5 m²/g, 4 m²/g, 3 m²/g, 2 m²/g, 1 m²/g, 0.9 m²/g, 0.8 m²/g, 0.7 m²/g, 0.6 m²/g, 0.5 m²/g, 0.4 m²/g, 0.3 m²/g, or 0.2 m²/g. In some embodiments, the active material (e.g., NCA) may have a specific surface area between about 0.3 m²/g and 0.7 m²/g. In some embodiments, the active material (e.g., NMC) may have a specific surface area between about 0.2 m²/g and 0.5 m²/g. In some embodiments, the active material (e.g., LFP) may have a specific surface area between about 9 m²/g and 13 m²/g, or 8 m²/g and 12 m²/g. The active material may have a given first discharge capacity. The active material may have a first discharge capacity of greater than or equal to about 100 milliamp hours per gram (mAh/g), 105 mAh/g, 110 mAh/g, 115 mAh/g, 120 mAh/g, 125 mAh/g, 130 mAh/g, 135 mAh/g, 140 mAh/g, 145 mAh/g, 150 mAh/g, 155 mAh/g, 160 mAh/g, 165 mAh/g, 170 mAh/g, 175 mAh/g, 180 mAh/g, 185 mAh/g, 190 mAh/g, 195 mAh/g, 200 mAh/g, 205 mAh/g, 210 mAh/g, 215 mAh/g, or 220 mAh. In addition, or as an alternative, the active material may have a first discharge capacity less than or equal to about 230 mAh/g, 225 mAh/g, 220 mAh/g, 215 mAh/g, 210 mAh/g, 205 mAh/g, 200 mAh/g, 195 mAh/g, 190 mAh/g, 185 mAh/g, 180 mAh/g, 175 mAh/g, 170 mAh/g, 165 mAh/g, 160 mAh/g, 155 mAh/g, or 150 mAh/g. In some embodiments, the active material (e.g., NCA) may have a first discharge capacity of greater than or equal to about 195 mAh/g (e.g., at a charge/discharge rate of 0.1 C/0.1 C and a voltage window of 4.33.0 volts (V)). In some embodiments, the active material (e.g., NMC) may have a first discharge capacity greater than or equal to about 178 mAh/g (e.g., for a coin cell (e.g., CR2032) at a charge/discharge rate of 0.1 C/0.1 C and a voltage window of 3.0 V˜4.3 V versus lithium). In some embodiments, the active material (e.g., LFP) may have a first discharge capacity of greater than or equal to about 150 mAh/g (e.g., at 0.2 C). The active material may have a given capacity. The active material may have a capacity of greater than or equal to about 80 mAh/g, 85 mAh/g, 90 mAh/g, 95 mAh/g, 100 mAh/g, 105 mAh/g, 110 mAh/g, 115 mAh/g, 120 mAh/g, 125 mAh/g, 130 mAh/g, 135 mAh/g, 140 mAh/g, 145 mAh/g, 150 mAh/g, 155 mAh/g, 160 mAh/g, 165 mAh/g, 170 mAh/g, 175 mAh/g, 180 mAh/g, 185 mAh/g, 190 mAh/g, 195 mAh/g, 200 mAh/g, 220 mAh/g, 240 mAh/g, 260 mAh/g, 280 mAh/g, 300 mAh/g, 400 mAh/g, 500 mAh/g, 600 mAh/g, 700 mAh/g, 800 mAh/g, or 900 mAh/g. In addition, or as an alternative, the active material may have a capacity greater than or equal to about 600 mAh/g, 500 mAh/g, 400 mAh/g, 300 mAh/g, 250 mAh/g, 210 mAh/g, 205 mAh/g, 200 mAh/g, 195 mAh/g, 190 mAh/g, 185 mAh/g, 180 mAh/g, 175 mAh/g, 170 mAh/g, 165 mAh/g, 160 mAh/g, 155 mAh/g, 150 mAh/g, 145 mAh/g, 140 mAh/g, 135 mAh/g, or 130 mAh/g. In some embodiments, the active material (e.g., NMC) may have a capacity between about 162 mAh/g and 168 mAh/g (e.g., for a full cell at a charge/discharge rate of 0.5 C). The active material may have a given first discharge efficiency (e.g., greater than or equal to about 75%, 81%, 82%, 83%, 84%, 85% (e.g., NMC), 86%, 87%, 88%, 89% (e.g., NCA), 90%, 91%, 92%, 93%, 94%, or 95%). The active material may have any combination of one or more of the aforementioned particle size compositions, specific surface areas, first discharge capacities, capacities, first discharge efficiencies, and other properties.

An electrode (e.g., a positive or negative electrode of a LIB) may include a binder. In some embodiments, the binder comprises at least one of a first binder and a second binder. In some embodiments, the first binder is the same as the second binder. In some embodiments, the first binder is not the same as the second binder. A binder (e.g., a first binder or a second binder) may comprise, for example, one or more fluoropolymers (e.g., non-reactive thermoplastic fluoropolymers), copolymers, and/or other polymer types. Examples of binders may include, but are not limited to, polyvinyl fluoride (PVF), polyvinylidene fluoride (PVDF), polytetrafluoroethylene (PTFE), polychlorotrifluoroethylene (PCTFE), perfluoroalkoxy polymer (PFA, MFA), fluorinated ethylene-propylene (FEP), polyethylenetetrafluoroethylene (ETFE), polyethylenechlorotrifluoroethylene (ECTFE), perfluorinated plastomer (FFPM/FFKM), fluorocarbon or (also “chlorotrifluoroethylenevinylidene fluoride” in the claims herein; FPM/FKM), fluoroelastomer (also “tetrafluoroethylene-propylene” in the claims herein; FEPM), perfluoropolyether (PFPE), perfluorosulfonic acid (PFSA), perfluoropolyoxetane, P(VDF-trifluoroethylene), P(VDF-tetrafluoroethylene), or any combination thereof. One or more of such binder materials may be present in the electrode (e.g., in the positive electrode and/or in the negative electrode) at an individual or combined concentration (e.g., by weight on a dry basis, without solvent) between about 0.5% and 1%, 0.5% and 2%, 0.5% and 3%, 0.5% and 4%, 0.5% and 5%, 0.5% and 6%, 0.5% and 7%, 0.5% and 8%, 0.5% and 9%, 0.5% and 10%, 0.5% and 11%, 0.5% and 12%, 0.5% and 13%, 0.5% and 14%, 0.5% and 15%, 0.5% and 16%, 0.5% and 17%, 0.5% and 18%, 0.5% and 19%, 0.5% and 20%, 1% and 2%, 1% and 3%, 1% and 4%, 1% and 5%, 1% and 6%, 1% and 7%, 1% and 8%, 1% and 9%, 1% and 10%, 1% and 11%, 1% and 12%, 1% and 13%, 1% and 14%, 1% and 15%, 1% and 16%, 1% and 17%, 1% and 18%, 1% and 19%, 1% and 20%, 2% and 3%, 2% and 4%, 2% and 5%, 2% and 6%, 2% and 7%, 2% and 8%, 2% and 9%, 2% and 10%, 2% and 11%, 2% and 12%, 2% and 13%, 2% and 14%, 2% and 15%, 2% and 16%, 2% and 17%, 2% and 18%, 2% and 19%, 2% and 20%, 3% and 4%, 3% and 5%, 3% and 6%, 3% and 7%, 3% and 8%, 3% and 9%, 3% and 10%, 3% and 11%, 3% and 12%, 3% and 13%, 3% and 14%, 3% and 15%, 3% and 16%, 3% and 17%, 3% and 18%, 3% and 19%, 3% and 20%, 4% and 5%, 4% and 6%, 4% and 7%, 4% and 8%, 4% and 9%, 4% and 10%, 4% and 11%, 4% and 12%, 4% and 13%, 4% and 14%, 4% and 15%, 4% and 16%, 4% and 17%, 4% and 18%, 4% and 19%, 4% and 20%, 5% and 6%, 5% and 7%, 5% and 8%, 5% and 9%, 5% and 10%, 5% and 11%, 5% and 12%, 5% and 13%, 5% and 14%, 5% and 15%, 5% and 16%, 5% and 17%, 5% and 18%, 5% and 19%, 5% and 20%, 6% and 7%, 6% and 8%, 6% and 9%, 6% and 10%, 6% and 11%, 6% and 12%, 6% and 13%, 6% and 14%, 6% and 15%, 6% and 16%, 6% and 17%, 6% and 18%, 6% and 19%, 6% and 20%, 7% and 8%, 7% and 9%, 7% and 10%, 7% and 11%, 7% and 12%, 7% and 13%, 7% and 14%, 7% and 15%, 7% and 16%, 7% and 17%, 7% and 18%, 7% and 19%, 7% and 20%, 8% and 9%, 8% and 10%, 8% and 11%, 8% and 12%, 8% and 13%, 8% and 14%, 8% and 15%, 8% and 16%, 8% and 17%, 8% and 18%, 8% and 19%, 8% and 20%, 9% and 10%, 9% and 11%, 9% and 12%, 9% and 13%, 9% and 14%, 9% and 15%, 9% and 16%, 9% and 17%, 9% and 18%, 9% and 19%, 9% and 20%, 10% and 11%, 10% and 12%, 10% and 13%, 10% and 14%, 10% and 15%, 10% and 16%, 10% and 17%, 10% and 18%, 10% and 19%, 10% and 20%, 11% and 12%, 11% and 13%, 11% and 14%, 11% and 15%, 11% and 16%, 11% and 17%, 11% and 18%, 11% and 19%, 11% and 20%, 12% and 13%, 12% and 14%, 12% and 15%, 12% and 16%, 12% and 17%, 12% and 18%, 12% and 19%, 12% and 20%, 13% and 14%, 13% and 15%, 13% and 16%, 13% and 17%, 13% and 18%, 13% and 19%, 13% and 20%, 14% and 15%, 14% and 16%, 14% and 17%, 14% and 18%, 14% and 19%, 14% and 20%, 15% and 16%, 15% and 17%, 15% and 18%, 15% and 19%, 15% and 20%, 16% and 17%, 16% and 18%, 16% and 19%, 16% and 20%, 17% and 18%, 17% and 19%, 17% and 20%, 18% and 19%, 18% and 20%, or 19% and 20%. One or more of such binder materials may be present in the electrode (e.g., in the positive electrode and/or in the negative electrode) at an individual or combined concentration (e.g., by weight on a dry basis, without solvent) of greater than or equal to about 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, or 20%. In addition, or as an alternative, one or more of such binder materials may be present in the electrode (e.g., in the positive electrode and/or in the negative electrode) at an individual or combined concentration of less than or equal to about 20%, 19.5%, 19%, 18.5%, 18%, 17.5%, 17%, 16.5%, 16%, 15.5%, 15%, 14.5%, 14%, 13.5%, 13%, 12.5%, 12%, 11.5%, 11%, 10.5%, 10%, 9.5%, 9%, 8.5%, 8%, 7.5%, 7%, 6.5%, 6%, 5.5%, 5%, 4.5%, 4%, 3.5%, 3%, 2.5%, 2%, 1.5%, 1%, or 0.5%. One or more of such binder materials may be present in the electrode at such concentrations in combination with one or more other materials (e.g., one or more other electrode materials and concentrations thereof described herein).

An electrode (e.g., a positive or negative electrode of a LIB) may be prepared with the aid of a solvent. A formula may include various levels of the solvent. At least a portion or all of the solvent may evaporate from the electrode. Examples of solvents may include, but are not limited to, 2-pyrrolidone (2-Py), n-vinylpyrrolidone (NVP), n-methyl-2-pyrrolidone (NMP), methyl ethyl ketone, or any combination thereof. One or more of such solvent compounds may be present in the electrode (e.g., in the positive electrode and/or in the negative electrode) at an individual or combined concentration (e.g., by weight on a wet basis) between about 20% and 25%, 20% and 30%, 20% and 35%, 20% and 40%, 20% and 45%, 20% and 50%, 20% and 55%, 20% and 60%, 20% and 65%, 20% and 70%, 20% and 75%, 25% and 30%, 25% and 35%, 25% and 40%, 25% and 45%, 25% and 50%, 25% and 55%, 25% and 60%, 25% and 65%, 25% and 70%, 25% and 75%, 30% and 35%, 30% and 40%, 30% and 45%, 30% and 50%, 30% and 55%, 30% and 60%, 30% and 65%, 30% and 70%, 30% and 75%, 35% and 40%, 35% and 45%, 35% and 50%, 35% and 55%, 35% and 60%, 35% and 65%, 35% and 70%, 35% and 75%, 40% and 45%, 40% and 50%, 40% and 55%, 40% and 60%, 40% and 65%, 40% and 70%, 40% and 75%, 45% and 50%, 45% and 55%, 45% and 60%, 45% and 65%, 45% and 70%, 45% and 75%, 50% and 55%, 50% and 60%, 50% and 65%, 50% and 70%, 50% and 75%, 55% and 60%, 55% and 65%, 55% and 70%, 55% and 75%, 60% and 65%, 60% and 70%, 60% and 75%, 65% and 70%, 65% and 75%, or 70% and 75%. One or more of such solvent compounds may be present in the electrode (e.g., in the positive electrode and/or in the negative electrode) at an individual or combined concentration (e.g., by weight on a wet basis) of greater than or equal to about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, or 75%. In addition, or as an alternative, one or more of such solvent compounds may be present in the electrode (e.g., in the positive electrode and/or in the negative electrode) at an individual or combined concentration (e.g., by weight on a wet basis) of less than or equal to about 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, or 20%. One or more of such solvent compounds may be present in the electrode at such concentrations in combination with one or more other materials (e.g., one or more other electrode materials and concentrations thereof described herein).

An active material of an electrode (e.g., a negative electrode of a LIB) may include, for example, polyacetylene, graphite (e.g., natural graphite or artificial graphite), vapor-phase-grown carbon fiber, soft carbon (graphitizable carbon), hard carbon (non-graphitizable carbon), carbon nanotubes, or any combination thereof. One or more of such active materials may be present in the electrode at an individual or combined concentration (e.g., by weight on a dry basis, without solvent) between about 0.25% and 0.5%, 0.25% and 0.75%, 0.25% and 1%, 0.25% and 2%, 0.25% and 5%, 0.25% and 10%, 0.25% and 20%, 0.25% and 30%, 0.25% and 40%, 0.25% and 50%, 0.5% and 0.75%, 0.5% and 1%, 0.5% and 2%, 0.5% and 5%, 0.5% and 10%, 0.5% and 20%, 0.5% and 30%, 0.5% and 40%, 0.5% and 50%, 0.75% and 1%, 0.75% and 2%, 0.75% and 5%, 0.75% and 10%, 0.75% and 20%, 0.75% and 30%, 0.75% and 40%, 0.75% and 50%, 1% and 2%, 1% and 5%, 1% and 10%, 1% and 20%, 1% and 30%, 1% and 40%, 1% and 50%, 2% and 5%, 2% and 10%, 2% and 20%, 2% and 30%, 2% and 40%, 2% and 50%, 5% and 10%, 5% and 20%, 5% and 30%, 5% and 40%, 5% and 50%, 10% and 20%, 10% and 30%, 10% and 40%, 10% and 50%, 20% and 30%, 20% and 40%, 20% and 50%, 30% and 40%, 30% and 50%, 40% and 50%, 50% and 55%, 50% and 60%, 50% and 65%, 50% and 70%, 50% and 72%, 50% and 74%, 50% and 76%, 50% and 78%, 50% and 80%, 50% and 82%, 50% and 84%, 50% and 86%, 50% and 88%, 50% and 90%, 50% and 91%, 50% and 92%, 50% and 93%, 50% and 94%, 50% and 95%, 50% and 96%, 50% and 97%, 50% and 98%, 50% and 99%, 55% and 60%, 55% and 65%, 55% and 70%, 55% and 72%, 55% and 74%, 55% and 76%, 55% and 78%, 55% and 80%, 55% and 82%, 55% and 84%, 55% and 86%, 55% and 88%, 55% and 90%, 55% and 91%, 55% and 92%, 55% and 93%, 55% and 94%, 55% and 95%, 55% and 96%, 55% and 97%, 55% and 98%, 55% and 99%, 60% and 65%, 60% and 70%, 60% and 72%, 60% and 74%, 60% and 76%, 60% and 78%, 60% and 80%, 60% and 82%, 60% and 84%, 60% and 86%, 60% and 88%, 60% and 90%, 60% and 91%, 60% and 92%, 60% and 93%, 60% and 94%, 60% and 95%, 60% and 96%, 60% and 97%, 60% and 98%, 60% and 99%, 65% and 70%, 65% and 72%, 65% and 74%, 65% and 76%, 65% and 78%, 65% and 80%, 65% and 82%, 65% and 84%, 65% and 86%, 65% and 88%, 65% and 90%, 65% and 91%, 65% and 92%, 65% and 93%, 65% and 94%, 65% and 95%, 65% and 96%, 65% and 97%, 65% and 98%, 65% and 99%, 70% and 72%, 70% and 74%, 70% and 76%, 70% and 78%, 70% and 80%, 70% and 82%, 70% and 84%, 70% and 86%, 70% and 88%, 70% and 90%, 70% and 91%, 70% and 92%, 70% and 93%, 70% and 94%, 70% and 95%, 70% and 96%, 70% and 97%, 70% and 98%, 70% and 99%, 72% and 74%, 72% and 76%, 72% and 78%, 72% and 80%, 72% and 82%, 72% and 84%, 72% and 86%, 72% and 88%, 72% and 90%, 72% and 91%, 72% and 92%, 72% and 93%, 72% and 94%, 72% and 95%, 72% and 96%, 72% and 97%, 72% and 98%, 72% and 99%, 74% and 76%, 74% and 78%, 74% and 80%, 74% and 82%, 74% and 84%, 74% and 86%, 74% and 88%, 74% and 90%, 74% and 91%, 74% and 92%, 74% and 93%, 74% and 94%, 74% and 95%, 74% and 96%, 74% and 97%, 74% and 98%, 74% and 99%, 76% and 78%, 76% and 80%, 76% and 82%, 76% and 84%, 76% and 86%, 76% and 88%, 76% and 90%, 76% and 91%, 76% and 92%, 76% and 93%, 76% and 94%, 76% and 95%, 76% and 96%, 76% and 97%, 76% and 98%, 76% and 99%, 78% and 80%, 78% and 82%, 78% and 84%, 78% and 86%, 78% and 88%, 78% and 90%, 78% and 91%, 78% and 92%, 78% and 93%, 78% and 94%, 78% and 95%, 78% and 96%, 78% and 97%, 78% and 98%, 78% and 99%, 80% and 82%, 80% and 84%, 80% and 86%, 80% and 88%, 80% and 90%, 80% and 91%, 80% and 92%, 80% and 93%, 80% and 94%, 80% and 95%, 80% and 96%, 80% and 97%, 80% and 98%, 80% and 99%, 82% and 84%, 82% and 86%, 82% and 88%, 82% and 90%, 82% and 91%, 82% and 92%, 82% and 93%, 82% and 94%, 82% and 95%, 82% and 96%, 82% and 97%, 82% and 98%, 82% and 99%, 84% and 86%, 84% and 88%, 84% and 90%, 84% and 91%, 84% and 92%, 84% and 93%, 84% and 94%, 84% and 95%, 84% and 96%, 84% and 97%, 84% and 98%, 84% and 99%, 86% and 88%, 86% and 90%, 86% and 91%, 86% and 92%, 86% and 93%, 86% and 94%, 86% and 95%, 86% and 96%, 86% and 97%, 86% and 98%, 86% and 99%, 88% and 90%, 88% and 91%, 88% and 92%, 88% and 93%, 88% and 94%, 88% and 95%, 88% and 96%, 88% and 97%, 88% and 98%, 88% and 99%, 90% and 91%, 90% and 92%, 90% and 93%, 90% and 94%, 90% and 95%, 90% and 96%, 90% and 97%, 90% and 98%, 90% and 99%, 91% and 92%, 91% and 93%, 91% and 94%, 91% and 95%, 91% and 96%, 91% and 97%, 91% and 98%, 91% and 99%, 92% and 93%, 92% and 94%, 92% and 95%, 92% and 96%, 92% and 97%, 92% and 98%, 92% and 99%, 93% and 94%, 93% and 95%, 93% and 96%, 93% and 97%, 93% and 98%, 93% and 99%, 94% and 95%, 94% and 96%, 94% and 97%, 94% and 98%, 94% and 99%, 95% and 96%, 95% and 97%, 95% and 98%, 95% and 99%, 96% and 97%, 96% and 98%, 96% and 99%, 97% and 98%, 97% and 99%, or 98% and 99%. One or more of such active materials may be present in the electrode at an individual or combined concentration (e.g., by weight on a dry basis, without solvent) of greater than or equal to about 50%, 51%, 52%, 53%, 54%, 55%, 56%, 57%, 58%, 59%, 60%, 61%, 62%, 63%, 64%, 65%, 66%, 67%, 68%, 69%, 70%, 70.5%, 71%, 71.5%, 72%, 72.5%, 73%, 73.5%, 74%, 74.5%, 75%, 75.5%, 76%, 76.5%, 77%, 77.5%, 78%, 78.5%, 79%, 79.5%, 80%, 80.5%, 81%, 81.5%, 82%, 82.5%, 83%, 83.5%, 84%, 84.5%, 85%, 85.5%, 86%, 86.5%, 87%, 87.5%, 88%, 88.5%, 89%, 89.5%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, 99%, or 99.5%. In addition, or as an alternative, one or more of such active materials may be present in the electrode at an individual or combined concentration (e.g., by weight on a dry basis, without solvent) of less than or equal to about 99.5%, 99%, 98.5%, 98%, 97.5%, 97%, 96.5%, 96%, 95.5%, 95%, 94.5%, 94%, 93.5%, 93%, 92.5%, 92%, 91.5%, 91%, 90.5%, 90%, 89.5%, 89%, 88.5%, 88%, 87.5%, 87%, 86.5%, 86%, 85.5%, 85%, 84.5%, 84%, 83.5%, 83%, 82.5%, 82%, 81.5%, 81%, 80.5%, 80%, 79.5%, 79%, 78.5%, 78%, 77.5%, 77%, 76.5%, 76%, 75.5%, 75%, 74.5%, 74%, 73.5%, 73%, 72.5%, 72%, 71.5%, 71%, 70.5%, 70%, 69%, 68%, 67%, 66%, 65%, 64%, 63%, 62%, 61%, 60%, 59%, 58%, 57%, 56%, 55%, 54%, 53%, 52%, 51%, or 50%. One or more of such active materials may be present in the electrode at such concentrations in combination with one or more other materials (e.g., one or more other electrode materials and concentrations thereof described herein).

The aforementioned active material may have a particle size distribution such that, for example, 10% of the particles are smaller than about 11 μm, 10 μm, 9 μm, 8 μm, 7 μm, 6 μm, 5 μm, or 4 μm. The active material may have such particle size distribution in combination with, for example, 50% of the particles being smaller than about 16 μm, 15 μm, 14 μm, 13 μm, 12 μm, 11 μm, 10 μm, or 9 μm. The active material may such particle size distribution in combination with, for example, 90% of the particles being smaller than about 31 μm, 30 μm, 29 μm, 28 μm, 27 μm, 26 μm, 25 μm, 24 μm, 23 μm, 22 μm, 21 μm, 20 μm, 19 μm, 18 μm, 17 μm, 16 μm, 15 μm, or 14 μm. In one embodiment, the active material may have a particle size distribution characterized by 10% of the particles smaller than about 6.8 μm, 50% of the particles smaller than about 11.6 μm and 90% of the particles smaller than about 19.3 μm. The active material may have a given tap density (e.g., a tap density of less than or equal to about 1.5 grams per cubic centimeter (g/cm³), 1.4 g/cm³, 1.3 g/cm³, 1.2 g/cm³, 1.1 g/cm³, 1 g/cm³, 0.9 g/cm³, 0.8 g/cm³, 0.7 g/cm³, 0.6 g/cm³, or 0.5 g/cm³). In one embodiment, the active material may have a tap density of less than or equal to about 0.99 g/cm³. The active material may have a given specific surface area (e.g., greater than or equal to about 1 m²/g, 1.5 m²/g, 2 m²/g, 2.5 m²/g, 3 m²/g, 3.5 m²/g, 4 m²/g, 4.5 m²/g, 5 m²/g, 5.5 m²/g, 6 m²/g, 6.5 m²/g, or 7 m²/g). In one embodiment, the active material may have a specific surface area of at least about 3.8 m²/g. The active material may have a given first capacity or first discharge capacity. The active material may have a first capacity or first discharge capacity of at least about 320 mAh/g, 325 mAh/g, 330 mAh/g, 335 mAh/g, 340 mAh/g, 345 mAh/g, 350 mAh/g, 351 mAh/g, 352 mAh/g, 353 mAh/g, 354 mAh/g, 355 mAh/g, 356 mAh/g, 357 mAh/g, 358 mAh/g, 359 mAh/g, 360 mAh/g, 361 mAh/g, 362 mAh/g, 363 mAh/g, 364 mAh/g, 365 mAh/g, 366 mAh/g, 367 mAh/g, 368 mAh/g, 369 mAh/g, 370 mAh/g, 371 mAh/g, 372 mAh/g, 373 mAh/g, 374 mAh/g, 375 mAh/g, 376 mAh/g, 377 mAh/g, 378 mAh/g, 379 mAh/g, 380 mAh/g, 385 mAh/g, 390 mAh/g, 395 mAh/g or 400 mAh/g. In one embodiment, the active material may have a first capacity of at least about 364.9 mAh/g. The active material may have a given efficiency or first discharge efficiency. The active material may have an efficiency or first discharge efficiency of at least about 80%, 81%, 82%, 83%, 84%, 85%, 86%, 87%, 88%, 89%, 90%, 91%, 91.5%, 92%, 92.5%, 93%, 93.5%, 94%, 94.5%, 95%, 95.5%, 96%, 96.5%, 97%, 97.5%, 98%, 98.5%, or 99%. In one embodiment, the active material may have an efficiency of at least about 94.5%. The active material may have a given wettability (e.g., a time to wet surface of at least about 80 seconds (s), 82 s, 84 s, 86 s, 88 s, 90 s, 92 s, 94 s, 96 s, 98 s, 100 s, 105 s, 110 s, or 115 s). In one embodiment, the active material may have a wettability of at least about 92 s. The active material may have a given powder conductivity (e.g., at least about 250 siemens per centimeter (S/cm), 255 S/cm, 260 S/cm, 265 S/cm, 270 S/cm, 275 S/cm, 280 S/cm, 285 S/cm, 290 S/cm, 295 S/cm, 300 S/cm, 305 S/cm, 310 S/cm, 315 S/cm, 320 S/cm, 325 S/cm, 330 S/cm, 335 S/cm, 340 S/cm, 345 S/cm, 350 S/cm, 355 S/cm, 360 S/cm, 365 S/cm or 370 S/cm). In one embodiment, the active material may have a powder conductivity of at least about 340 S/cm. The active material may have a given crystal orientation. The active material may have any combination of one or more of the aforementioned particle size distributions, tap densities, specific surface areas, pellet densities, first capacities, efficiencies, or first discharge efficiencies, wettability, powder conductivities, and other properties (e.g., crystal orientations).

An electrode (e.g., a negative electrode of a LIB) may include conductive additive(s). A conductive additive may comprise, for example, conductive carbon. Examples of conductive additives may include, but are not limited to, carbon black (e.g., acetylene black, furnace black, or other carbon types), vapor-grown carbon fibers, carbon nanotubes, or any combination thereof. One or more of such conductive additives may be present in the electrode at an individual or combined concentration (e.g., by weight on a dry basis, without solvent) between about 0.1% and 0.5%, 0.1% and 1%, 0.1% and 1.5%, 0.1% and 2%, 0.1% and 2.5%, 0.1% and 3%, 0.1% and 3.5%, 0.1% and 4%, 0.1% and 4.5%, 0.1% and 5%, 0.1% and 5.5%, 0.1% and 6%, 0.1% and 6.5%, 0.1% and 7%, 0.1% and 7.5%, 0.1% and 8%, 0.1% and 8.5%, 0.1% and 9%, 0.1% and 9.5%, 0.1% and 10%, 0.5% and 1%, 0.5% and 1.5%, 0.5% and 2%, 0.5% and 2.5%, 0.5% and 3%, 0.5% and 3.5%, 0.5% and 4%, 0.5% and 4.5%, 0.5% and 5%, 0.5% and 5.5%, 0.5% and 6%, 0.5% and 6.5%, 0.5% and 7%, 0.5% and 7.5%, 0.5% and 8%, 0.5% and 8.5%, 0.5% and 9%, 0.5% and 9.5%, 0.5% and 10%, 1% and 1.5%, 1% and 2%, 1% and 2.5%, 1% and 3%, 1% and 3.5%, 1% and 4%, 1% and 4.5%, 1% and 5%, 1% and 5.5%, 1% and 6%, 1% and 6.5%, 1% and 7%, 1% and 7.5%, 1% and 8%, 1% and 8.5%, 1% and 9%, 1% and 9.5%, 1% and 10%, 1.5% and 2%, 1.5% and 2.5%, 1.5% and 3%, 1.5% and 3.5%, 1.5% and 4%, 1.5% and 4.5%, 1.5% and 5%, 1.5% and 5.5%, 1.5% and 6%, 1.5% and 6.5%, 1.5% and 7%, 1.5% and 7.5%, 1.5% and 8%, 1.5% and 8.5%, 1.5% and 9%, 1.5% and 9.5%, 1.5% and 10%, 2% and 2.5%, 2% and 3%, 2% and 3.5%, 2% and 4%, 2% and 4.5%, 2% and 5%, 2% and 5.5%, 2% and 6%, 2% and 6.5%, 2% and 7%, 2% and 7.5%, 2% and 8%, 2% and 8.5%, 2% and 9%, 2% and 9.5%, 2% and 10%, 2.5% and 3%, 2.5% and 3.5%, 2.5% and 4%, 2.5% and 4.5%, 2.5% and 5%, 2.5% and 5.5%, 2.5% and 6%, 2.5% and 6.5%, 2.5% and 7%, 2.5% and 7.5%, 2.5% and 8%, 2.5% and 8.5%, 2.5% and 9%, 2.5% and 9.5%, 2.5% and 10%, 3% and 3.5%, 3% and 4%, 3% and 4.5%, 3% and 5%, 3% and 5.5%, 3% and 6%, 3% and 6.5%, 3% and 7%, 3% and 7.5%, 3% and 8%, 3% and 8.5%, 3% and 9%, 3% and 9.5%, 3% and 10%, 3.5% and 4%, 3.5% and 4.5%, 3.5% and 5%, 3.5% and 5.5%, 3.5% and 6%, 3.5% and 6.5%, 3.5% and 7%, 3.5% and 7.5%, 3.5% and 8%, 3.5% and 8.5%, 3.5% and 9%, 3.5% and 9.5%, 3.5% and 10%, 4% and 4.5%, 4% and 5%, 4% and 5.5%, 4% and 6%, 4% and 6.5%, 4% and 7%, 4% and 7.5%, 4% and 8%, 4% and 8.5%, 4% and 9%, 4% and 9.5%, 4% and 10%, 4.5% and 5%, 4.5% and 5.5%, 4.5% and 6%, 4.5% and 6.5%, 4.5% and 7%, 4.5% and 7.5%, 4.5% and 8%, 4.5% and 8.5%, 4.5% and 9%, 4.5% and 9.5%, 4.5% and 10%, 5% and 5.5%, 5% and 6%, 5% and 6.5%, 5% and 7%, 5% and 7.5%, 5% and 8%, 5% and 8.5%, 5% and 9%, 5% and 9.5%, 5% and 10%, 5.5% and 6%, 5.5% and 6.5%, 5.5% and 7%, 5.5% and 7.5%, 5.5% and 8%, 5.5% and 8.5%, 5.5% and 9%, 5.5% and 9.5%, 5.5% and 10%, 6% and 6.5%, 6% and 7%, 6% and 7.5%, 6% and 8%, 6% and 8.5%, 6% and 9%, 6% and 9.5%, 6% and 10%, 6.5% and 7%, 6.5% and 7.5%, 6.5% and 8%, 6.5% and 8.5%, 6.5% and 9%, 6.5% and 9.5%, 6.5% and 10%, 7% and 7.5%, 7% and 8%, 7% and 8.5%, 7% and 9%, 7% and 9.5%, 7% and 10%, 7.5% and 8%, 7.5% and 8.5%, 7.5% and 9%, 7.5% and 9.5%, 7.5% and 10%, 8% and 8.5%, 8% and 9%, 8% and 9.5%, 8% and 10%, 8.5% and 9%, 8.5% and 9.5%, 8.5% and 10%, 9% and 9.5%, 9% and 10%, or 9.5% and 10%. One or more of such conductive additives may be present in the electrode at an individual or combined concentration (e.g., by weight on a dry basis, without solvent) of greater than or equal to about 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, or 10%. In addition, or as an alternative, one or more of such conductive additives may be present in the electrode at an individual or combined concentration (e.g., by weight on a dry basis, without solvent) of less than or equal to about 10%, 9.5%, 9%, 8.5%, 8%, 7.5%, 7%, 6.5%, 6%, 5.5%, 5%, 4.5%, 4%, 3.5%, 3%, 2.5%, 2%, 1.5%, 1%, 0.5%, or 0.1%. One or more of such conductive additives may be present in the electrode at such concentrations in combination with one or more other materials (e.g., one or more other electrode materials and concentrations thereof described herein).

The aforementioned conductive additive may have a given conductivity. The conductive additive may have an electrical conductivity of at least about 5 S/cm, 6 S/cm, 7 S/cm, 8 S/cm, 9 S/cm, 10 S/cm, 15 S/cm, 20 S/cm, 30 S/cm, 35 S/cm, 40 S/cm, 45 S/cm, 50 S/cm, 55 S/cm, 60 S/cm, or 65 S/cm. The conductive additive may be a powder. In some embodiments, the powder may initially be compressed (e.g., 50% or 100% compressed). The conductive additive may have a given surface area. The conductive additive may have a surface area (e.g., Brunauer, Emmett and Teller (BET) nitrogen surface area, as measured, for example, by ASTM D3037-89 test method) of at least about 10 m²/g, 15 m²/g, 20 m²/g, 25 m²/g, 30 m²/g, 35 m²/g, 40 m²/g, 45 m²/g, 50 m²/g, 55 m²/g, 60 m²/g, 65 m²/g, or 70 m²/g. The conductive additive may have a given density. The conductive additive may have a density (e.g., in the bag, as measured by a suitable test method) of at least about 100 kilograms per cubic meter (kg/m³), 110 kg/m³, 120 kg/m³, 130 kg/m³, 140 kg/m³, 150 kg/m³, 160 kg/m³, 170 kg/m³, 180 kg/m³, 200 kg/m³, 210 kg/m³, 220 kg/m³, 230 kg/m³, 240 kg/m³, or 250 kg/m³.

The carbon-based material of the present disclosure may be used in an electrode as active material, as conductive additive, and/or as binder. In certain embodiments, use of the carbon-based material of the present disclosure in an electrode may allow improved utilization of active material(s) in the electrode. For example, in a conventional LIB, a significant portion of the electrode may not be active, as a large amount of conductive additive (e.g., carbon black) may need to be added to allow the percolation threshold to be reached. In an example, a percolation threshold of carbon black in positive electrodes of lithium-ion batteries (e.g., in LFP) is about 10-15 wt %. A large amount of conductive additive (e.g., about 10-15 wt % carbon black) may therefore need to be added to the electrode to reach the percolation threshold, thereby decreasing the amount of active material that may be provided. The threshold value may depend on the size and aspect ratio of particles in the active material of the positive electrode (e.g., metal oxide may form spherical particles with a diameter of between about 2 microns and 10 microns). When the carbon-based material of the present disclosure is used instead of carbon black (or other conductive additives), the percolation threshold may be significantly lowered (e.g., by a factor of at least about 2, 3, 4, 5, or more). Such decreases in the percolation threshold may be achieved when the carbon-based material is used alone or in combination with one or more other conductive additives (e.g., in combination with some of the conductive additives that it replaces). The carbon-based material of the present disclosure may be used to entirely replace other conductive additives. In such a case, a percolation threshold may or may not exist. Use of the carbon-based material of the present disclosure (alone or in combination with one or more other conductive additives) may allow at least about 5%, 10%, 15%, 20%, or 25% (e.g., by weight) more active material to be incorporated in the electrode when compared with an electrode with substantially the same conductivity (e.g., electrical conductivity) that does not comprise the present carbon-based material. The improved performance of the carbon-based network described herein may result from its composition, morphology, and/or distribution. For example, the carbon-based material may have a higher conductivity per unit weight. The carbon-based material may have a higher conductivity per unit weight serve as binder. In some embodiments, as described elsewhere herein, the carbon-based material described herein may form PCS. The carbon in the carbon-based material of the present disclosure may form a porous network. At least a portion of the carbon-based material of the present disclosure may comprise non-sp2 carbon.

A carbon-based material of the present disclosure (e.g., PCS) may be present in an electrode (e.g., a positive electrode of a LIB) at a concentration (e.g., by weight on a dry basis, without solvent) between about 0.01% and 0.05%, 0.01% and 0.1%, 0.01% and 0.5%, 0.01% and 1%, 0.01% and 2%, 0.01% and 3%, 0.01% and 4%, 0.01% and 5%, 0.01% and 6%, 0.01% and 7%, 0.01% and 8%, 0.01% and 9%, 0.01% and 10%, 0.01% and 11%, 0.01% and 12%, 0.01% and 13%, 0.01% and 14%, 0.01% and 15%, 0.01% and 16%, 0.01% and 17%, 0.01% and 18%, 0.01% and 19%, 0.01% and 20%, 0.01% and 25%, 0.01% and 30%, 0.01% and 35%, 0.01% and 40%, 0.05% and 0.1%, 0.05% and 0.5%, 0.05% and 1%, 0.05% and 2%, 0.05% and 3%, 0.05% and 4%, 0.05% and 5%, 0.05% and 6%, 0.05% and 7%, 0.05% and 8%, 0.05% and 9%, 0.05% and 10%, 0.05% and 11%, 0.05% and 12%, 0.05% and 13%, 0.05% and 14%, 0.05% and 15%, 0.05% and 16%, 0.05% and 17%, 0.05% and 18%, 0.05% and 19%, 0.05% and 20%, 0.05% and 25%, 0.05% and 30%, 0.05% and 35%, 0.05% and 40%, 0.1% and 0.5%, 0.1% and 1%, 0.1% and 2%, 0.1% and 3%, 0.1% and 4%, 0.1% and 5%, 0.1% and 6%, 0.1% and 7%, 0.1% and 8%, 0.1% and 9%, 0.1% and 10%, 0.1% and 11%, 0.1% and 12%, 0.1% and 13%, 0.1% and 14%, 0.1% and 15%, 0.1% and 16%, 0.1% and 17%, 0.1% and 18%, 0.1% and 19%, 0.1% and 20%, 0.1% and 25%, 0.1% and 30%, 0.1% and 35%, 0.1% and 40%, 0.5% and 1%, 0.5% and 2%, 0.5% and 3%, 0.5% and 4%, 0.5% and 5%, 0.5% and 6%, 0.5% and 7%, 0.5% and 8%, 0.5% and 9%, 0.5% and 10%, 0.5% and 11%, 0.5% and 12%, 0.5% and 13%, 0.5% and 14%, 0.5% and 15%, 0.5% and 16%, 0.5% and 17%, 0.5% and 18%, 0.5% and 19%, 0.5% and 20%, 0.5% and 25%, 0.5% and 30%, 0.5% and 35%, 0.5% and 40%, 1% and 2%, 1% and 3%, 1% and 4%, 1% and 5%, 1% and 6%, 1% and 7%, 1% and 8%, 1% and 9%, 1% and 10%, 1% and 11%, 1% and 12%, 1% and 13%, 1% and 14%, 1% and 15%, 1% and 16%, 1% and 17%, 1% and 18%, 1% and 19%, 1% and 20%, 1% and 25%, 1% and 30%, 1% and 35%, 1% and 40%, 2% and 3%, 2% and 4%, 2% and 5%, 2% and 6%, 2% and 7%, 2% and 8%, 2% and 9%, 2% and 10%, 2% and 11%, 2% and 12%, 2% and 13%, 2% and 14%, 2% and 15%, 2% and 16%, 2% and 17%, 2% and 18%, 2% and 19%, 2% and 20%, 2% and 25%, 2% and 30%, 2% and 35%, 2% and 40%, 3% and 4%, 3% and 5%, 3% and 6%, 3% and 7%, 3% and 8%, 3% and 9%, 3% and 10%, 3% and 11%, 3% and 12%, 3% and 13%, 3% and 14%, 3% and 15%, 3% and 16%, 3% and 17%, 3% and 18%, 3% and 19%, 3% and 20%, 3% and 25%, 3% and 30%, 3% and 35%, 3% and 40%, 4% and 5%, 4% and 6%, 4% and 7%, 4% and 8%, 4% and 9%, 4% and 10%, 4% and 11%, 4% and 12%, 4% and 13%, 4% and 14%, 4% and 15%, 4% and 16%, 4% and 17%, 4% and 18%, 4% and 19%, 4% and 20%, 4% and 25%, 4% and 30%, 4% and 35%, 4% and 40%, 5% and 6%, 5% and 7%, 5% and 8%, 5% and 9%, 5% and 10%, 5% and 11%, 5% and 12%, 5% and 13%, 5% and 14%, 5% and 15%, 5% and 16%, 5% and 17%, 5% and 18%, 5% and 19%, 5% and 20%, 5% and 25%, 5% and 30%, 5% and 35%, 5% and 40%, 6% and 7%, 6% and 8%, 6% and 9%, 6% and 10%, 6% and 11%, 6% and 12%, 6% and 13%, 6% and 14%, 6% and 15%, 6% and 16%, 6% and 17%, 6% and 18%, 6% and 19%, 6% and 20%, 6% and 25%, 6% and 30%, 6% and 35%, 6% and 40%, 7% and 8%, 7% and 9%, 7% and 10%, 7% and 11%, 7% and 12%, 7% and 13%, 7% and 14%, 7% and 15%, 7% and 16%, 7% and 17%, 7% and 18%, 7% and 19%, 7% and 20%, 7% and 25%, 7% and 30%, 7% and 35%, 7% and 40%, 8% and 9%, 8% and 10%, 8% and 11%, 8% and 12%, 8% and 13%, 8% and 14%, 8% and 15%, 8% and 16%, 8% and 17%, 8% and 18%, 8% and 19%, 8% and 20%, 8% and 25%, 8% and 30%, 8% and 35%, 8% and 40%, 9% and 10%, 9% and 11%, 9% and 12%, 9% and 13%, 9% and 14%, 9% and 15%, 9% and 16%, 9% and 17%, 9% and 18%, 9% and 19%, 9% and 20%, 9% and 25%, 9% and 30%, 9% and 35%, 9% and 40%, 10% and 11%, 10% and 12%, 10% and 13%, 10% and 14%, 10% and 15%, 10% and 16%, 10% and 17%, 10% and 18%, 10% and 19%, 10% and 20%, 10% and 25%, 10% and 30%, 10% and 35%, 10% and 40%, 11% and 12%, 11% and 13%, 11% and 14%, 11% and 15%, 11% and 16%, 11% and 17%, 11% and 18%, 11% and 19%, 11% and 20%, 11% and 25%, 11% and 30%, 11% and 35%, 11% and 40%, 12% and 13%, 12% and 14%, 12% and 15%, 12% and 16%, 12% and 17%, 12% and 18%, 12% and 19%, 12% and 20%, 12% and 25%, 12% and 30%, 12% and 35%, 12% and 40%, 13% and 14%, 13% and 15%, 13% and 16%, 13% and 17%, 13% and 18%, 13% and 19%, 13% and 20%, 13% and 25%, 13% and 30%, 13% and 35%, 13% and 40%, 14% and 15%, 14% and 16%, 14% and 17%, 14% and 18%, 14% and 19%, 14% and 20%, 14% and 25%, 14% and 30%, 14% and 35%, 14% and 40%, 15% and 16%, 15% and 17%, 15% and 18%, 15% and 19%, 15% and 20%, 15% and 25%, 15% and 30%, 15% and 35%, 15% and 40%, 16% and 17%, 16% and 18%, 16% and 19%, 16% and 20%, 16% and 25%, 16% and 30%, 16% and 35%, 16% and 40%, 17% and 18%, 17% and 19%, 17% and 20%, 17% and 25%, 17% and 30%, 17% and 35%, 17% and 40%, 18% and 19%, 18% and 20%, 18% and 25%, 18% and 30%, 18% and 35%, 18% and 40%, 19% and 20%, 19% and 25%, 19% and 30%, 19% and 35%, 19% and 40%, 20% and 25%, 20% and 30%, 20% and 35%, 20% and 40%, 25% and 30%, 25% and 35%, 25% and 40%, 30% and 35%, 30% and 40%, or 35% and 40%. The carbon-based material may be present in the electrode at a concentration (e.g., by weight on a dry basis, without solvent) of greater than or equal to about 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 21%, 22%, 23%, 24%, 25%, 26%, 27%, 28%, 29%, 30%, 31%, 32%, 33%, 34%, 35%, 36%, 37%, 38%, 39%, or 40%. In addition, or as an alternative, the carbon-based material may be present in the electrode at a concentration (e.g., by weight on a dry basis, without solvent) of less than or equal to about 40%, 39%, 38%, 37%, 36%, 35%, 34%, 33%, 32%, 31%, 30%, 29%, 28%, 27%, 26%, 25%, 24%, 23%, 22%, 21%, 20%, 19.5%, 19%, 18.5%, 18%, 17.5%, 17%, 16.5%, 16%, 15.5%, 15%, 14.5%, 14%, 13.5%, 13%, 12.5%, 12%, 11.5%, 11%, 10.5%, 10%, 9.5%, 9%, 8.5%, 8%, 7.5%, 7%, 6.5%, 6%, 5.5%, 5%, 4.5%, 4%, 3.5%, 3%, 2.5%, 2%, 1.5%, 1%, 0.5%, 0.1%, 0.05%, or 0.01%. The carbon-based material may be present in the electrode at such concentrations in combination with one or more other materials (e.g., one or more other electrode materials and concentrations thereof described herein).

In certain embodiments, the carbon-based material of the present disclosure (e.g., PCS) may be present in an electrode (e.g., an electrode of a supercapacitor) at a concentration (e.g., by weight) of greater than or equal to about 0.01%, 0.05%, 0.1%, 0.5%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, 20%, 25%, 30%, 35%, 40%, 45%, 50%, 60%, 65%, 70%, 75%, 80%, 85%, 90%, or 95%.

### Methods of Forming Energy Storage Devices

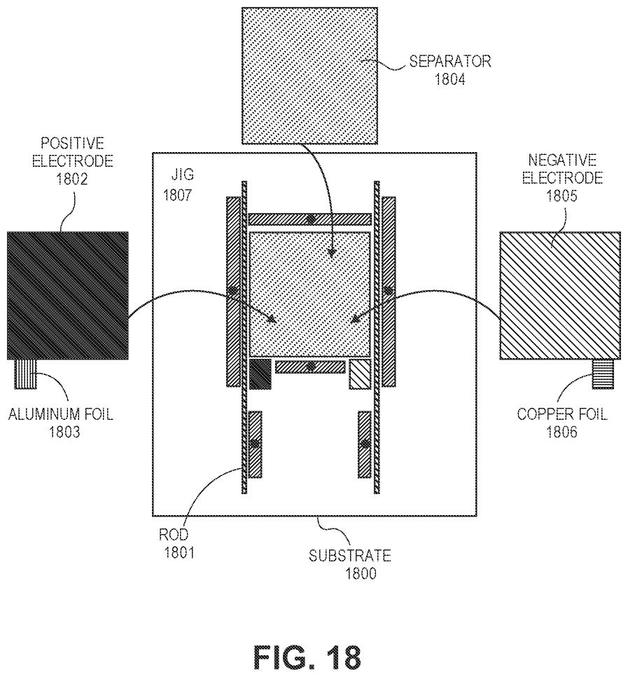

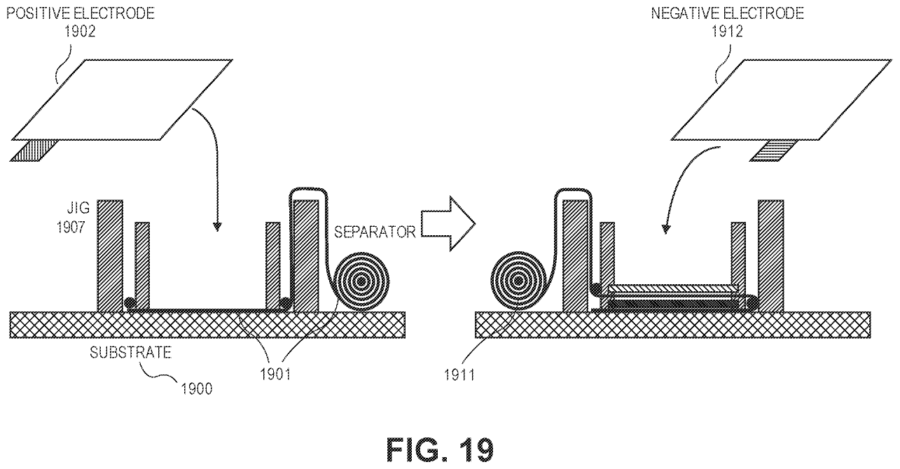

An energy storage device of the present disclosure may comprise electrodes, separator(s), electrolyte, and packaging. Such components may be fabricated and assembled in different ways. In certain embodiments, individual components may be fabricated and later assembled. In some embodiments, the components may be assembled through winding or rolling (e.g., see FIG. 9 and FIG. 20). For example, a method of making a battery cell may comprise providing a first sheet of a separator, placing a positive electrode sheet (e.g., comprising a carbon-based material of the present disclosure) on the first sheet of separator, placing a second sheet of the separator on the positive electrode sheet, placing a negative electrode sheet (e.g., comprising graphite) on the second sheet of the separator, and rolling the sheets to form the battery cell (a rolled cell). In some embodiments, the components may be assembled through stacking (e.g., see FIG. 18 and FIG. 19).

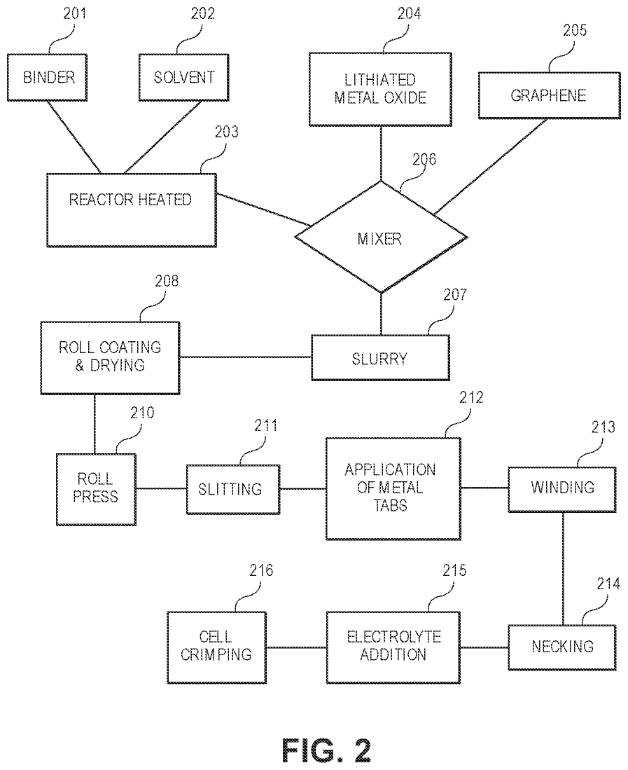

FIG. 2 schematically illustrates an example of a process of getting a formula and processing of a battery comprising a carbon-based material of the present disclosure. The formula may include at least a portion of an electrode mixture (e.g., a cathode mixture). In certain embodiments, a formula may include all components of an electrode mixture (e.g., the whole cathode mixture). In certain embodiments, the formula may be or may form a slurry. The process may include providing a binder 201 and a solvent 202. The binder 201 and the solvent 202 may be combined in a reactor 203. The reactor 203 may be heated to a given temperature (e.g., at least about 90° C.). The process may include providing a lithiated metal compound (e.g., lithiated metal oxide or phosphate) 204 and the carbon-based material (e.g., PCS) 205. A mixer 206 may receive at least a portion of the material from the reactor 203 (e.g., heated binder and heated solvent), the lithiated metal compound (e.g., lithiated metal oxide or phosphate) 204 and the carbon-based material (e.g., PCS) 205. The mixer 206 may output a slurry 207 (e.g., comprising a mixture of the components in the mixer). The slurry 207 may be processed through roll coating and drying 208, followed by a roll press 210. Then, the process may comprise slitting 211 and application of metal tabs 212. The process may further comprise winding 213, followed by necking 214. The process may further include electrolyte addition 215. Finally, the process may include cell crimping 216.

Alternatively, in some embodiments, at least a portion of the binder 201, solvent 202, lithiated metal compound 204, carbon-based material 205, and/or any other electrode components may be otherwise combined. For example, these components or a subset thereof may all be provided directly to the mixer 206 (e.g., which may be heated).

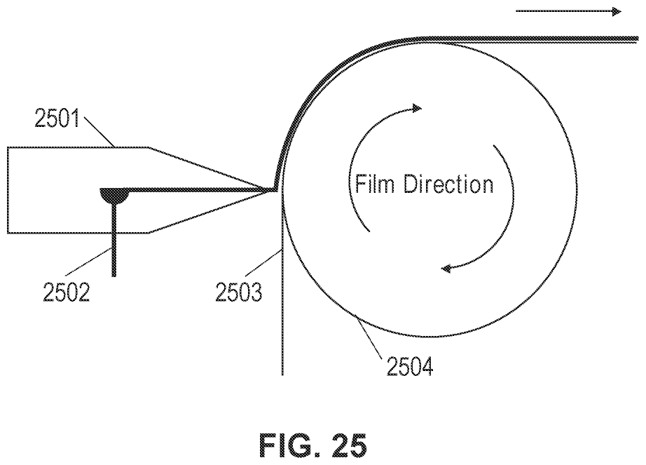

FIG. 25 illustratively depicts an exemplary apparatus for roll coating, wherein a slot die 2501 deposits a slurry 2502 on a film 2503, as the film 2503 passes over a roller 2504.

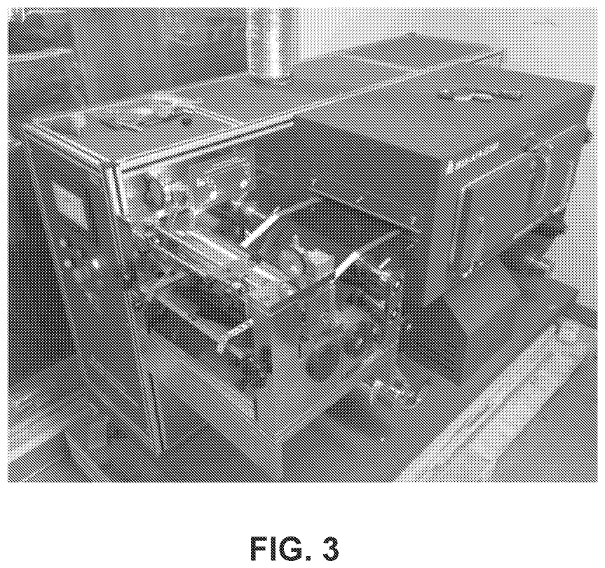

FIGS. 3-7 show examples of processing of battery electrode(s). Such processing may include one or more process(ing) steps (e.g., step 208 in FIG. 2). The process(ing) may include coating of a substrate with a slurry (e.g., a slurry comprising the carbon-based material, for example, PCS) using large scale roll-to-roll processing as shown in FIG. 3. The substrate (e.g., if conductive) may serve as an electrode current collector. In some embodiments, the process(ing) may include using an aluminum foil as a substrate. The aluminum foil may form a current collector.

In some embodiments, the active material is present in the slurry at a concentration of about 20% to about 75%. In some embodiments, the active material is present in the slurry at a concentration of at least about 20%. In some embodiments, the active material is present in the slurry at a concentration of at most about 75%. In some embodiments, the active material is present in the slurry at a concentration of about 20% to about 25%, about 20% to about 30%, about 20% to about 35%, about 20% to about 40%, about 20% to about 45%, about 20% to about 50%, about 20% to about 55%, about 20% to about 60%, about 20% to about 65%, about 20% to about 70%, about 20% to about 75%, about 25% to about 30%, about 25% to about 35%, about 25% to about 40%, about 25% to about 45%, about 25% to about 50%, about 25% to about 55%, about 25% to about 60%, about 25% to about 65%, about 25% to about 70%, about 25% to about 75%, about 30% to about 35%, about 30% to about 40%, about 30% to about 45%, about 30% to about 50%, about 30% to about 55%, about 30% to about 60%, about 30% to about 65%, about 30% to about 70%, about 30% to about 75%, about 35% to about 40%, about 35% to about 45%, about 35% to about 50%, about 35% to about 55%, about 35% to about 60%, about 35% to about 65%, about 35% to about 70%, about 35% to about 75%, about 40% to about 45%, about 40% to about 50%, about 40% to about 55%, about 40% to about 60%, about 40% to about 65%, about 40% to about 70%, about 40% to about 75%, about 45% to about 50%, about 45% to about 55%, about 45% to about 60%, about 45% to about 65%, about 45% to about 70%, about 45% to about 75%, about 50% to about 55%, about 50% to about 60%, about 50% to about 65%, about 50% to about 70%, about 50% to about 75%, about 55% to about 60%, about 55% to about 65%, about 55% to about 70%, about 55% to about 75%, about 60% to about 65%, about 60% to about 70%, about 60% to about 75%, about 65% to about 70%, about 65% to about 75%, or about 70% to about 75%. In some embodiments, the active material is present in the slurry at a concentration of about 20%, about 25%, about 30%, about 35%, about 40%, about 45%, about 50%, about 55%, about 60%, about 65%, about 70%, or about 75%.

In some embodiments, the binder is present in the slurry at a concentration of about 0.2% to about 10%. In some embodiments, the binder is present in the slurry at a concentration of at least about 0.2%. In some embodiments, the binder is present in the slurry at a concentration of at most about 10%. In some embodiments, the binder is present in the slurry at a concentration of about 0.2% to about 0.5%, about 0.2% to about 0.75%, about 0.2% to about 1%, about 0.2% to about 2%, about 0.2% to about 3%, about 0.2% to about 4%, about 0.2% to about 5%, about 0.2% to about 6%, about 0.2% to about 7%, about 0.2% to about 8%, about 0.2% to about 10%, about 0.5% to about 0.75%, about 0.5% to about 1%, about 0.5% to about 2%, about 0.5% to about 3%, about 0.5% to about 4%, about 0.5% to about 5%, about 0.5% to about 6%, about 0.5% to about 7%, about 0.5% to about 8%, about 0.5% to about 10%, about 0.75% to about 1%, about 0.75% to about 2%, about 0.75% to about 3%, about 0.75% to about 4%, about 0.75% to about 5%, about 0.75% to about 6%, about 0.75% to about 7%, about 0.75% to about 8%, about 0.75% to about 10%, about 1% to about 2%, about 1% to about 3%, about 1% to about 4%, about 1% to about 5%, about 1% to about 6%, about 1% to about 7%, about 1% to about 8%, about 1% to about 10%, about 2% to about 3%, about 2% to about 4%, about 2% to about 5%, about 2% to about 6%, about 2% to about 7%, about 2% to about 8%, about 2% to about 10%, about 3% to about 4%, about 3% to about 5%, about 3% to about 6%, about 3% to about 7%, about 3% to about 8%, about 3% to about 10%, about 4% to about 5%, about 4% to about 6%, about 4% to about 7%, about 4% to about 8%, about 4% to about 10%, about 5% to about 6%, about 5% to about 7%, about 5% to about 8%, about 5% to about 10%, about 6% to about 7%, about 6% to about 8%, about 6% to about 10%, about 7% to about 8%, about 7% to about 10%, or about 8% to about 10%. In some embodiments, the binder is present in the slurry at a concentration of about 0.2%, about 0.5%, about 0.75%, about 1%, about 2%, about 3%, about 4%, about 5%, about 6%, about 7%, about 8%, or about 10%.

In some embodiments, the solvent is present in the slurry at a concentration of about 5% to about 80%. In some embodiments, the solvent is present in the slurry at a concentration of at least about 5%. In some embodiments, the solvent is present in the slurry at a concentration of at most about 80%. In some embodiments, the solvent is present in the slurry at a concentration of about 5% to about 10%, about 5% to about 15%, about 5% to about 20%, about 5% to about 25%, about 5% to about 30%, about 5% to about 35%, about 5% to about 40%, about 5% to about 50%, about 5% to about 60%, about 5% to about 70%, about 5% to about 80%, about 10% to about 15%, about 10% to about 20%, about 10% to about 25%, about 10% to about 30%, about 10% to about 35%, about 10% to about 40%, about 10% to about 50%, about 10% to about 60%, about 10% to about 70%, about 10% to about 80%, about 15% to about 20%, about 15% to about 25%, about 15% to about 30%, about 15% to about 35%, about 15% to about 40%, about 15% to about 50%, about 15% to about 60%, about 15% to about 70%, about 15% to about 80%, about 20% to about 25%, about 20% to about 30%, about 20% to about 35%, about 20% to about 40%, about 20% to about 50%, about 20% to about 60%, about 20% to about 70%, about 20% to about 80%, about 25% to about 30%, about 25% to about 35%, about 25% to about 40%, about 25% to about 50%, about 25% to about 60%, about 25% to about 70%, about 25% to about 80%, about 30% to about 35%, about 30% to about 40%, about 30% to about 50%, about 30% to about 60%, about 30% to about 70%, about 30% to about 80%, about 35% to about 40%, about 35% to about 50%, about 35% to about 60%, about 35% to about 70%, about 35% to about 80%, about 40% to about 50%, about 40% to about 60%, about 40% to about 70%, about 40% to about 80%, about 50% to about 60%, about 50% to about 70%, about 50% to about 80%, about 60% to about 70%, about 60% to about 80%, or about 70% to about 80%. In some embodiments, the solvent is present in the slurry at a concentration of about 5%, about 10%, about 15%, about 20%, about 25%, about 30%, about 35%, about 40%, about 50%, about 60%, about 70%, or about 80%.

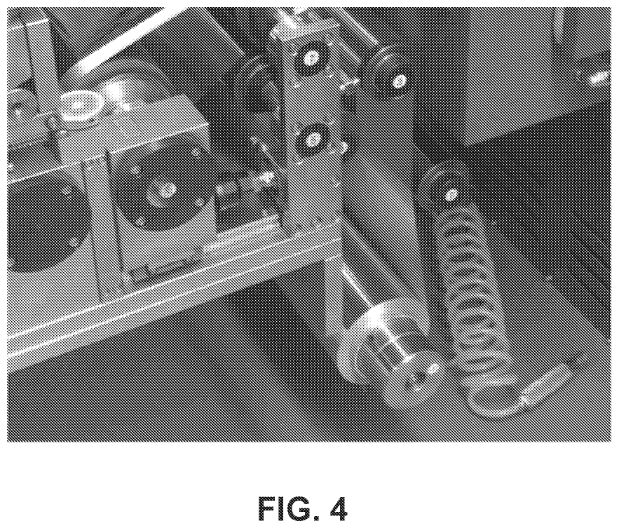

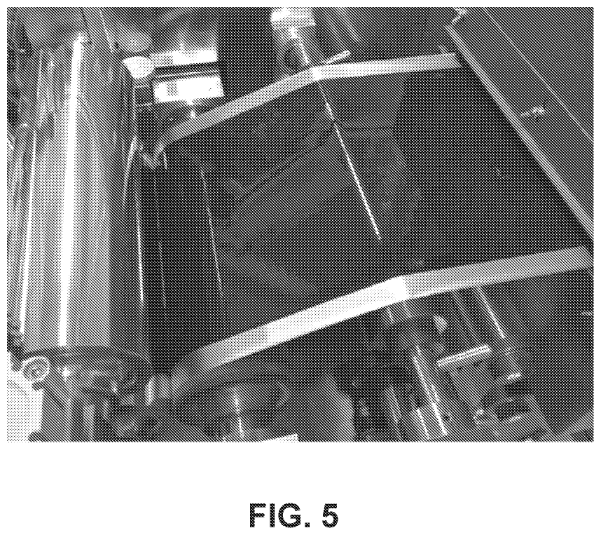

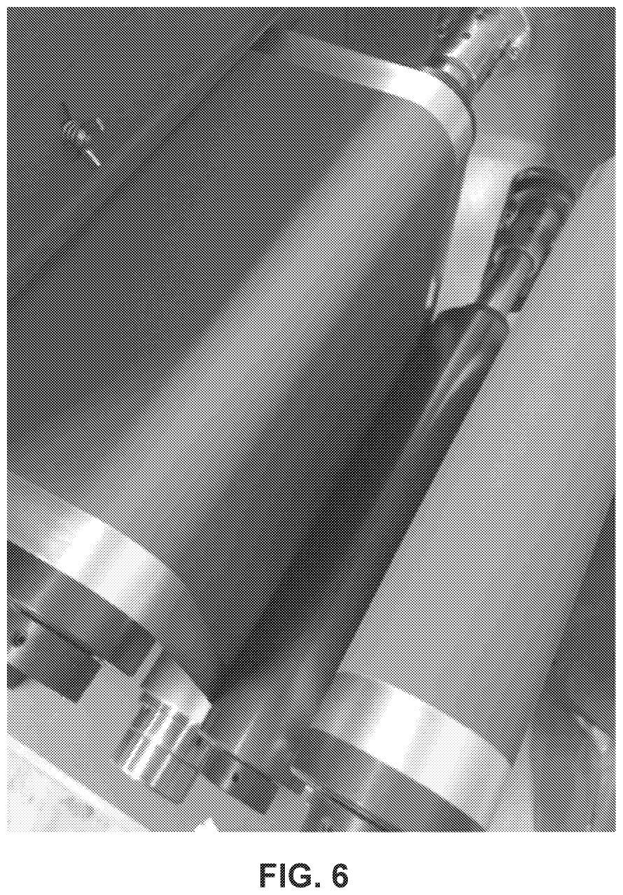

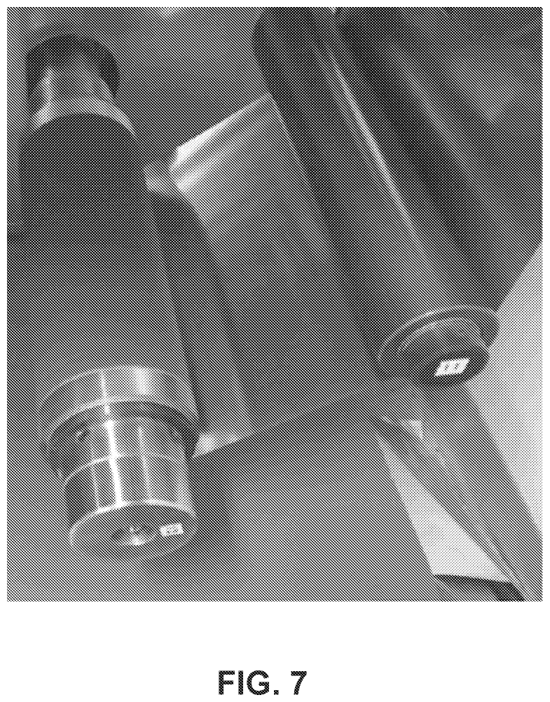

The process(ing) may start with un-winding an aluminum foil for coating a slurry (e.g., of a formula) as shown in FIG. 4. FIG. 5 shows an example of a close-up view of a slurry as it is being coated onto an aluminum foil (slurry is black in color). The coated slurry may form a film. The process(ing) may include drying of the coated film. FIG. 6 shows an example of a coated film (e.g., a film comprising a carbon-based material, for example, PCS) of an electrode after drying at 120° C. using an in-line heating oven. The process(ing) may include rewinding the aluminum foil after it has been coated. FIG. 7 shows an example of rewinding an aluminum foil after it has been coated with the carbon-based material (e.g., PCS).

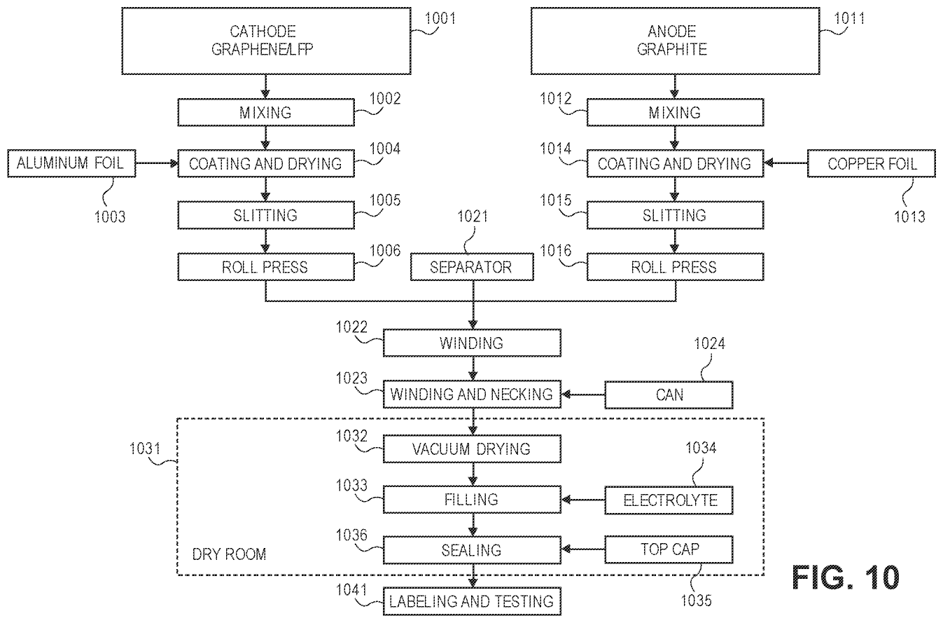

A manufacturing process of a battery (e.g., an LFP-based cell) may be as illustrated in FIG. 10. A positive electrode (cathode during discharge) may be prepared from cathode material 1001 comprising PCS/LFP. Mixing 1002 of the cathode material 1001 may be followed by coating and drying 1004 on an aluminum foil 1003. The coated foil may be processed by slitting 1005 and in a roll press 1006. A negative electrode (anode during discharge) may be prepared from anode material 1011 comprising graphite. Mixing 1012 of the anode material 1011 may be followed by coating and drying 1014 on a copper foil 1013. The coated foil may be processed by slitting 1015 and in a roll press 1016.

A separator 1021 may then be integrated with (e.g., disposed between) the positive and negative electrodes. Next, the process may include winding 1022 of the positive electrode, negative electrode, and separator. The wound roll may be placed in a can 1024, followed by winding and necking 1023. Next, vacuum drying 1032 may be performed, followed by filling 1033 with an electrolyte 1034. A top can 1035 may be used for sealing 1036. The steps 1032, 1033, and 1036 may be performed in a dry room 1031. In some embodiments, the electrolyte 1034 and the top cap 1035 may be prepared or stored in the dry room environment. Finally, the battery may be sent to labeling and testing 1041.

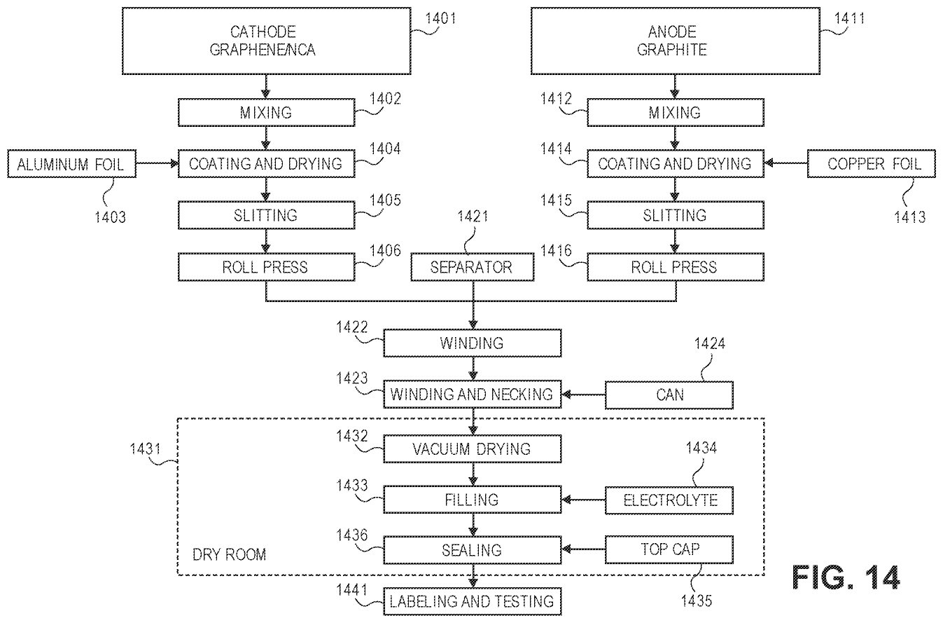

A manufacturing process of a battery (e.g., an NCA-based cell) may be as illustrated in FIG. 14. A positive electrode (cathode during discharge) may be prepared from cathode material 1401 comprising PCS/NCA. Mixing 1402 of the positive electrode material may be followed by coating and drying 1404 on an aluminum foil 1403. The coated foil may be processed by slitting 1405 and in a roll press 1406. A negative electrode (anode during discharge) may be prepared from anode material 1411 comprising graphite. Mixing 1412 of the anode material 1411 may be followed by coating and drying 1414 on a copper foil 1413. The coated foil may be processed by slitting 1415 and in a roll press 1416.

A separator 1421 may then be integrated with (e.g., disposed between) the positive and negative electrodes. Next, the process may include winding 1422 of the positive electrode, negative electrode, and separator. The wound roll may be placed in a can 1424, followed by winding and necking 1423. Next, vacuum drying 1432 may be performed, followed by filling 1433 with an electrolyte 1434. A top can 1435 may be used for sealing 1436. The steps 1432, 1433, and 1436 may be performed in a dry room 1431. In some embodiments, the electrolyte 1434 and the top cap 1435 may be prepared or stored in the dry room environment. Finally, the battery may be sent to labeling and testing 1441.

In some embodiments, an assembly process of a battery (e.g., an NMC-based cell) may be as illustrated in FIGS. 18-20. The process may include stacking (FIGS. 18-19), and/or winding or rolling (FIG. 20). For example, the battery may be assembled through stacking or winding.

FIG. 18 is a bird's eye view of stacking of a cell (e.g., an NMC-based cell). Assembly may be performed on a jig 1807. The assembly may be performed on a substrate 1800 (e.g., a wooden substrate). A metal rod 1801 may confine the assembly of a positive electrode 1802 with an aluminum foil current collector 1803, a separator 1804, and negative electrode 1805 with a copper foil current collector 1806. The positive electrode 1802 and aluminum foil current collector 1803 may be formed (at least in part) as described elsewhere herein (e.g., in relation to FIGS. 2-7, FIG. 10 and FIG. 14). The negative electrode 1805 and copper foil current collector 1806 may be formed (at least in part) as described elsewhere herein (e.g., in relation to FIGS. 2-7, FIG. 10 and FIG. 14).

FIG. 19 is a cross-sectional view of the stacking of a cell (e.g., an NMC-based cell). Assembly may be performed on a jig 1907. Assembly may be performed on a substrate 1900 (e.g., a wooden substrate). A separator 1901 may be laid first, thereby creating a first layer of the separator. The separator may be unwound as shown in FIG. 19 and held in place by the jig. A positive electrode (e.g., positive electrode comprising or coupled to an aluminum foil serving as a positive current collector) 1902 may be placed on top of the first layer of the separator 1901 (left). Next, the separator may be folded over the positive electrode 1902 to create a second layer of the separator, and a negative electrode (e.g., negative electrode comprising or coupled to a copper foil serving as a negative current collector) 1912 may be placed on top of the second layer of the separator 1911 (right). The negative and positive electrodes (e.g., including current collectors) may be formed (at least in part) as described elsewhere herein (e.g., in relation to FIGS. 2-7, FIG. 10, and FIG. 14).

FIG. 20 is an example of the winding of a cell (e.g., an NMC-based cell). Layered sheets including a first sheet of a separator 2001, a positive electrode 2002, a second sheet of the separator 2003, and a negative electrode 2004 may be rotated along an axis 2000 to form the cell. The negative and positive electrodes (e.g., including current collectors) may be formed (at least in part) as described elsewhere herein (e.g., in relation to FIGS. 2-7, FIG. 10 and FIG. 14).

One or more steps of the fabrication process in FIG. 2 and/or one or more of the processing steps in FIGS. 3-7 may be used to produce finished products (batteries) such as shown in FIG. 11, FIG. 15, and FIG. 21.

### Performance of Energy Storage Devices

Energy storage devices available in the market may provide around 1000 mAh of charge storage capacity, power density of 500-1500 watts per kilogram (W/kg), and cycling stability of 500 cycles. However, further improvements of these figures are necessary for the wide adoption of this technology, especially for large scale applications such as electric vehicles and grid scale energy storage (e.g., to reduce the price of electric vehicles and contribute to a clean and green environment).

In contrast, the energy storage devices (e.g., batteries) provided herein may in some embodiments provide a capacity (e.g., charge storage capacity) of more than 2200 or 3400 mAh and a power density of around 3000 W/kg and be used for more than 1000 cycles. Such features may be enabled, for example, by outstanding electrical and mechanical properties of the carbon-based materials described herein, extraordinarily high surface area of the carbon-based materials described herein, or a combination thereof. The carbon-based materials described herein may make the energy storage devices (e.g., batteries) lighter, more powerful, more efficient, or any combination thereof.

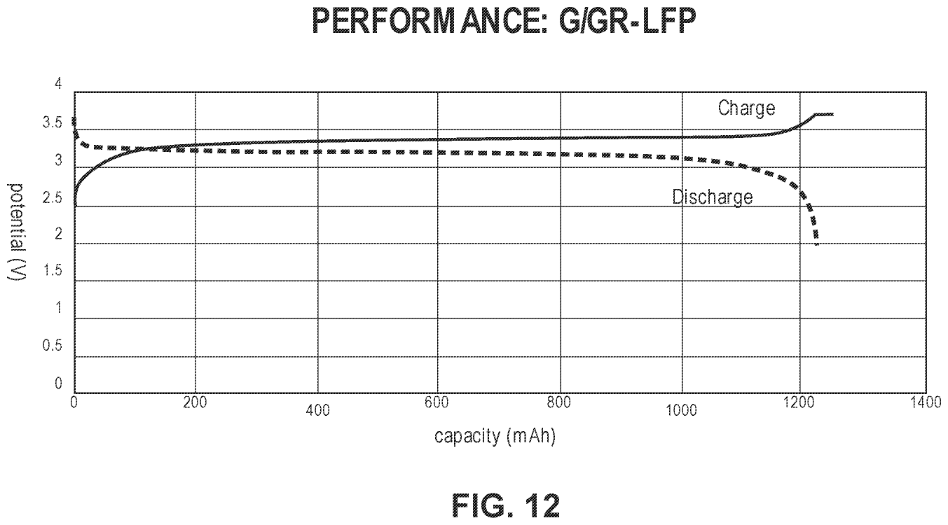

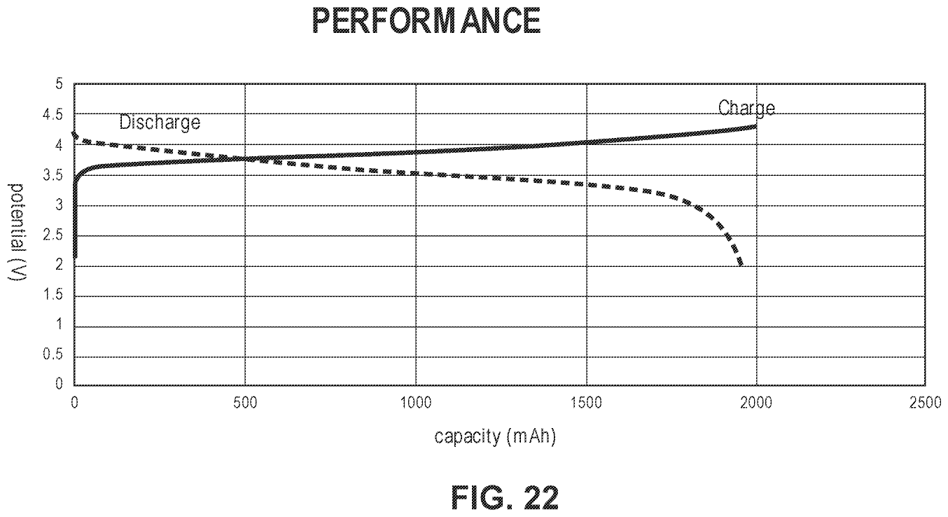

FIG. 12 shows example performance of an LFP-based battery. FIG. 22 shows example performance of an NMC-based battery.

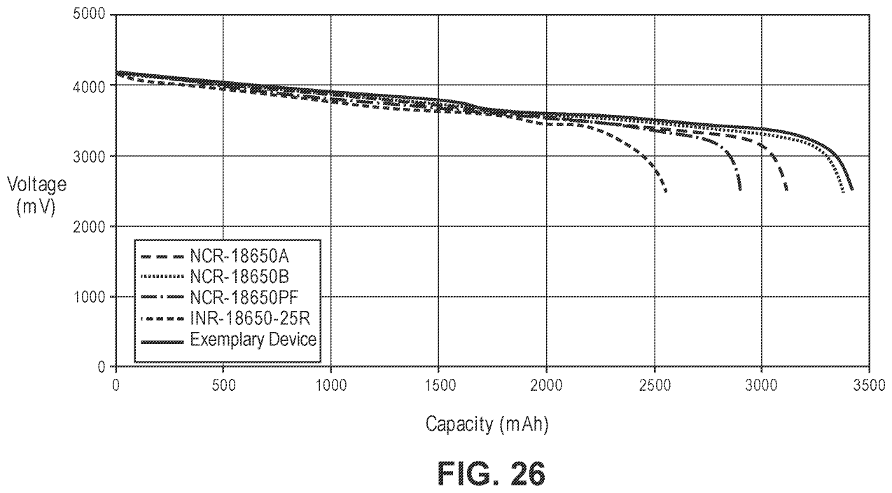

Per FIG. 26, an energy storage device (e.g., battery or battery cell) of the present disclosure may have a charge storage capacity of at least about 1.5, 2, 2.1, 2.2, 2.3, 2.4, 2.5, 2.6, 2.7, 2.8, 2.9, or 3 times greater than an LIB available in the market (e.g., an LIB with a charge storage capacity of 1000 or 3400 mAh). Exemplary LIBs currently available in the market, per FIG. 26, comprise the NCR-18650A, the NCR-18650B, and the NCR-18650PF LIBs made by Panasonic, as well as the INR-18650-25R LIB made by Samsung. An energy storage device (e.g., battery or battery cell) of the present disclosure may have a power density at least about 1.5, 2, 2.5, 3, 3.5, 4, 4.5, 5, 5.5, 6, 6.5, 7, 7.5, or 8 times greater than an LIB available in the market (e.g., an LIB with a power density of 500-1500 W/kg). An energy storage device (e.g., battery or battery cell) of the present disclosure may have cycling stability or cycle life at least about 1.5, 2, or 2.5 times greater than an LIB available in the market (e.g., an LIB with a cycling stability or cycle life of 500 or 1000 cycles). For example, an energy storage device (e.g., battery or battery cell) of the present disclosure may run electronic device(s) for twice as long and may be used for more than 1000 cycles compared with only 500 cycles for competitive technologies. In some embodiments, a battery of the present disclosure not only may have a much higher capacity than commercial cells but also may provide high power and last longer. An energy storage device (e.g., battery or battery cell) of the present disclosure may have an energy density at least about 1.5, 2, or 2.5 times greater than an LIB available in the market (e.g., an LIB with an energy density of 90-150 watt-hour per kilogram (Wh/kg)). An energy storage device (e.g., battery or battery cell) of the present disclosure may be at least about 2 times more powerful (e.g., at least 2 times greater charge storage capacity, at least 2 times greater power density, and/or at least 2 times greater cycling stability/cycle life) than commercial (e.g., LIB) cells.

An energy storage device (e.g., battery or battery cell) of the present disclosure may have a charge storage capacity of greater than or equal to about 750 mAh, 800 mAh, 850 mAh, 950 mAh, 1000 mAh, 1100 mAh, 1200 mAh, 1300 mAh, 1400 mAh, 1500 mAh, 1600 mAh, 1700 mAh, 1800 mAh, 1900 mAh, 2000 mAh, 2100 mAh, 2200 mAh, 2300 mAh, 2400 mAh, 2500 mAh, 2600 mAh, 2700 mAh, 2800 mAh, 2900 mAh, 3000 mAh, 3100 mAh, 3200 mAh, 3300 mAh, 3400 mAh, 3500 mAh, 3600 mAh, 3700 mAh, 3800 mAh, 3900 mAh, 4000 mAh, 4200 mAh, 4600 mAh, 4800 mAh, 5000 mAh. An energy storage device (e.g., battery or battery cell) of the present disclosure may have a charge storage capacity between about 1000 mAh and 2500 mAh, 1000 mAh and 3000 mAh, 1000 mAh and 3500 mAh, 1000 mAh and 4000 mAh, 1100 mAh and 2500 mAh, 1100 mAh and 3000 mAh, 1100 mAh and 3500 mAh, 1100 mAh and 4000 mAh, 1200 mAh and 2500 mAh, 1200 mAh and 3000 mAh, 1200 mAh and 3500 mAh, 1200 mAh and 4000 mAh, 1300 mAh and 2500 mAh, 1300 mAh and 3000 mAh, 1300 mAh and 3500 mAh, 1300 mAh and 4000 mAh, 1400 mAh and 2500 mAh, 1400 mAh and 3000 mAh, 1400 mAh and 3500 mAh, 1400 mAh and 4000 mAh, 1500 mAh and 2500 mAh, 1500 mAh and 3000 mAh, 1500 mAh and 3500 mAh, 1500 mAh and 4000 mAh, 1600 mAh and 2500 mAh, 1600 mAh and 3000 mAh, 1600 mAh and 3500 mAh, 1600 mAh and 4000 mAh, 1700 mAh and 2500 mAh, 1700 mAh and 3000 mAh, 1700 mAh and 3500 mAh, 1700 mAh and 4000 mAh, 1800 mAh and 2500 mAh, 1800 mAh and 3000 mAh, 1800 mAh and 3500 mAh, 1800 mAh and 4000 mAh, 1900 mAh and 2500 mAh, 1900 mAh and 3000 mAh, 1900 mAh and 3500 mAh, 1900 mAh and 4000 mAh, 2000 mAh and 2500 mAh, 2000 mAh and 3000 mAh, 2000 mAh and 3500 mAh, 2000 mAh and 4000 mAh, 2500 mAh and 3000 mAh, 2500 mAh and 3500 mAh, 2500 mAh and 4000 mAh, 3000 mAh and 3500 mAh, 3000 mAh and 4000 mAh, or 3500 mAh and 4000 mAh. An energy storage device (e.g., battery or battery cell) of the present disclosure may have such charge storage capacities in combination with one or more power densities, energy densities, and/or cycling stabilities/cycle lives described herein. In some embodiments, an energy storage device (e.g., battery or battery cell) of the present disclosure has a storage capacity of about 800 mAh to about 4,000 mAh. In some embodiments, an energy storage device (e.g., battery or battery cell) of the present disclosure has a storage capacity of at least about 1,000 mAh.

An energy storage device (e.g., battery or battery cell) of the present disclosure may have a charge storage capacity of about 80 mAh/g to about 800 mAh/g. An energy storage device (e.g., battery or battery cell) of the present disclosure may have a charge storage capacity of at least about 80 mAh/g. An energy storage device (e.g., battery or battery cell) of the present disclosure may have a charge storage capacity of at most about 800 mAh/g. An energy storage device (e.g., battery or battery cell) of the present disclosure may have a charge storage capacity of about 80 mAh/g to about 100 mAh/g, about 80 mAh/g to about 150 mAh/g, about 80 mAh/g to about 200 mAh/g, about 80 mAh/g to about 300 mAh/g, about 80 mAh/g to about 400 mAh/g, about 80 mAh/g to about 500 mAh/g, about 80 mAh/g to about 600 mAh/g, about 80 mAh/g to about 700 mAh/g, about 80 mAh/g to about 800 mAh/g, about 100 mAh/g to about 150 mAh/g, about 100 mAh/g to about 200 mAh/g, about 100 mAh/g to about 300 mAh/g, about 100 mAh/g to about 400 mAh/g, about 100 mAh/g to about 500 mAh/g, about 100 mAh/g to about 600 mAh/g, about 100 mAh/g to about 700 mAh/g, about 100 mAh/g to about 800 mAh/g, about 150 mAh/g to about 200 mAh/g, about 150 mAh/g to about 300 mAh/g, about 150 mAh/g to about 400 mAh/g, about 150 mAh/g to about 500 mAh/g, about 150 mAh/g to about 600 mAh/g, about 150 mAh/g to about 700 mAh/g, about 150 mAh/g to about 800 mAh/g, about 200 mAh/g to about 300 mAh/g, about 200 mAh/g to about 400 mAh/g, about 200 mAh/g to about 500 mAh/g, about 200 mAh/g to about 600 mAh/g, about 200 mAh/g to about 700 mAh/g, about 200 mAh/g to about 800 mAh/g, about 300 mAh/g to about 400 mAh/g, about 300 mAh/g to about 500 mAh/g, about 300 mAh/g to about 600 mAh/g, about 300 mAh/g to about 700 mAh/g, about 300 mAh/g to about 800 mAh/g, about 400 mAh/g to about 500 mAh/g, about 400 mAh/g to about 600 mAh/g, about 400 mAh/g to about 700 mAh/g, about 400 mAh/g to about 800 mAh/g, about 500 mAh/g to about 600 mAh/g, about 500 mAh/g to about 700 mAh/g, about 500 mAh/g to about 800 mAh/g, about 600 mAh/g to about 700 mAh/g, about 600 mAh/g to about 800 mAh/g, or about 700 mAh/g to about 800 mAh/g. An energy storage device (e.g., battery or battery cell) of the present disclosure may have a charge storage capacity of about 80 mAh/g, about 100 mAh/g, about 150 mAh/g, about 200 mAh/g, about 300 mAh/g, about 400 mAh/g, about 500 mAh/g, about 600 mAh/g, about 700 mAh/g, about 800 mAh/g, or about 80 mAh/g.

An energy storage device (e.g., battery or battery cell) of the present disclosure may have such charge storage capacities in combination with one or more power densities, energy densities, and/or cycling stabilities/cycle lives described herein. In some embodiments, an energy storage device (e.g., battery or battery cell) of the present disclosure has a storage capacity of about 80 mAh/g to about 800 mAh/g. In some embodiments, an energy storage device (e.g., battery or battery cell) of the present disclosure has a storage capacity of at least about 1,000 mAh/g.

An energy storage device (e.g., battery or battery cell) of the present disclosure may have a power density of greater than or equal to about 500 W/kg, 600 W/kg, 700 W/kg, 800 W/kg, 900 W/kg, 1000 W/kg, 1100 W/kg, 1200 W/kg, 1300 W/kg, 1400 W/kg, 1500 W/kg, 1600 W/kg, 1700 W/kg, 1800 W/kg, 1900 W/kg, 2000 W/kg, 2100 W/kg, 2200 W/kg, 2300 W/kg, 2400 W/kg, 2500 W/kg, 2600 W/kg, 2700 W/kg, 2800 W/kg, 2900 W/kg, 3000 W/kg, 3100 W/kg, 3200 W/kg, 3300 W/kg, 3400 W/kg, or 3500 W/kg. An energy storage device (e.g., battery or battery cell) of the present disclosure may have a power density between about 500 W/kg and 3000 W/kg, 500 W/kg and 3500 W/kg, 1000 W/kg and 3000 W/kg, 1000 W/kg and 3500 W/kg, 1500 W/kg and 3000 W/kg, 1500 W/kg and 3500 W/kg, 1600 W/kg and 3000 W/kg, 1600 W/kg and 3500 W/kg, 1700 W/kg and 3000 W/kg, 1700 W/kg and 3500 W/kg, 1800 W/kg and 3000 W/kg, 1800 W/kg and 3500 W/kg, 1900 W/kg and 3000 W/kg, 1900 W/kg and 3500 W/kg, 2000 W/kg and 3000 W/kg, 2000 W/kg and 3500 W/kg, 2100 W/kg and 3000 W/kg, 2100 W/kg and 3500 W/kg, 2200 W/kg and 3000 W/kg, 2200 W/kg and 3500 W/kg, 2300 W/kg and 3000 W/kg, 2300 W/kg and 3500 W/kg, 2400 W/kg and 3000 W/kg, 2400 W/kg and 3500 W/kg, 2500 W/kg and 3000 W/kg, 2500 W/kg and 3500 W/kg, 2600 W/kg and 3000 W/kg, 2600 W/kg and 3500 W/kg, 2700 W/kg and 3000 W/kg, 2700 W/kg and 3500 W/kg, 2800 W/kg and 3000 W/kg, 2800 W/kg and 3500 W/kg, 2900 W/kg and 3000 W/kg, 2900 W/kg and 3500 W/kg, or 3000 W/kg and 3500 W/kg. An energy storage device (e.g., battery or battery cell) of the present disclosure may have such power densities in combination with one or more charge storage capacities, energy densities, and/or cycling stabilities/cycle lives described herein.

An energy storage device (e.g., battery or battery cell) of the present disclosure may have a cycling stability or cycle life of greater than or equal to about 500 cycles, 600 cycles, 700 cycles, 800 cycles, 900 cycles, 1000 cycles, 1100 cycles, 1200 cycles, 1300 cycles, 1400 cycles, 1500 cycles, or 2000 cycles. An energy storage device (e.g., battery or battery cell) of the present disclosure may have a cycling stability or cycle life between about 500 cycles and 1000 cycles, 500 cycles and 1500 cycles, 600 cycles and 1000 cycles, 600 cycles and 1500 cycles, 700 cycles and 1000 cycles, 700 cycles and 1500 cycles, 800 cycles and 1000 cycles, 800 cycles and 1500 cycles, 800 cycles and 1000 cycles, 800 cycles and 1500 cycles, 900 cycles and 1000 cycles, 900 cycles and 1500 cycles, 1000 cycles and 1500 cycles, or 1500 cycles and 2000 cycles. An energy storage device (e.g., battery or battery cell) of the present disclosure may have such cycling stabilities/cycle lives in combination with one or more charge storage capacities, power densities and/or energy densities described herein.

An energy storage device (e.g., battery or battery cell) of the present disclosure may have an energy density of greater than or equal to about 50 Wh/kg, 75 Wh/kg, 90 Wh/kg, 100 Wh/kg, 110 Wh/kg, 120 Wh/kg, 130 Wh/kg, 140 Wh/kg, 150 Wh/kg, 160 Wh/kg, 170 Wh/kg, 180 Wh/kg, 190 Wh/kg, 200 Wh/kg, 210 Wh/kg, 220 Wh/kg, 230 Wh/kg, 240 Wh/kg, 250 Wh/kg, 260 Wh/kg, 270 Wh/kg, 280 Wh/kg, 290 Wh/kg, 300 Wh/kg, 310 Wh/kg, 320 Wh/kg, 330 Wh/kg, 340 Wh/kg, 350 Wh/kg, 360 Wh/kg, 370 Wh/kg, 380 Wh/kg, 390 Wh/kg or 400 Wh/kg. An energy storage device (e.g., battery or battery cell) of the present disclosure may have an energy density between about 90 Wh/kg and 250 Wh/kg, 90 Wh/kg and 300 Wh/kg, 90 Wh/kg and 350 Wh/kg, 90 Wh/kg and 400 Wh/kg, 150 Wh/kg and 250 Wh/kg, 150 Wh/kg and 300 Wh/kg, 150 Wh/kg and 350 Wh/kg, 150 Wh/kg and 400 Wh/kg, 200 Wh/kg and 250 Wh/kg, 200 Wh/kg and 300 Wh/kg, 200 Wh/kg and 350 Wh/kg, 200 Wh/kg and 400 Wh/kg, 250 Wh/kg and 300 Wh/kg, 250 Wh/kg and 350 Wh/kg, 250 Wh/kg and 400 Wh/kg, 300 Wh/kg and 350 Wh/kg, 300 Wh/kg and 400 Wh/kg, or 350 Wh/kg and 400 Wh/kg. An energy storage device (e.g., battery or battery cell) of the present disclosure may have such energy densities in combination with one or more charge storage capacities, power densities, and/or cycling stabilities/cycle lives described herein.

An energy storage device (e.g., battery or battery cell) of the present disclosure may have a charge voltage of greater than or equal to about 2 V, 2.1 V, 2.2 V, 2.3 V, 2.4 V, 2.5 V, 2.6 V, 2.7 V, 2.8 V, 2.9 V, 3 V, 3.1 V, 3.2 V, 3.3 V, 3.4 V, 3.5 V, 3.6 V, 3.7 V, 3.8 V, 3.9 V, 4 V, 4.1 V, 4.2 V, 4.3 V, 4.4 V, or 4.5 V. An energy storage device (e.g., battery or battery cell) of the present disclosure may have a charge voltage between about 2 V and 2.5 V, 2 V and 3 V, 2 V and 3.5 V, 2 V and 4 V, 2 V and 4.5 V, 2.5 V and 3 V, 2.5 V and 3.5 V, 2.5 V and 4 V, 2.5 V and 4.5 V, 3 V and 3.5 V, 3 V and 4 V, 3 V and 4.5 V, 3.5 V and 4 V, 3.5 V and 4.5 V, or 4 V and 4.5 V. An energy storage device (e.g., battery or battery cell) of the present disclosure may have a discharge voltage of greater than or equal to about 2 V, 2.5 V, 3 V, 3.5 V, 4 V, or 4.5 V. An energy storage device (e.g., battery or battery cell) of the present disclosure may a discharge voltage between about 2 V and 2.5 V, 2 V and 3 V, 2 V and 3.5 V, 2 V and 4 V, 2 V and 4.5 V, 2.5 V and 3 V, 2.5 V and 3.5 V, 2.5 V and 4 V, 2.5 V and 4.5 V, 3 V and 3.5 V, 3 V and 4 V, 3 V and 4.5 V, 3.5 V and 4 V, 3.5 V and 4.5 V, or 4 V and 4.5 V. In some embodiments, the charge and discharge voltage may differ by less than or equal to about 25%, 20%, 15%, 10% or 5% (e.g., see FIG. 12). The charge and discharge voltage may have such similarities over a given capacity range (e.g., up to about 1000 mAh, 1100 mAh, 1200 mAh, 1300 mAh, 1400 mAh, 1600 mAh, 1700 mAh, 1800 mAh, 1900 mAh, 2000 mAh, 2200 mAh, 2400 mAh, 2600 mAh, 2800 mAh, 3000 mAh, 3200 mAh, 3400 mAh, 3600 mAh, 3800 mAh or 4000 mAh).

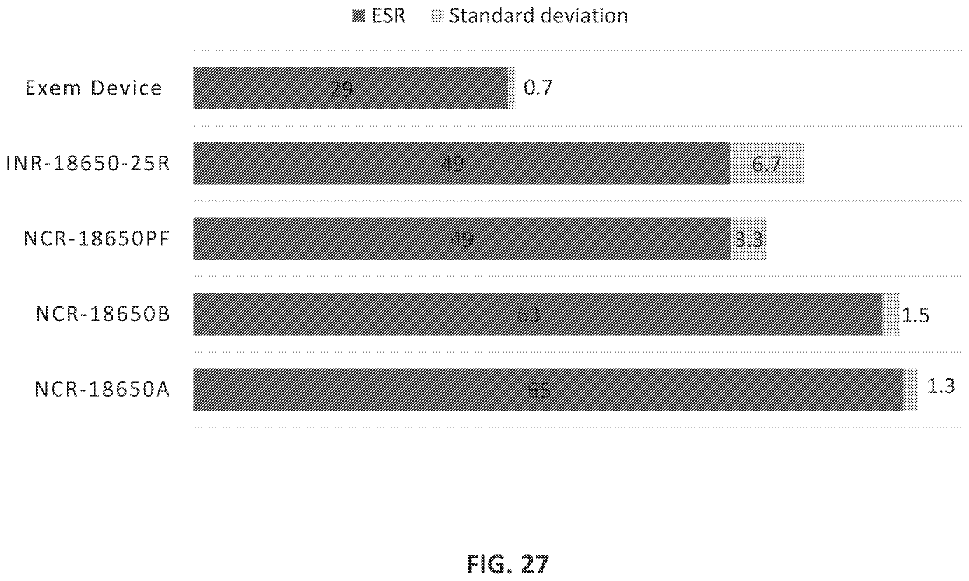

Per FIG. 27, energy storage devices available in the market exhibit an equivalent series resistance (ESR) of about 40Ω to about 70Ω. However, further improvements of these figures are necessary for the wide adoption of this technology, especially for large scale applications such as electric vehicles and grid scale energy storage (e.g., to reduce the price of electric vehicles and contribute to a clean and green environment).

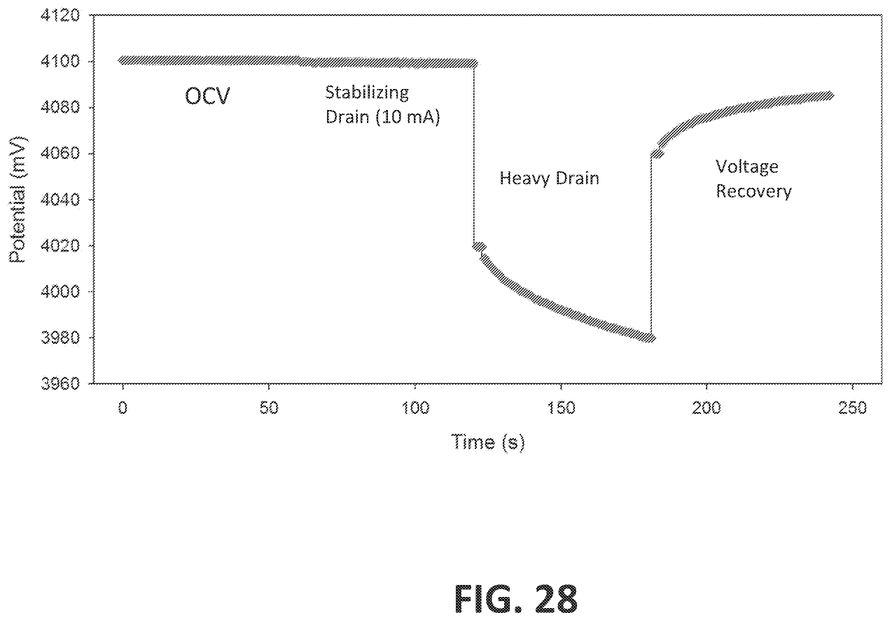

In contrast, the energy storage devices (e.g., batteries) provided herein may in some embodiments exhibit an ESR of less than 30Ω, as calculated by the potential-time graph in FIG. 28. Such features may be enabled, for example, by outstanding electrical and mechanical properties of the carbon-based materials described herein, extraordinarily high surface area of the carbon-based materials described herein, or a combination thereof.

An energy storage device (e.g., battery or battery cell) of the present disclosure may have an ESR at 1 kilohertz (kHz) of 14 milliohms to 80 milliohms. An energy storage device (e.g., battery or battery cell) of the present disclosure may have an ESR at 1 kHz of at least 14 milliohms. An energy storage device (e.g., battery or battery cell) of the present disclosure may have an ESR at 1 kHz of at most 80 milliohms. An energy storage device (e.g., battery or battery cell) of the present disclosure may have an ESR at 1 kHz of 14 milliohms to 20 milliohms, 14 milliohms to 25 milliohms, 14 milliohms to 30 milliohms, 14 milliohms to 35 milliohms, 14 milliohms to 40 milliohms, 14 milliohms to 45 milliohms, 14 milliohms to 50 milliohms, 14 milliohms to 55 milliohms, 14 milliohms to 60 milliohms, 14 milliohms to 70 milliohms, 14 milliohms to 80 milliohms, 20 milliohms to 25 milliohms, 20 milliohms to 30 milliohms, 20 milliohms to 35 milliohms, 20 milliohms to 40 milliohms, 20 milliohms to 45 milliohms, 20 milliohms to 50 milliohms, 20 milliohms to 55 milliohms, 20 milliohms to 60 milliohms, 20 milliohms to 70 milliohms, 20 milliohms to 80 milliohms, 25 milliohms to 30 milliohms, 25 milliohms to 35 milliohms, 25 milliohms to 40 milliohms, 25 milliohms to 45 milliohms, 25 milliohms to 50 milliohms, 25 milliohms to 55 milliohms, 25 milliohms to 60 milliohms, 25 milliohms to 70 milliohms, 25 milliohms to 80 milliohms, 30 milliohms to 35 milliohms, 30 milliohms to 40 milliohms, 30 milliohms to 45 milliohms, 30 milliohms to 50 milliohms, 30 milliohms to 55 milliohms, 30 milliohms to 60 milliohms, 30 milliohms to 70 milliohms, 30 milliohms to 80 milliohms, 35 milliohms to 40 milliohms, 35 milliohms to 45 milliohms, 35 milliohms to 50 milliohms, 35 milliohms to 55 milliohms, 35 milliohms to 60 milliohms, 35 milliohms to 70 milliohms, 35 milliohms to 80 milliohms, 40 milliohms to 45 milliohms, 40 milliohms to 50 milliohms, 40 milliohms to 55 milliohms, 40 milliohms to 60 milliohms, 40 milliohms to 70 milliohms, 40 milliohms to 80 milliohms, 45 milliohms to 50 milliohms, 45 milliohms to 55 milliohms, 45 milliohms to 60 milliohms, 45 milliohms to 70 milliohms, 45 milliohms to 80 milliohms, 50 milliohms to 55 milliohms, 50 milliohms to 60 milliohms, 50 milliohms to 70 milliohms, 50 milliohms to 80 milliohms, 55 milliohms to 60 milliohms, 55 milliohms to 70 milliohms, 55 milliohms to 80 milliohms, 60 milliohms to 70 milliohms, 60 milliohms to 80 milliohms, or 70 milliohms to 80 milliohms. An energy storage device (e.g., battery or battery cell) of the present disclosure may have an ESR at 1 kHz of 14 milliohms, 20 milliohms, 25 milliohms, 30 milliohms, 35 milliohms, 40 milliohms, 45 milliohms, 50 milliohms, 55 milliohms, 60 milliohms, 70 milliohms, or 80 milliohms. An energy storage device (e.g., battery or battery cell) of the present disclosure may have an ESR at 1 kHz of about 5 milliohms to about 100 milliohms. An energy storage device (e.g., battery or battery cell) of the present disclosure may have an ESR at 1 kHz of at least about 5 milliohms. An energy storage device (e.g., battery or battery cell) of the present disclosure may have an ESR at 1 kHz of at most about 100 milliohms. An energy storage device (e.g., battery or battery cell) of the present disclosure may have an ESR at 1 kHz of about 5 milliohms to about 10 milliohms, about 5 milliohms to about 20 milliohms, about 5 milliohms to about 30 milliohms, about 5 milliohms to about 40 milliohms, about 5 milliohms to about 50 milliohms, about 5 milliohms to about 60 milliohms, about 5 milliohms to about 70 milliohms, about 5 milliohms to about 80 milliohms, about 5 milliohms to about 90 milliohms, about 5 milliohms to about 100 milliohms, about 10 milliohms to about 20 milliohms, about 10 milliohms to about 30 milliohms, about 10 milliohms to about 40 milliohms, about 10 milliohms to about 50 milliohms, about 10 milliohms to about 60 milliohms, about 10 milliohms to about 70 milliohms, about 10 milliohms to about 80 milliohms, about 10 milliohms to about 90 milliohms, about 10 milliohms to about 100 milliohms, about 20 milliohms to about 30 milliohms, about 20 milliohms to about 40 milliohms, about 20 milliohms to about 50 milliohms, about 20 milliohms to about 60 milliohms, about 20 milliohms to about 70 milliohms, about 20 milliohms to about 80 milliohms, about 20 milliohms to about 90 milliohms, about 20 milliohms to about 100 milliohms, about 30 milliohms to about 40 milliohms, about 30 milliohms to about 50 milliohms, about 30 milliohms to about 60 milliohms, about 30 milliohms to about 70 milliohms, about 30 milliohms to about 80 milliohms, about 30 milliohms to about 90 milliohms, about 30 milliohms to about 100 milliohms, about 40 milliohms to about 50 milliohms, about 40 milliohms to about 60 milliohms, about 40 milliohms to about 70 milliohms, about 40 milliohms to about 80 milliohms, about 40 milliohms to about 90 milliohms, about 40 milliohms to about 100 milliohms, about 50 milliohms to about 60 milliohms, about 50 milliohms to about 70 milliohms, about 50 milliohms to about 80 milliohms, about 50 milliohms to about 90 milliohms, about 50 milliohms to about 100 milliohms, about 60 milliohms to about 70 milliohms, about 60 milliohms to about 80 milliohms, about 60 milliohms to about 90 milliohms, about 60 milliohms to about 100 milliohms, about 70 milliohms to about 80 milliohms, about 70 milliohms to about 90 milliohms, about 70 milliohms to about 100 milliohms, about 80 milliohms to about 90 milliohms, about 80 milliohms to about 100 milliohms, or about 90 milliohms to about 100 milliohms. An energy storage device (e.g., battery or battery cell) of the present disclosure may have an ESR at 1 kHz of about 5 milliohms, about 10 milliohms, about 20 milliohms, about 30 milliohms, about 40 milliohms, about 50 milliohms, about 60 milliohms, about 70 milliohms, about 80 milliohms, about 90 milliohms, or about 100 milliohms.

### Terms and Definitions

Unless otherwise defined, all technical terms used herein have the same meaning as commonly understood by one of ordinary skill in the art to which the present disclosure belongs. As used in this specification and the appended claims, the singular forms “a,” “an,” and “the” include plural references unless the context clearly dictates otherwise. Any reference to “or” herein is intended to encompass “and/or” unless otherwise stated.

While preferable embodiments of the present disclosure have been shown and described herein, it will be obvious to those skilled in the art that such embodiments are provided by way of example only. Numerous variations, changes, and substitutions will now occur to those skilled in the art without departing from the the present disclosure. It should be understood that various alternatives to the embodiments of the the device of the present disclosure described herein may be employed in practicing the the present disclosure. It is intended that the following claims define the scope of the the present disclosure and that methods and structures within the scope of these claims and their equivalents be covered thereby.

Throughout the present disclosure, numerical features are presented in a range format. It should be understood that the description in range format is merely for convenience and brevity and should not be construed as an inflexible limitation on the scope of any embodiments. Accordingly, the description of a range should be considered to have specifically disclosed all the possible subranges as well as individual numerical values within that range to the tenth of the unit of the lower limit unless the context clearly dictates otherwise. For example, description of a range such as from 1 to 6 should be considered to have specifically disclosed subranges such as from 1 to 3, from 1 to 4, from 1 to 5, from 2 to 4, from 2 to 6, and from 3 to 6, as well as individual values within that range, for example, 1.1, 2, 2.3, 5, and 5.9. This applies regardless of the breadth of the range. The upper and lower limits of these intervening ranges may independently be included in the smaller ranges, and are also encompassed within the the present disclosure, subject to any specifically excluded limit in the stated range. Where the stated range includes one or both of the limits, ranges excluding either or both of those included limits are also included in the the present disclosure, unless the context clearly dictates otherwise.

Unless specifically stated or obvious from context, as used herein, the term “about” in reference to a number or range of numbers is understood to mean the stated number and numbers ±10% thereof, or 10% below the lower listed limit and 10% above the higher listed limit for the values listed for a range.

### EXAMPLES

### Example 1—NCA Cell

An exemplary battery comprises at least one cell comprising a negative electrode (anode during discharge) comprising graphite and a positive electrode (cathode during discharge) comprising PCS/lithium nickel cobalt aluminum oxide (NCA), as shown in Table 1.

TABLE 1
NCA Cell

| | | | Wet | Dry |
|---|---|---|---|---|
| | | | Slurry | Electrode |
| Electrode | Component | Material | Composition | Composition |
| Positive | Active | Graphene | 0.3%-0.6% | 0.5%-1% |
| Electrode | electrode | Lithium nickel | 58%-59% | 96%-97% |
| | material | cobalt aluminum | | |
| | | oxide | | |
| | Binder | Polyvinylidene | 1.5% | 2.5% |
| | | fluoride | | |
| | Solvent | N-methyl-2- | 39% | 0% |
| | | pyrrolidone | | |
| Negative | Active | Natural | 49% | 95% |
| Electrode | material | graphite | | |
| | Conductive | Carbon Black | 0.5% | 1% |
| | additive | Super-P | | |
| | Binder | Polyvinylidene | 2% | 5% |
| | | fluoride | | |
| | Solvent | N-methyl-2- | 48% | 0% |
| | | pyrrolidone | | |

### Example 2—NMC Cell

An exemplary battery comprises at least one cell comprising a negative electrode (anode during discharge) comprising graphite and a positive electrode (cathode during discharge) comprising PCS/lithium nickel manganese cobalt oxide (NMC), as shown in Table 2.

TABLE 2
NMC Cell

| | | | Wet | Dry |
|---|---|---|---|---|
| | | | Slurry | Electrode |
| Electrode | Component | Material | Composition | Composition |
| Positive | Active | Graphene | 0.3%-0.6% | 0.5%-1% |
| Electrode | electrode | Lithium nickel | 58%-59% | 96%-97% |
| | material | manganese cobalt | | |
| | | oxide | | |
| | Binder | Polyvinylidene | 1.5% | 2.5% |
| | | fluoride | | |
| | Solvent | N-methyl-2- | 39% | 0% |
| | | pyrrolidone | | |
| Negative | Active | Natural | 49% | 95% |
| Electrode | material | graphite | | |
| | Conductive | Carbon Black | 0.5% | 1% |
| | additive | Super-P | | |
| | Binder | Polyvinylidene | 2% | 5% |
| | | fluoride | | |
| | Solvent | N-methyl-2- | 48% | 0% |
| | | pyrrolidone | | |

### Example 3—LFP Cell

An exemplary battery comprises at least one cell comprising a negative electrode (anode during discharge) comprising graphite and a positive electrode (cathode during discharge) comprising PCS/lithium iron phosphate (LFP), as shown in Table 3.

TABLE 3
LFP Cell

| | | | Wet | Dry |
|---|---|---|---|---|
| | | | Slurry | Electrode |
| Electrode | Component | Material | Composition | Composition |
| Positive | Active | Graphene | 0.3%-0.6% | 0.5%-1% |
| Electrode | electrode | Lithium iron | 58%-59% | 96%-97% |
| | material | phosphate | | |
| | Binder | Polyvinylidene | 1.5% | 2.5% |
| | | fluoride | | |
| | Solvent | N-methyl-2- | 39% | 0% |
| | | pyrrolidone | | |
| Negative | Active | Natural | 49% | 95% |
| Electrode | material | graphite | | |
| | Conductive | Carbon Black | 0.5% | 1% |
| | additive | Super-P | | |
| | Binder | Polyvinylidene | 2% | 5% |
| | | fluoride | | |
| | Solvent | N-methyl-2- | 48% | 0% |
| | | pyrrolidone | | |

What is claimed is:

1. An energy storage device comprising:
a. a negative electrode comprising:
i. a plurality of porous graphene sheets comprising graphene oxide, reduced graphene oxide, graphite oxide, or a combination thereof, wherein a portion of edges of a portion of the plurality of porous graphene sheets are oxidized and comprise an oxygen content of about 0.5% to about 10%,
ii. a first binder, and
iii. a conductive additive;
b. a positive electrode comprising:
i. an active material, and
ii. a second binder; and
c. a separator between the negative electrode and the positive electrode.

2. The energy storage device of claim 1, wherein at least one of the first binder and the second binder comprises polyvinyl fluoride, polyvinylidene fluoride, polytetrafluoroethylene, polychlorotrifluoroethylene, perfluoroalkoxy polymer, fluorinated ethylene-propylene, polyethylenetetrafluoroethylene, polyethylenechlorotrifluoroethylene, perfluorinated plastomer, a fluorocarbon, chlorotrifluoroethylenevinylidene fluoride, a fluoroelastomer, tetrafluoroethylene-propylene, perfluoropolyether, perfluorosulfonic acid, perfluoropolyoxetane, P(VDF-trifluoroethylene), P(VDF-tetrafluoroethylene), or any combination thereof.

3. The energy storage device of claim 1, wherein the conductive additive comprises carbon black, acetylene black, furnace black, vapor-grown carbon fibers, carbon nanotubes, or any combination thereof.

4. The device of claim 1, wherein the active material comprises, graphene, lithium iron phosphate, lithium nickel cobalt aluminum oxide, lithium nickel manganese cobalt oxide, lithium cobalt oxide, lithium manganese oxide, lithium titanate, lithium sulfur, or any combination thereof.

5. The device of claim 1, having a storage capacity of at least 800 mAh.

6. The device of claim 1, having a cycle life of at least about 500 cycles, about 600 cycles, about 700 cycles, about 800 cycles, about 900 cycles, or at least about 1000 cycles.

7. The device of claim 1, having an equivalent series resistance of about 10 milliohms to about 100 milliohms, about 20 milliohms to about 80 milliohms, about 20 milliohms to about 100 milliohms, or about 60 milliohms to about 100 milliohms.

8. The device of claim 1, wherein the separator has a permeability greater than or equal to about 150 sec/100 mL.

9. The device of claim 1, wherein carboxylic acid functional groups are bonded only to one or both of a top sheet or a bottom sheet of the porous graphene sheets.

10. The device of claim 1, wherein the porous graphene sheets comprise about 2 to about 10 porous graphene sheets.

11. The device of claim 1, wherein each of the porous graphene sheets comprises a plurality of pores, wherein a portion of the plurality of pores have a pore size of about 1 nanometer (nm) to about 10 nm.

12. A method of providing an energy storage device, the method comprising:
a. mixing an active material into a binder and a solvent to form a slurry, wherein the active material comprises a plurality of porous graphene sheets comprising graphene oxide, reduced graphene oxide, graphite oxide, or a combination thereof, wherein a portion of edges of a portion of the plurality of porous graphene sheets are oxidized and comprise an oxygen content of about 0.5% to about 10%;
b. roll coating the slurry onto a foil;
c. drying the slurry on the foil;
d. roll pressing the slurry on the foil;
e. slitting the slurry on the foil to form an electrode.

13. The method of claim 12, wherein the oxygen content is less than about 5%.

14. The method of claim 12, wherein the oxygen content is less than about 2%.

15. The method of claim 12, wherein the binder comprises polyvinyl fluoride, polyvinylidene fluoride, polytetrafluoroethylene, polychlorotrifluoroethylene, perfluoroalkoxy polymer, fluorinated ethylene-propylene, polyethylenetetrafluoroethylene, polyethylenechlorotrifluoroethylene, perfluorinated plastomer, a fluorocarbon, chlorotrifluoroethylenevinylidene fluoride, a fluoroelastomer, tetrafluoroethylene-propylene, perfluoropolyether, perfluorosulfonic acid, perfluoropolyoxetane, P(VDF-trifluoroethylene), P(VDF-tetrafluoroethylene), or any combination thereof.

16. The method of claim 12, wherein the active material further comprises a lithiated metal compound.

17. The method of claim 12, wherein the plurality of porous graphene sheets is a single layer of graphene.

18. The method of claim 12, wherein a portion of the plurality of porous graphene sheets has an average pore size of about 1 nm to about 10 nm.

19. The method of claim 12, further comprising applying a metal tab to the electrode.

20. The method of claim 12, further comprising forming the porous graphene sheets using a non-Hummer's method, wherein the non-Hummer's method comprises:
chemically oxidizing graphite to form graphene oxide;
exfoliating the graphene oxide;
purifying the graphene oxide; and
chemically reducing the graphene oxide to form the porous graphene sheets.
